(19) United States
(12) Patent Application Publication
(10) Pub. No.: US 2022/0171874 A1
(43) Pub. Date: Jun. 2, 2022

(54) APPARATUSES, METHODS, AND COMPUTER PROGRAM PRODUCTS FOR PRIVACY-PRESERVING PERSONALIZED DATA SEARCHING AND PRIVACY-PRESERVING PERSONALIZED DATA SEARCH TRAINING

(71) Applicant: XAYN AG, Berlin (DE)

(72) Inventor: Leif-Nissen LUNDBÆK, Berlin (DE)

(21) Appl. No.: 17/107,324

(22) Filed: Nov. 30, 2020

(51) Int. Cl. G06F 21/62; G06F 16/9535; G06F 16/9538; G06N 20/00

(52) U.S. Cl. CPC G06F 21/6245; G06F 21/6227; G06N 20/00; G06F 16/9538; G06F 16/9535

(57) ABSTRACT

Embodiments of the present disclosure provide for privacy-preserving personalized search, which enables accurate search personalization without exposing user data to third-party entities in a manner that may be illegal due to regional privacy restrictions and/or undesirable for purposes of data privacy protection. Such personalized search is provided via a privacy-preserving personalized search model that embodies or utilizes at least one model trained in a privacy-preserving manner, for example via privacy-preserving federated learning. Contrary to conventional systems, embodiments thus remain highly accurate while simultaneously remaining fully private. Additionally, embodiments of the present disclosure provide for privacy-preserving personalized search training to enable training of device(s) for privacy-preserving personalized search in an efficient manner and user-friendly manner utilizing search preference training interface(s). Some embodiments provide search preference training interface(s) and/or associated interfaces to enable user-insight data associated with personalized search results to be received and/or subsequently processed.

### TECHNOLOGICAL FIELD

Embodiments of the present disclosure generally relate to personalized search of electronic data, and specifically to searching electronic data using personalization without undesired exposure of personal data to third-party entities.

### BACKGROUND

Search of electronic data is conventionally performed with privacy or personalization in mind. In circumstances where privacy is prioritized, the search system does not collect any personal data regarding searching activity for a particular user. In circumstances where personalization is prioritized, the search system collects personal data regarding searching activity to provide such personalization. Such systems require personal data for a user to be exposed to enable such personalization of searching. Applicant has discovered problems with current implementations of personalized data search. Through applied effort, ingenuity, and innovation, Applicant has solved many of these identified problems by developing embodied in the present disclosure, which are described in detail below.

### BRIEF SUMMARY

In general, embodiments of the present disclosure provided herein privacy-preserving personalized data search. Other implementations for privacy-preserving personalized data search will be, or will become, apparent to one with skill in the art upon examination of the following figures and detailed description. It is intended that all such additional implementations be included within this description be within the scope of the disclosure, and be protected by the following claims.

In accordance with a first aspect of the disclosure, a computer-implemented method for privacy-preserving data searching. is provided. The computer-implemented method may be executed on any of the computing devices described herein embodied in hardware, software, firmware, and/or a combination thereof. In at least one example embodiment, the computer-implemented method includes receiving a search result set associated with a search query. The example computer-implemented method further includes generating a personalized search result set from the search result set by applying the search result set to a privacy-preserving personalized search model. The example computer-implemented method further includes outputting the personalized search result set.

Additionally or alternatively, in some embodiments of the example computer-implemented method, applying the search result set to the privacy-preserving personalized search model comprise applying the search result set a trained dynamic contextual multi-armed bandit, the trained dynamic contextual multi-armed bandit configured to utilize a plurality of sub-models, the plurality of sub-models comprising at least one sub-model trained via communication with a privacy-preserving federated learning system.

Additionally or alternatively, in some embodiments of the example computer-implemented method, the privacy-preserving search model utilizes a trained resource context model, a trained user resource interest model, a trained user domain preference model, and a trained user content type preference model.

Additionally or alternatively, in some embodiments of the example computer-implemented method, the computer-implemented method further comprises receiving user input data indicating a user-selected search result from the personalized search result set; and accessing an electronic resource represented by the user-selected search result.

Additionally or alternatively, in some embodiments of the example computer-implemented method, the computer-implemented method further comprises receiving user input data indicating a user-selected search result from the personalized search result set; and training at least one sub-model of the privacy-preserving search model based at least on the user-selected search result.

Additionally or alternatively, in some embodiments of the example computer-implemented method, the computer-implemented method further comprises receiving the search query inputted by a user; and transmitting the search query to a search system, wherein the search result set is received in response to transmitting the search query based at least on the search query.

Additionally or alternatively, in some embodiments of the example computer-implemented method, the computer-implemented method further comprises receiving, from a privacy-preserving federated learning system, a masked updated global model of at least one sub-model trained via the privacy-preserving federated learning system; and unmasking the masked updated global model utilizing a secured unmasking data object to store as the at least one sub-model for use.

Additionally or alternatively, in some embodiments of the example computer-implemented method, the privacy-preserving personalized search model is configured for generating, for each electronic resource corresponding to at least a portion of the search result set, resource context data associated with the electronic resource by processing electronic content of the electronic resource using a trained resource context model configured to apply natural language processing to the electronic content of the electronic resource; generating, using a trained user resource interest model, at least one center of interest associated with a user profile and at least one center of disinterest associated with the user profile; and generating the personalized search result set based at least on (1) the resource context data for each electronic resource corresponding to at least the portion of the search result set, and (2) the at least one center of interest associated with the user profile and/or the at least one center of disinterest associated with the user profile.

Additionally or alternatively, in some embodiments of the example computer-implemented method, the computer-implemented method further comprises receiving user input data indicating a user-selected search result from the personalized search result set; determining resource context data for an electronic resource corresponding to the user-selected search result; determining the resource context data is associated with a context distance from a context cluster of a set of context clusters that satisfies a clustering context distance threshold; generating an updated context cluster by adding data associated with the user-selected search result to the context cluster; and updating at least one center of interest or at least one center of disinterest based on the updated context cluster.

Additionally or alternatively, in some embodiments of the example computer-implemented method, the computer-implemented method further comprising receiving user input data indicating a user-selected search result from the personalized search result set; determining resource context data for an electronic resource corresponding to the user-selected search result; determining, for each context cluster of a set of context clusters, the resource context data is associated with a context distance that does not satisfy a clustering context distance threshold; generating an updated set of context clusters including a new context cluster comprising data associated the user-selected search result; and updating at least one center of interest or at least one center of disinterest based on the updated set of context clusters.

Additionally or alternatively, in some embodiments of the example computer-implemented method, the privacy-preserving search model utilizes a trained user resource interest model configured for identifying a set of previously engaged search results; extracting resource context data for each previously engaged search result of the set of previously engaged search results; and generating at least one of a center of interest and a center of disinterest based at least on the resource context data for each previously engaged search result.

Additionally or alternatively, in some embodiments of the example computer-implemented method, applying the search result set to a privacy-preserving personalized search model comprises generating, for each search result in the search result set, resource context data by embedding extracted resource data associated with the search result using a trained resource context model; generating a set of context clusters based on the resource context data for each search result in the search result set; calculating, for each search result in the search result set, a context distance from a center of interest; processing the search result set associated with the search query to determine a set of search model features based on a set of previously engaged search results; generating, utilizing a trained privacy-preserving personalized search model trained, a context-based result ranking score for each search result based on the set of search features; generating, for each search result in the search result set, a normalized result ranking score based on the context distance for the search result and the context-based ranking score for the search result; calculating, for each context cluster in the set of context clusters, at least one distribution parameter based on the normalized result ranking scores for each search result in the context cluster defining a distribution of context clusters; determining a selected context cluster from the set of context clusters based on the at least one distribution parameter; and identifying a highest ranked search result associated with the selected context cluster for including in the personalized search result set.

Additionally or alternatively, in some embodiments of the example computer-implemented method, the privacy-preserving personalized search model utilizes at least one sub-model trained via communication with a privacy-preserving federated learning system.

Additionally or alternatively, in some embodiments of the example computer-implemented method, the privacy-preserving personalized search model comprises a multi-armed bandit model configured to generate the personalized search result set based on a learning to rank model generated from a learning to rank model, at least one center of interest, and at least one center of disinterest.

In accordance with another aspect of the disclosure, an apparatus for privacy-preserving data searching is provided. The apparatus comprises at least one processor and at least one non-transitory memory having computer-coded instructions stored thereon. The computer-coded instructions, in execution with the at least one processor, configure the apparatus to perform any one of the example computer-implemented methods described herein.

In accordance with yet another aspect of the disclosure, a computer program product for privacy-preserving data searching is provided. The computer program product comprises at least one non-transitory computer-readable storage medium having computer program code stored thereon. The computer program code, in execution with at least one processor, is configured for performing any one of the example computer-implemented methods described herein.

In accordance with yet another aspect of the disclosure, an example computer-implemented method for privacy-preserving data search training is provided. The computer-implemented method may be executed on any of the computing devices described herein embodied in hardware, software, firmware, and/or a combination thereof. In at least one example embodiment, the example computer-implemented method includes receiving a search result set associated with a search query. The example computer implemented method further includes generating a personalized search result set from the search result set by applying the search result set to a privacy-preserving personalized search model. The example computer-implemented method further includes generating a personalized resource summary data set comprising personalized resource summary data for each personalized search result in at least a portion of the personalized search result set. The example computer-implemented method further includes causing rendering of a search preference training interface, the search preference training interface comprising a personalized resource summary interface element for at least one personalized resource summary data of the personalized resource summary data set. The example computer-implemented method further includes receiving user input data associated with the personalized resource summary interface element embodying an indication of interest or disinterest of a personalized search result corresponding to the personalized resource summary interface element. The example computer-implemented method further includes causing updating of the privacy-preserving personalized search model based on the indication of interest or disinterest in the personalized search result.

Additionally or alternatively, in some embodiments of the example computer-implemented method, the example computer-implemented method further comprises removing the personalized resource summary interface element from the search preference training interface; and causing rendering of a new personalized resource summary interface element associated with another personalized resource summary data of the personalized resource summary data set.

Additionally or alternatively, in some embodiments of the example computer-implemented method, the user input data embodies a left swipe indicating disinterest in the personalized search result, or the user input data embodies a right swipe indicating interest in the personalized search result.

Additionally or alternatively, in some embodiments of the example computer-implemented method, each personalized resource summary data of the personalized resource summary data set comprises extracted content summary data generated associated with an electronic resource corresponding to a personalized search result of the personalized search result set.

Additionally or alternatively, in some embodiments of the example computer-implemented method, the user input data embodies an indication of disinterest of the personalized search result corresponding to the personalized resource summary interface element, and the example computer-implemented method further comprising causing rendering of a disinterest investigation interface associated with the personalized search result corresponding to the personalized resource summary interface element, wherein the disinterest investigation interface comprises a plurality of user insight interface elements, each user insight interface element associated with updating one or more sub-model utilized by the privacy-preserving personalized search model, wherein second user input data associated with a particular user insight interface element of the plurality of user insight interface elements is utilized to further train one or more of the at least one sub-model based on the second user input data.

Additionally or alternatively, in some embodiments of the example computer-implemented method, the user input data embodies an indication of interest of the personalized search result corresponding to the personalized resource summary interface element, and the example computer-implemented method further comprises causing rendering of an interest investigation interface associated with the personalized search result corresponding to the personalized resource summary interface element, wherein the interest investigation interface comprises a plurality of user insight interface elements, each user insight interface element associated with updating one or more sub-model utilized by the privacy-preserving personalized search model, wherein second user input data associated with a particular user insight interface element of the plurality of user insight interface elements is utilized to further train the one or more of the at least one sub-model based on the second user input data.

Additionally or alternatively, in some embodiments of the example computer-implemented method, the example computer-implemented method further comprises receiving the search query inputted by a user; and transmitting the search query to a search system, wherein the search result set is received in response to transmitting the search query based at least on the search query.

Additionally or alternatively, in some embodiments of the example computer-implemented method, the privacy-preserving personalized search model is configured to generate the personalized search result set based at least on (1) at least one center of interest associated with a user profile and (2) at least one center of disinterest associated with the user profile.

Additionally or alternatively, in some embodiments of the example computer-implemented method, wherein the privacy-preserving personalized search model is configured to generate the personalized search result set based at least on (1) an exploration deviation from at least one center of interest associated with a user profile or (2) the exploration deviation from at least one center of disinterest associated with the user profile.

Additionally or alternatively, in some embodiments of the example computer-implemented method, causing updated training of the privacy-preserving personalized search model based on the indication of interest or disinterest of the personalized search result comprises training an updated search model based on the indication of interest or disinterest of the personalized search result; masking, based on a local decryption key, the updated search model to produce a local masked updated search model; transmitting the local masked updated search model to the privacy-preserving federated learning system; generating a secured unmasking data object based on at least the local decryption key and a plurality of external local decryption keys; receiving a masked updated global model from the privacy-preserving federated learning system; and generating an unmasked updated global model by unmasking the masked updated global model utilizing the secured unmasking data object, the unmasked updated global model embodying the updated privacy-preserving personalized search model.

In accordance with another aspect of the disclosure, an apparatus for privacy-preserving data search training is provided. The apparatus comprises at least one processor and at least one non-transitory memory having computer-coded instructions stored thereon. The computer-coded instructions, in execution with the at least one processor, configure the apparatus to perform any one of the example computer-implemented methods described herein.

In accordance with yet another aspect of the disclosure, a computer program product for privacy-preserving search training is provided. The computer program product comprises at least one non-transitory computer-readable storage medium having computer program code stored thereon. The computer program code, in execution with at least one processor, is configured for performing any one of the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of an example privacy-preserving personalized search system that may be specially configured within which embodiments of the present disclosure may operate;

FIG. 2 illustrates a block diagram of detailed computing entities interacting of an example privacy-preserving personalized search system that may be specially configured within which embodiments of the present disclosure may operate;

FIG. 3 illustrates a block diagram of an example privacy-preserving personalized search apparatus that may be specially configured in accordance with an example embodiment of the present disclosure;

FIG. 4 illustrates a visualization of an example privacy-preserving personalized search model in accordance with at least some example embodiments of the present disclosure;

FIG. 5 illustrates a visualization of search index generation in accordance with at least some embodiments of the present disclosure;

FIG. 6 illustrates an example context mapping space in accordance with at least some embodiments of the present disclosure;

FIG. 7 illustrates an example search results personalization process in accordance with at least some example embodiments of the present disclosure;

FIG. 8 illustrates a flowchart depicting example operations of an example process for privacy-preserving personalized searching in accordance with at least some example embodiments of the present disclosure;

FIG. 9 illustrates a flowchart depicting example additional operations of an example process for utilizing a user-selected search result, for example as part of a process for privacy-preserving personalized searching, in accordance with at least some example embodiments of the present disclosure;

FIG. 10 illustrates a flowchart depicting example additional operations of an example process for utilizing updated context clusters, for example as part of a process for privacy-preserving personalized searching, in accordance with at least some example embodiments of the present disclosure;

FIG. 11 illustrates a flowchart depicting example additional operations of an example process for utilizing updated context clusters, for example as part of a process for privacy-preserving personalized searching, in accordance with at least some example embodiments of the present disclosure;

FIG. 12A illustrates a flowchart depicting example operations of an example process for generating a personalized search result set in accordance with at least some example embodiments of the present disclosure;

FIG. 12B illustrates a data flow between components for performing an example implementation of the process depicted with respect to FIG. 12A for generating a personalized search result set, in accordance with at least some example embodiments of the present disclosure;

FIG. 13 illustrates an example resource summary generation process in accordance with at least some example embodiments of the present disclosure;

FIG. 14 illustrates an example search preference training interface and associated process in accordance with at least some example embodiments of the present disclosure;

FIG. 15 illustrates an privacy-preserving personalized search model training process in accordance with at least some example embodiments of the present disclosure;

FIG. 16 illustrates an example search preference training interface in accordance with at least some example embodiments of the present disclosure;

FIG. 17 illustrates an example search preference training interface including a disinterest investigation interface and an interest investigation interface in accordance with at least some example embodiments of the present disclosure;

FIG. 18 illustrates a flowchart depicting example operations of rendering of a search personalization training interface for personalized privacy-preserving personalized search training in accordance with at least some example embodiments of the present disclosure;

FIG. 19 illustrates a flowchart depicting example additional operations of an example process for updating a search personalization training interface, for example as part of a process for rendering and using a search personalization training interface, in accordance with at least some example embodiments of the present disclosure; and

FIG. 20 illustrates a flowchart depicting example additional operations of an example process for updating one or more sub-models of a privacy-preserving personalized search model, for example as part of a process for rendering and using a search personalization training interface, in accordance with at least some example embodiments of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

Overview

A user generally utilizes a search system with a particular goal in mind. In this regard, when a user enters a search, a search system may return any number of results determined as being related to the user's search. Of the various provided results, only a few particular results may be of interest to the user, and only a subset of the results of interest to a user (sometimes, only one result) may be accessed and/or otherwise selected by the user. The selected results may be selected by a user for any of a myriad of reasons—such as it appears to best match the desired content, it is from a preferred domain, it offers a content type preferred by the user, it is by an author preferred by the user, and/or the like. Search systems attempt to provide results most likely to be selected by the user to improve the overall user experience, reduce the computational resources expended by the search system or a corresponding user device in providing, rendering, and/or otherwise managing subsequent results (e.g., in a circumstance where initial results were not of interest to the user and/or were not selected by the user), and/or otherwise improve throughput of search operations performed by the search system.

Conventional search systems often function such that only one of privacy or personalization is prioritized. In circumstances where privacy is prioritized, data associated with a user's search activities is not collected. In this manner, exposure of the user's data (as well as information that can be derived therefrom) is minimized. By failing to store any data or only storing limited data regarding a user's search activities, however, such implementations either cannot provide search personalization functionality, or cannot provide the same level of search personalization as systems that collect significant data or all data associated with a user's search activities. By failing to provide personalized search results to a user, such search implementations may waste resources providing irrelevant search results to a user and/or force the user to spend increased amounts of time and/or computing resources to explore search results before identifying one that is relevant to the searching user, preferred by the searching user, and/or otherwise sufficient for selection by the searching user. In implementations where personalization is prioritized, significant data or all data associated with a user's search activities is collected. Such collection significantly exposes the user's data at least to the system performing the search personalization, as well as to possible exposure of such data due to data breach or other interactions by a third-party. The inventors have identified that data exposure is preferably minimized to prevent misuse of such data, as well as to prevent cybersecurity risks posed by exposure of such data.

Additionally, in certain circumstances, collection and/or processing of data associated with a user's search activities is impermissible or has significant operations-level repercussions. For example, certain legal regimes prioritizing privacy (e.g., aspects of the General Data Protection Regulation adopted into law by the European Union). In some such legal regimes, certain restrictions and/or implementation requirements may be imposed in circumstances where such data is collected and/or processed. Such implementation requirements may be difficult or impossible to perform, and/or may otherwise significantly increase the computational complexity of systems that conform to the implementation requirements. To become compliant, systems often require significant investment in the form of man-hour commitment to upgrade associated search systems, capital expenditure for computing system upgrades and/or man-hour payment for such upgrades, and continued increased costs to maintain and utilize the search system due to the increased complexity of the search system.

Embodiments of the present disclosure provide for privacy-preserving personalized data searching. In this regard, various embodiments of the present disclosure enable search personalization to be performed without exposing directly readable and/or interpretable versions of data associated with a user's search activities. Such embodiments improve the overall privacy provided to users performing such searches while maintaining the various benefits of personalization. For example, such embodiments improve the likelihood of providing a search result of interest and/or likely to be accessed by the user performing the search (thus saving computational resources, improving the user experience, and the like) without diminishing the privacy of the data associated with the user's search activities.

Embodiments of the disclosure utilize a privacy-preserving personalized search model trained, or that utilizes one or more sub-models trained, via communication with a privacy-preserving federated learning system. The privacy-preserving federated learning system trains the privacy-preserving personalized search model, and/or sub-models utilized by the privacy-preserving personalized search model, in a privacy-preserving federated manner. Example implementations of the privacy-preserving federated learning system, as well as the operations for performing the training of the privacy-preserving personalized search model and/or sub-models in a privacy-preserving federated manner, and benefits associated therewith, are described in U.S. patent application Ser. No. 16/792,981 titled “APPARATUSES, COMPUTER PROGRAM PRODUCTS, AND COMPUTER-IMPLEMENTED METHODS FOR PRIVACY-PRESERVING FEDERATED LEARNING” filed on Feb. 18, 2020, the contents of which are incorporated by reference herein in their entirety. It should be appreciated, as described herein, that in some other embodiments one or more sub-models are trained in a privacy-preserving manner via communication with a privacy-preserving federated learning system, and one or more sub-models is not trained in such a privacy-preserving manner. For example, one or more other sub-models may be trained local to the user device, and/or in a manner that exposes data to one or more third-parties permissioned to access such data. The privacy-preserving manner of maintaining one or more model(s) provides further improvements in the accuracy of such model(s) based on trends learned by various implementations on different training data without exposing such training data to unintended third parties.

In this regard, the user's device may store and/or process information associated with previous searches, previous selected search results, preferences by of the user, interests and/or disinterests, and/or the like, that may be utilized to train local models accessible on the user device. For one or more of such model(s), masked versions of the model(s) on the user devices may be utilized to perform updated training of the privacy-preserving personalized search model and/or sub-models of the privacy-preserving personalized search model for distribution back to the user device, and/or other user devices, without exposing the data associated with the user's search activities. Training such model(s) via the privacy-preserving federated learning system in a manner that maintains the privacy of such data enables embodiments to provide search personalization without exposure of the data associated with user's search activities. Additionally, as users continue to interact with such embodiments, updated training may be performed in the same or a similar manner to further improve the performance of privacy-preserving personalized data search without exposing such subsequent data for any one particular user. I some embodiments, one or more particular models are trained in the privacy-preserving manner whereas other model(s) are not to ensure particular model(s) are trained specifically for a particular user. For example, a context embedding model (e.g., BERT), and a dynamic contextual multi-armed bandit (e.g., using Thompson sampling) may each be trained local to a particular user account of or associated with a particular user device, and a learn to rank model utilized by the dynamic contextual multi-armed bandit may be trained in a privacy-preserving manner to enhance the accuracy of such a model based on trends determined from a plurality of individual user accounts without sacrificing user privacy protection of the data utilized for such training. In other embodiments, for example, both the context embedding model and learn to rank model are trained in a privacy-preserving manner.

### Definitions

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

The terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

The terms “comprising” means including but not limited to, and should be interpreted in the manner it is typically used in the patent context. Use of broader terms such as comprises, includes, and should be understood to provide support for, narrower terms such as consisting of, consisting essentially of, and comprised substantially of.

The terms “in one embodiment,” “according to one embodiment,” “in some embodiments,” and the like generally refers to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

The term “example” is used herein to mean “serving as an example, instance, or illustration.” Any implementation described herein as “example” is not necessarily to be construed as preferred or advantageous over other implementations.

The terms “computer-readable medium” and “memory” refer to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

The term “computing device” refers to any computer embodied in hardware, software, firmware, and/or any combination thereof. Non-limiting examples of computing devices include a personal computer, a server, a laptop, a mobile device, a smartphone, a fixed terminal, a personal digital assistant (“PDA”), a kiosk, a custom-hardware device, a wearable device, a smart home device, an Internet-of-Things (“IoT”) enabled device, and a network-linked computing device.

The term “set” when used with respect to a particular type of data refers to one or more data objects embodying or including any number of data elements of the particular data type. For example, a “set of electronic resources” and an “electronic resource set” refer to one or more data objects embodying zero or more electronic resources. Similarly, a “set of search results” and a “search result set” refer to one or more data objects embodying zero or more search results. In some embodiments, a set is embodied in a particular defined order involving one or more ordered indices. In some embodiments, a set is unordered.

The term “search system” refers to one or more computing devices that execute search queries to identify any number of search results corresponding to the search query. A search system maintains at least one search index that enables search results to be identified via the search index for a particular search query. In some embodiments, the search system performs one or more non-personalized data-driven search process(es) to execute the search query, for example based on keyword matching between the search query and electronic resources represented in the search index.

The term “user profile” refers to data that embodies or is associated with a particular user or a particular client device. In some embodiments, a user profile is associated with a user profile identifier that uniquely represents the user or client device associated with or embodied by the user profile. A user profile may be associated with any of myriad of data based on user interactions and/or initiated processes, including a search history data comprising any number of previous search queries, a search engagement history comprising any number of previously engaged search results, one or more center(s) of interest and/or one or more center(s) of disinterest, and/or biographical data associated with a user (e.g., name, age, location, gender, and/or the like) and/or a user device (e.g. location, device age, IP address, and/or the like).

The term “user device” refers to a user-facing device that renders data visible to a particular end user and/or is under the control of a particular end user. A user device is specially configured utilizing hardware, software, firmware, and/or a combination thereof, to provide privacy-preserving personalized search functionality described herein

The terms “user input” and “user input data” refer to electronically managed data representing a user engagement with a user device and/or a display associated therewith. User input data, in some embodiments, embodies engagement provided by the user via one or more peripherals associated with a user device. In other embodiments, user input data embodies engagement by the user directly with one or more portions of the user device. Non-limiting examples of user input data includes keystroke data, mouse click data at a particular location of one or more user interface(s), mouse movement data, peripheral engagement data, voice input data, tap data on a touch-adaptive display, touch gesture data on a touch-adaptive display (e.g., swipe left, swipe right, pinch, long press, and the like), eye movement commands, user movement data, video input data, and user body gesture data (e.g., a user wave, body motion, head movement, and the like).

The term “privacy-preserving federated learning system” refers to one or more computing devices that, alone or in conjunction with one or more other computing devices, perform federated learning of one or more model(s) in a privacy-preserving manner, as described in U.S. patent application Ser. No. 16/792,981.

The term “electronic resource” refers to electronic data made available for searching by one or more computing device(s). In some embodiments, the same or associated computing device(s) provide access to view and/or otherwise interact with the electronic resource. Ae electronic resource may comprise any number of sub-information. Non-limiting examples of an electronic resource include a webpage, an electronic file, a portion of another electronic resource (e.g., a blog post of a website), and/or the like.

The term “extracted resource data” refers to a portion of information extracted from information of an electronic resource and/or derived from information of a portion of the electronic resource. Non-limiting examples of extracted resource data includes at least a portion of content data for an electronic resource, summary data for an electronic resource, an author of an electronic resource, a resource identifier for an electronic resource, a title of an electronic resource, and a data format for an electronic resource.

The terms “electronic resource content” and “content” refer to one or more substantive portions of text, video, or other data embodied within or as part of an electronic resource. It should be appreciated that different types of electronic resources may include different types of electronic content.

The term “resource context data” refers to electronically managed data embodying a representation of the context for the electronic content of an electronic resource. The resource context data is extracted by processing the electronic content to determine the contextual meaning of the electronic content.

The term “search query” refers to electronically managed data representing a request to identify a set of search results based on one or more terms, phrases, and/or other data that is embodied in or associated with the search query. In some embodiments, a search query includes at least one term to utilize for distilling a search index of all possible results.

The term “search result” refers to electronically managed data representing or otherwise serving as a pointer to a particular electronic resource. Non-limiting examples of a search result include a copy of the electronic resource, a URL (“Uniform Resource Locator”) to the electronic resource, a URI (“Uniform Resource Identifier”) to the electronic resource, and/or a pointer to the electronic resource.

The term “personalized search result” refers to a search result determined or otherwise identified as being sufficiently relevant to a particular user, user profile, and/or user device. In some embodiments, a personalized search result is determined utilizing a privacy-preserving personalized search model.

The term “user-selected search result” refers to a search result with which the user has engaged to indicate a desire to access and/or otherwise retrieve the electronic resource associated with the search result. For example, in some embodiments, a user interacts with a user-selected search result embodying a personalized search result provided to and/or otherwise rendered associated with an interface element accessible to the user.

The term “privacy-preserving personalized search model” refers to one or more algorithmic model, statistical model, and/or machine learning model that identify and/or otherwise generate one or more personalized search result(s) from a set of search results based on data associated with a particular user, user profile, and/or user device. A privacy-preserving personalized search model embodies or includes one or more sub-models that is/are trained in a privacy-preserving federated manner, such that the user data utilized to train the models and/or data embodied in the sub-models themselves are not exposed to unauthorized parties (e.g., parties other than the data owner and/or user of the trained models).

The term “sub-model” refers to one or more specially trained algorithmic model(s), trained statistical model(s), and trained machine-learning model(s) embodied and/or utilized by a privacy-preserving personalized search model. A sub-model is trained to perform a particular determination based on one or more identified features. It should be appreciated that different sub-models may utilize and/or maximize data representing different objective based on the same and/or different features.

The term “trained dynamic contextual multi-armed bandit” refers to a multi-armed bandit model associated with one or more sub-models that identifies a personalized search result from a set of search results based on particular data associated with a user profile and data associated with each search result. In some embodiments, the trained dynamic contextual multi-armed bandit is configured to maximize conversion of a personalized search result at the top of a list into a user-selected search result (e.g., maximize the likelihood a personalized search result provided for a user profile higher in a list results in user engagement or other access of the personalized search result).

The term “trained resource context model” refers to one or more algorithmic model(s), statistical model(s), and/or machine learning model(s) that is/are configured to extract context data for a particular search result and/or corresponding electronic resource.

The term “trained user domain preference model” refers to one or more algorithmic model(s), statistical model(s), and/or machine learning model(s) that is/are configured to generate data representing an affinity a user profile has for a particular domain corresponding to one or more search result(s). In an example context, a trained user domain preference model is configured to generate data representing whether a user profile prefers or otherwise has a particular affinity towards a particular web domain associated with a search result. In this regard, the trained user domain preference model may determine the user has a preference for a first domain (e.g., MSNBC.com) over a second domain (e.g., CNN.com).

The term “trained user content type preference model” refers to one or more algorithmic model(s), statistical model(s), and/or machine learning model(s) that is/are configured to generate data representing an affinity a user profile has for a particular domain corresponding to one or more search result(s). In an example context, a trained user content type preference model is configured to generate data representing whether a user profile prefers or has a particular affinity towards a particular medium of content associated with a search result. In this regard, the trained user content type preference model may determine the user has a preference for a first content type (e.g., video content) over a second content type (e.g., text content).

The term “trained user resource interest model” refers to one or more algorithmic model(s), statistical model(s), and/or machine learning model(s) that is/are configured to generate data representing an affinity a user profile has for a particular context of content represented by context data corresponding to one or more search result(s). In an example context, a trained user resource interest model is configured to generate data representing whether a user profile prefers or has a particular affinity towards a particular context associated with a search result. In some embodiments, a trained user resource interest model may determine the user has a preference (e.g., an “interest”) in a first context (e.g., interpretive dance) over a second context (e.g., law). In some embodiments, a trained user resource interest model is configured to generate data representing a non-affinity a user profile has for a particular context (e.g., a “disinterest”) of content represented by context data corresponding to one or more search result(s).

The term “center of interest” refers to data embodying a user affinity (or “interest”) for particular context data within in a multi-dimensional space mapping any number of distinct and/or related context data. A center of interest indicates that context data near to the center of interest in the mapped space is likely to be of interest to the user profile corresponding to the center of interest. In some embodiments, a center of interest represents particular context data embodying a context liked by a user based on input by the user indicating liked search results and/or corresponding electronic resources via a search preference training interface. In some embodiments, a center of interest is associated with a centroid age that represents the age of the center of interest since creation and/or update of the center of interest.

The term “center of disinterest” refers to data embodying a user non-affinity (or “disinterest”) for particular context data within a multi-dimensional space mapping any number of distinct and/or related context data. A center of disinterest indicates that context data near to the center of disinterest in the mapped space is likely not to be of interest to the user profile corresponding to the center of disinterest. In some embodiments, a center of disinterest represents particular context data embodying a context not liked by a user based on input by the user indicating disliked search results and/or corresponding electronic resources via a search preference training interface. In some embodiments, a center of disinterest is associated with a centroid age that represents the age of the center of disinterest since creation and/or update of the center of disinterest.

The term “context cluster” refers to electronically managed data embodying any number of search results and/or corresponding electronic resources that are related based on a shared context. In some embodiments, components of a context cluster are within a particular context distance from one another and/or from a particular point in a mapped space embodying the center of the context cluster.

The term “context distance” refers to electronically managed data representing a distance between a first context data representing a first point in a mapped contextual and a second context data representing a second point in the mapped contextual space.

The term “clustering context distance threshold” refers to electronically managed data embodying a maximum distance between context data(s), and/or between a context data and a center of an existing context cluster, for new context data associated with a search result to be associated with the existing context cluster.

The term “previously engaged search results” refers to electronically managed data embodying a previous user-selected search result engaged with and/or otherwise selected by a particular user profile.

The term “search model features” refers to electronically managed data utilized by a privacy-preserving personalized search model and/or one or more sub-models thereof.

The term “context-based result ranking score” refers to electronically managed data representing a likelihood a search result is likely to be of interest to a particular user for a particular search query such that the search result should be provided as a personalized search result. A plurality of search results are able to be ranked based on their corresponding context-based ranking scores. In some embodiments, one or more ordered sets of search results may be constructed for use in selecting search results for providing as personalized search results

The term “normalized result ranking score” refers to a context-based result ranking score adjusted based on one or more other factors and/or data values. In some embodiments, a normalized result ranking score for a search result embodies a context-based result ranking score based on a context distance between context data for the corresponding search result and a center of interest or a center of disinterest.

The term “selected context cluster” refers to a particular context cluster from which a search result is chosen to be selected for providing as a personalized search result.

The term “highest ranked search result” refers to a search result of a set of search results for a particular context cluster that has a highest context-based ranking score or highest normalized result ranking score. In some embodiments, the highest ranked search result of the search result set for a selected context cluster is selected for providing in a personalized search result set.

The term “personalized resource summary data” refers to extracted and/or generated data representing one or more aspects of a personalized search result and/or corresponding electronic resource that is relevant for use in user training of a privacy-preserving personalized search model and/or one or more sub-models utilized by a privacy-preserving personalized search model. Non-limiting example of personalized resource summary data includes metadata associated with a personalized search result and/or electronic resource, a portion of extracted content data for an electronic resource corresponding to a personalized search result, a generated or extracted headline for an electronic resource corresponding to a personalized search result, and/or a generated or extracted content summary for an electronic resource corresponding to a personalized search result.

The term “personalized resource summary interface element” refers to a renderable data object corresponding to a particular personalized search result that is configured to receive user engagement for indicating whether the user is interested in the personalized search result for a particular search query or disinterested in the personalized search result for the particular search query.

The term “search preference training interface” refers to a user interface or sub-interface rendered to receive user input data indicating interest or disinterest in any of a number of personalized search results, where such indications are utilized to train a privacy-preserving personalized search model and/or one or more sub-models thereof. A search preference training interface includes any number of personalized resource summary interface element(s) associated with any number of personalized search results and/or supporting interface controls.

The term “indication of interest or disinterest” refers to one or more data objects and/or data values that indicate whether a user profile is interested or disinterested in a particular personalized search result for a particular search query. In some embodiments, a single indication is generated that embodies a first data value representing interest in a particular personalized search result for a particular search query, and a second data value representing interest in a particular personalized search result for a particular search query, based on user input data received associated with a search preference training interface.

The term “disinterest investigation interface” refers to a user interface or sub-interface rendered to receive user input data embodying one or more reason(s) a user profile is disinterested in a particular personalized search result for a particular search query, where the indication of one or more reason(s) for such disinterest is/are utilized for updating at least one center of interest and/or at least one center of disinterest, updating training a privacy-preserving personalized search model, and/or updating training a sub-model of a privacy-preserving personalized search model.

The term “interest investigation interface” refers to a user interface or sub-interface rendered to receive user input data embodying one or more reason(s) a user profile is interested in a particular personalized search result for a particular search query, where the indication of one or more reason(s) for such interest is/are utilized for updating at least one center of interest and/or at least one center of disinterest, updating training a privacy-preserving personalized search model, and/or updating training a sub-model of a privacy-preserving personalized search model.

The term “user insight interface element” refers to a renderable data object corresponding to a particular interface component of an interest investigation interface or a disinterest investigation interface that that is configured to receive user input data for indicating a particular reason a user profile is interest or disinterested in a particular personalized search result for a particular search query.

The term “exploration deviation” refers to electronically managed data representing a probability a personalized search result should be generated from a particular context distance from one or more center(s) of interest or center(s) of disinterest.

### Example Systems of the Disclosure

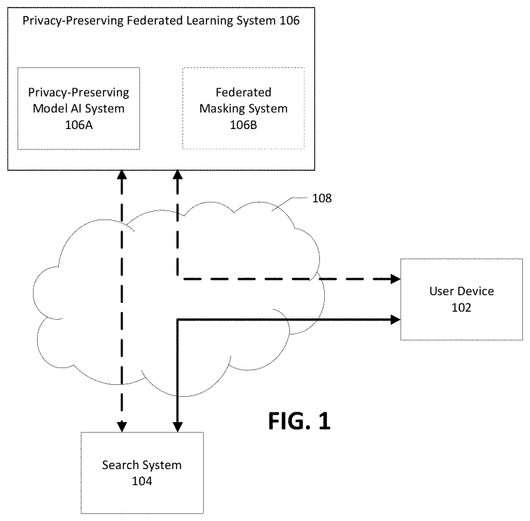

FIG. 1 illustrates a block diagram of an example privacy-preserving personalized search system that may be specially configured within which embodiments of the present disclosure may operate. As illustrated, the privacy-preserving personalized search system includes a user device 102 in communication with search system 104. As illustrated, the search system 104 is in communication with a privacy-preserving federated learning system 106. In some embodiments, the user device 102 is optionally communicable directly with the privacy-preserving federated learning system 106, for example for providing updated search model(s) in a privacy-preserving manner (e.g., via masked formats as described). Additionally or alternatively still, in some embodiments, the user device 102 is in communication with one or more other user device(s), for example to enable generation of at least one secure unmasking data object for unmasking a masked updated model for use. As illustrated, the user device 102 (and/or other user devices), the search system 104, and/or the privacy-preserving federated learning system 106 communicate over one or more communications network(s), such as the communications network 108.

User device 102 includes one or more computing devices embodied in hardware, software, firmware, and/or the like, accessible to a user for performing privacy-preserving personalized search functionality as described herein. In some embodiments, the user device 102 comprises a user's personal device (e.g., a smartphone, a mobile device, a personal computer, an enterprise terminal, and/or the like) utilizing specially configured software applications to perform such privacy-preserving personalized search functionality. In this regard, the user may interact with the user device 102 to perform particular privacy-preserving personalized search functionality. For example, in some embodiments, the user device 102 is specially configured via one or more user-facing applications (e.g., a user-facing privacy-preserving personalized search application and/or a user-facing privacy-preserving personalized search training application, or a single user-facing application providing both functionality).

The user device 102 may maintain any number of models and/or corresponding sub-models utilized for performing privacy-preserving search personalization. In some embodiments, each model is trained local to the user device 102, such that data particular to a user is not exposed to any third-party entities, systems, devices, and/or the like. Alternatively or additionally, in some embodiments, one or more of such model(s) is trained in a privacy-preserving manner via communication with the privacy-preserving federated learning system 106. For example, in some embodiments, the user device 102 maintains a learning to rank model that is trained using federated learning via communication with the privacy-preserving federated learning system 106. In this regard, data that corresponds to a particular user remains unexposed for use while retaining improved accuracy associated with learning data relationships from multiple users.

In some embodiments, for example, the user device 102 communicates with the privacy-preserving federated learning system 106 to generate and/or otherwise identify a privacy-preserving personalized search model and/or one or more sub-models trained in a privacy-preserving manner. In this regard, the user device 102 may receive and/or otherwise maintain such model(s) without exposing data associated with a user profile of the user device 102. For example, the particular search results selected associated with the user profile and/or interests of the user represented by the user profile may be utilized to train the privacy-preserving personalized search model and/or sub-models associated therewith in a privacy-preserving manner, such that the models may be trained for use without risking exposure to third-party entities and/or systems such as the search system 104 and/or the privacy-preserving federated learning system 106. The user device 102 may communicates with the search system 104 to identify a set of search results subsequently utilized to generate a personalized search result set utilizing the search model(s) on the user device 102.

The user device 102 may be specially configured to provide personalized search utilizing any number of the search model(s) maintained by and/or otherwise accessible to the user device 102. In some embodiments, each of the search model(s) is trained and/or updated locally and exclusively by the user device. In other embodiments, one or more search model(s) is updated via communication with third-party system(s), for example to aggregate trends and/or other data relationships learned across a plurality of user devices. In yet other embodiments, one or more search model(s) is/are trained and/or maintained in a privacy-preserving manner, for example such that the trends and/or data relationships learned by individual model(s) may be aggregated for purposes of generating a corresponding updated global model that may replace each individual model and subsequently continue to be iterated upon by each user device. It should be appreciated that any number of model(s) utilized by a particular user device may be trained in such manners. For example, in some embodiments no models are trained in a privacy-preserving manner, in other embodiments a portion of the model(s) are trained in a privacy-preserving manner, and in yet other embodiments all model(s) are trained in a privacy-preserving manner.

Search system 104 includes one or more computing devices embodied in hardware, software, firmware, and/or the like, configured to execute one or more search queries. In some embodiments, the search system 104 includes one or more specially configured server(s), database(s), and/or the like, that maintains a search index and executes search queries by identifying search results from the search index based on each search query. The search system 104 may crawl external systems and/or otherwise extract information associated with electronic resources stored or otherwise made available by such external systems. In other embodiments, the search system 104 retrieves a search index for processing from one or more external systems, databases, and/or the like.

Privacy-preserving federated learning system 106 includes one or more computing devices embodied in hardware, software, firmware, and/or the like, configured to train one or more models in a privacy-preserving manner. In some embodiments, for example, the privacy-preserving federated learning system 106 includes one or more server(s), database(s), and/or the like, specially configured to perform training of the one or more models, such as a privacy-preserving personalized search model and/or a sub-model associated therewith, in a privacy-preserving manner. In this regard, the privacy-preserving federated learning system 106 may generate an updated masked global model in a privacy preserving manner, the updated masked global model embodying a privacy-preserving personalized search model and/or a sub-model associated therewith. The updated masked global model, and/or a corresponding secured unmasking data object, for use in performing privacy-preserving personalized search functionality.

In some embodiments, for example as illustrated, the privacy-preserving federated learning system 106 includes or interacts with a privacy-preserving model AI system 106A. The privacy-preserving model AI system 106A may include any number of computing device(s) specially configured to generate an updated, global version of one or more model(s) based on various client versions of said model(s). For example privacy-preserving model AI system 106A may include one or more specially configured server(s), database(s), distributed system(s), cloud system(s) and/or individual cloud device(s), and/or the like. For a particular model type, for example a learn to rank model having an implementation maintained by each user device 102, the privacy-preserving model AI system 106A may receive (or otherwise retrieve) masked versions of each client model on various user device(s), and combine them to generate an updated masked global model for that model type. In this regard, the updated masked global model represents an updated version of that model type that learns trends and other data relationships from each of the masked client models of that model type. The updated masked global model is generated without exposing any of the individual data values utilized to train the various client models, and without exposing inferences and/or other data insights that may be present in the individual client models themselves utilizing the mask. In this regard, the privacy-preserving model AI system 106A may not receive any masking information that could enable the privacy-preserving model AI system 106A to unmask any of the individual client model(s) and/or the masked updated global model.

In some embodiments, for example as illustrated, the privacy-preserving federated learning system 106 optionally includes or interacts with federated masking system 106B. The federated masking system 106B may include any number of computing device(s) specially configured to generate a secure unmasking data object based on masking information for any number of client models, for example locally maintained by any number of user devices. For example federated masking system 106B may include one or more specially configured server(s), database(s), distributed system(s), cloud system(s) and/or individual cloud device(s), and/or the like, configured to perform such functionality. The federated masking system 106B may receive and/or retrieve, for example via request from various user devices such as the user device 102, masking information associated with each user device that was utilized to mask the corresponding client model for the user device. In this regard, the federated masking system 106B may combine such masking information for each user device (or “client”) and/or information regarding selected model(s) utilized to generate a masked updated global model (e.g., via the privacy-preserving model AI system 106A) to generate a secure unmasking data object that may be utilized to unmask the masked updated global model. The secure unmasking data object may subsequent be distributed to devices that are permissioned and/or otherwise intended to unmask and/or utilize the updated model, for example each user device including the user device 102.

In other embodiments, the federated masking system 106B is optionally not included. For example, in some embodiments, the functionality of the federated masking system 106B is subsumed by one or more other components of the described system. In some embodiments, one or more user devices (e.g., user device 102) performs the functionality of the federated masking system 106B. In this regard, masking information from various other user devices may be received by the user device 102 and utilized to generate the secure unmasking data object, which then gets distributed back to the other user devices. It should be appreciated that any one or more user device(s) from a set of user devices may be selected for generating such information, for example. In some such embodiments, the user devices are configured to receive and utilize both the updated masked global model and secure unmasking data object, enabling such user devices to unmask and store and/or utilize the updated global model. In this regard, the privacy-preserving federated learning system 106 may be embodied by or otherwise include solely a privacy-preserving model AI system 106A.

In some embodiments, a single device or system embodies multiple of the component systems and/or devices depicted and described in FIG. 1. For example, in some embodiments, a single device or system embodies the user device 102, search system 104, and privacy-preserving model AI system 106A. In particular embodiments, to ensure the privacy-preserving nature of the described functionality, at least two systems interact with one another to ensure that unauthorized, unpermissioned, and/or otherwise unintended third-party systems do not gain access to the masked model(s) and masked updated global model together with masking information and/or a secure unmasking data object.

In some embodiments, the communications network 108 includes any number of intermediary devices embodied in hardware, software, firmware, and/or any combination thereof. Such communications network 108 may be configured to operate utilizing any of a myriad of networking protocols. For example, in some embodiments, the communications network 108 includes hardware, software, and/or firmware that enables communication via a Bluetooth communication connection, near-field communication connection, Wi-Fi communication connection, a radio frequency communication connection, a cellular communication connection, and/or the like, between various communicating computing device(s). In some embodiments, the communications network 108 includes one or more base stations, relays, cell towers, intermediary processing servers and/or domain hosts, and/or associated connection wires and/or other associated physical connections. In some such contexts, the communications networks 108 includes one or more user-controlled devices facilitating access network to the communications network. For example, in some embodiments, the communications network 108 includes a router, modem, relay, and/or other user-controlled network access device that facilitates access to a particular public, private, and/or hybrid network.

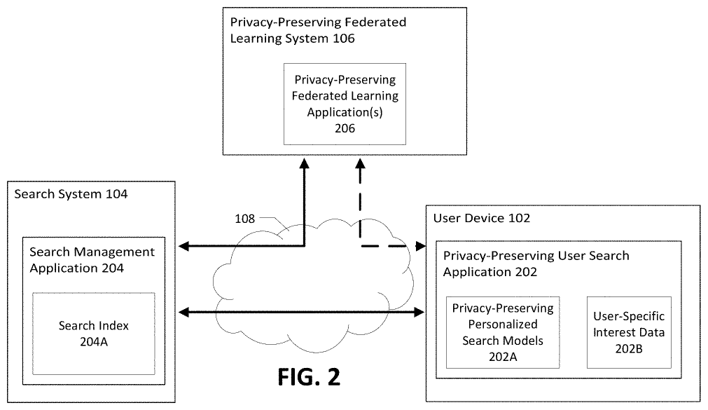

FIG. 2 illustrates a block diagram of detailed computing entities interacting of an example privacy-preserving personalized search system that may be specially configured within which embodiments of the present disclosure may operate. Specifically, as illustrated, the example privacy-preserving personalized search system includes the privacy-preserving federated learning system 106, the search system 104, and the user device 102, each including particular computing entities utilized by such computing devices. The various sub-entities are embodied in specially configured hardware, software, firmware, and/or a combination thereof. In some embodiments, for example, each of the sub-computing entities is embodied by specially configured software application(s) executed on the particular computing device(s), as described herein.

As illustrated, the privacy-preserving federated learning system 106 includes, executes, and/or otherwise is associated with privacy-preserving federated learning application(s) 206. The privacy-preserving federated learning application(s) 206 may be embodied by specially configured software that is configured to perform training of model(s) in a privacy-preserving manner. In this regard, the privacy-preserving federated learning application(s) 206 may receive masked client model(s), generate a masked updated global model based on the masked client model(s), and/or distribute the masked updated global model to one or more user devices (e.g., to the user device 102) for further utilization and/or processing.

For example, in some embodiments, the privacy-preserving federated learning application(s) 206 generate and/or otherwise cause distribution of masked updated global model(s) embodying a privacy-preserving personalized search model for use by the user device 102 in performing privacy-preserving personalized search functionality, and/or one or more sub-model(s) (trained in a privacy preserving manner) of a privacy-preserving personalized search model for use in performing such privacy-preserving personalized search functionality. In some embodiments, additionally or alternatively, the privacy-preserving federated learning application(s) 206 includes one or more software applications that generates a secure unmasking data object for use in unmasking the masked updated global model(s) for use. It should be appreciated that in circumstances where the privacy-preserving federated learning application(s) 206 includes a plurality of applications, such applications may be performed on the same computing hardware (e.g., all on one or more shared servers), or may be performed on various computing hardware (e.g., each performed on a different server, or certain applications sharing certain computing hardware distinct from computing hardware for executing other software applications, and/or the like).

As illustrated, the search system 104 includes, executes, and/or otherwise is associated with search management application 204. The search management application 204 may be embodied by specially configured software that is configured to perform maintenance of at least one search index, and/or execution of at least one search query utilizing the at least one search index. In this regard, the search management application 204 may generate, receive, and/or otherwise maintain at least a search index 204A embodying information associated with any number of electronic resources. The search index 204A may similarly link the electronic resource with one or more data value(s) for accessing the electronic resource, for example a URL, URI, IP address, or hostname where the electronic resource is stored. The search management application 204 may receive a search query (or multiple search queries) from a user device 102, and execute the search query by processing the search query and search index 204A to determine search results from the index that satisfy the search query. It should be appreciated that to determine the search results that satisfy a search query, the search management application 204 may be configured to perform any of a myriad of conventional search implementations, including keyword matching, result context matching, and/or the like. In some such embodiments, the search management application 204 transmits the search results to the user device 102A, in response to execution of the search query/queries, for further personalization and/or other processing.

As illustrated, the user device 102 includes, executes, and/or otherwise is associated with a privacy-preserving user search application 202. The privacy-preserving user search application 202 may be embodied by specially configured software that is configured to perform privacy-preserving personalized search functionality. In this regard, the privacy-preserving user search application 202 may generate and/or otherwise provide personalized search results for one or more search queries in a manner that does not expose the user's data to reading and/or use by external systems and/or third-party entities. The privacy-preserving user search application 202 may provide any number of user-facing user interfaces for interaction by a user to initiate and/or otherwise perform the privacy-preserving personalized search functionality and/or privacy-preserving personalized search training functionality.

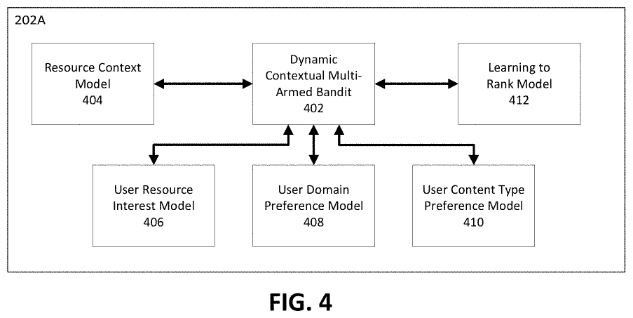

The privacy-preserving user search application 202 may include and/or otherwise utilize any of a myriad of data objects and/or data values to perform such privacy-preserving personalized search functionality. For example, as illustrated, the privacy-preserving user search application 202 may include and/or otherwise maintain privacy-preserving personalized search model(s) 202A. The privacy-preserving personalized search model(s) 202A may include a privacy-preserving personalized search model and/or one or more sub-models utilized to perform privacy-preserving personalized search functionality as described herein. For example, in some embodiments, the privacy-preserving personalized search model(s) 202A is embodied by and/or includes the various models depicted and described with respect to FIG. 4 herein. It should be appreciated that one or more, or all, of the privacy-preserving personalized search model(s) 202A may be trained in a privacy-preserving manner. For example, in some embodiments, one or more of the privacy-preserving personalized search model(s) 202A are trained local to the user device 102, for example utilizing data particular to the user (or users) of the user device 102. Additionally or alternatively, in some embodiments, one or more of the privacy-preserving personalized search model(s) 202A is/are via communication with the privacy-preserving federated learning system 106 to enable updating and use of such model(s) to account for data relationships and trends learned from multiple user devices without exposing user data for a particular profile associated with the user device 102. For example, in some embodiments, a client-side and/or local model may be trained on the user device 102, and utilized to generate a globally updated model for use by the user device 102, and/or other user device(s), utilizing the privacy-preserving federated learning system 106 in a privacy-preserving federated manner.

Additionally or alternatively, the privacy-preserving user search application 202 may include and/or otherwise maintain user-specific interest data 202B. The user-specific interest data 202B may include data associated with a particular user profile that is utilized for performing privacy-preserving personalized search functionality as described herein. For example, the user-specific interest data 202B may include any data utilized for training one or more of the privacy-preserving personalized search model(s) 202A. In this regard, the user-specific interest data 202B may be collected, generated/and/or derived from the user's interactions with the privacy-preserving user search application 202, and utilized to improve the accuracy of such privacy-preserving personalized search model(s) 202A with respect to generating and/or otherwise identifying personalized search results for a particular search query.

It should be appreciated that the user-specific interest data 202B may include any of a myriad of data inputted into, received by, processed by, generated by, and/or otherwise derived from use of the privacy-preserving user search application 202. Non-limiting examples of such user-specific interest data includes, for each particular user profile, search queries input by the user profile, previously-engaged search results associated with the user profile, center of interest data associated with the user profile, center of disinterest data associated with the user profile, It should be appreciated that the user device 102 may be associated with only a single user profile (e.g., representing specifically the user of the user device 102 and/or the user device 102 itself), and/or may be associated with any number of user profiles (e.g., in a circumstance where a user logs into a particular user profile for using that user profile to access particular privacy-preserving personalized search functionality via the user device 102).

### Example Apparatuses of the Disclosure

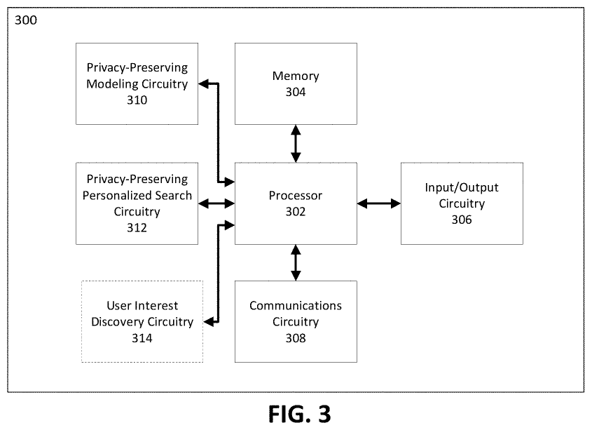

Having discussed example systems structured in accordance with the present disclosure, example apparatuses configured in accordance with the present disclosure will now be described. In some embodiments, the specially configured user device 102 is embodied by one or more computing systems, such as the privacy-preserving user apparatus 300 as depicted and described in FIG. 3. The privacy-preserving user apparatus 300 includes processor 302, memory 304, input/output circuitry 306, communications circuitry 308, privacy-preserving modeling circuitry 310, privacy-preserving personalized search circuitry 312, and user interest discovery circuitry 314. The privacy-preserving user apparatus 300 may be configured, using one or more of the sets of circuitry 302, 304, 306, 308, 310, 312, and/or 314, to execute the operations described herein.

Although components are described with respect to functional limitations, it should be understood that the particular implementations necessarily include the use of particular computing hardware. It should also be understood that certain of the components described herein may include similar or common hardware. Two sets of circuitry, for example, may both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the privacy-preserving user apparatus 300 may provide or supplement the functionality of another particular set of circuitry. For example, the processor 302 in some embodiments provides processing functionality to any of the sets of circuitry, the memory 304 provides storage functionality to any of the sets of circuitry, the communications circuitry 308 provides network interface functionality to any of the sets of circuitry, and/or the like.

In some embodiments, the processor 302 (and/or co-processor or any other processing circuitry assisting or otherwise associated with the processor) may be in communication with the memory 304 via a bus for passing information among components of the privacy-preserving user apparatus 300. In some embodiments, for example, the memory 304 is non-transitory and may include, for example, one or more volatile and/or non-volatile memories. In other words, for example, the memory 304 in some embodiments includes or embodies an electronic storage device (e.g., a computer readable storage medium). In some embodiments, the memory 304 is configured to store information, data, content, applications, instructions, or the like, for enabling the privacy-preserving user apparatus 300 to carry out various functions in accordance with example embodiments of the present disclosure.

The processor 302 may be embodied in a number of different ways. For example, in some example embodiments, the processor 302 includes one or more processing devices configured to perform independently. Additionally or alternatively, in some embodiments, the processor 302 includes one or more processor(s) configured in tandem via a bus to enable independent execution of instructions, pipelining, and/or multithreading. The use of the terms “processor” and “processing circuitry” may be understood to include a single core processor, a multi-core processor, multiple processors internal to the privacy-preserving user apparatus 300, and/or one or more remote or “cloud” processor(s) external to the privacy-preserving user apparatus 300.

In an example embodiment, the processor 302 may be configured to execute instructions stored in the memory 304 or otherwise accessible to the processor 302. Alternatively or additionally, the processor 302 in some embodiments, is configured to execute hard-coded functionality. As such, whether configured by hardware or software methods, or by a combination thereof, the processor 302 may represent an entity (e.g., physically embodied in circuitry) capable of performing operations according to an embodiment of the present disclosure while configured accordingly. Alternatively or additionally, as another example in some example embodiments, when the processor 302 is embodied as an executor of software instructions, the instructions may specifically configure the processor 302 to perform the algorithms embodied by the specific operations described herein when the instructions are executed.

As one particular example, the processor 302 may be configured to perform various operations associated with performing privacy-preserving personalized search functionality and/or associated training. In some embodiments, the processor 302 includes hardware, software, firmware, and/or a combination thereof, that receives a search result set associated with a search query, generates a personalized search result set from the search result set by applying the search result set to a privacy-preserving personalized search model, and/or outputting the personalized search result set. Additionally or alternatively, in some embodiments, the processor 302 includes hardware, software, firmware, and/or a combination thereof, that receives a search query inputted by a user, and/or processes the search query, such as by transmitting the search query to a search system. Additionally or alternatively still, in some embodiments, the processor 303 includes hardware, software, firmware, and/or a combination thereof, that receives user input data indicating a user-selected search result from the personalized search result set, and processing the user input data indicating the user-selected search result.

Additionally or alternatively, in some embodiments, the processor 302 includes hardware, software, firmware, and/or a combination thereof, that performs training of a privacy-preserving personalized search model and/or associated sub-models for use in performing privacy-preserving personalized search functionality as described herein. Additionally or alternatively, in some embodiments, the processor 302 includes hardware, software, firmware, and/or a combination thereof, that generates and/or causes rendering of a user preference training interface associated with one or more personalized search results. Additionally or alternatively still, in some embodiments, the processor 302 includes hardware, software, firmware, and/or a combination thereof, that receives user input data associated with one or more personalized search results, and/or updates the privacy-preserving personalized search model based on an indication associated with such user input data.

In some embodiments, the privacy-preserving user apparatus 300 includes input/output circuitry 306. In some such embodiments, the input/output circuitry 306, in turn, is in communication with processor 302 to provide output to the user and, in some embodiments, to receive an indication of a user input. The input/output circuitry 306 may comprise one or more user interface(s) and may include a display that may comprise the interface(s) rendered as a web user interface, an application interface, a user device, a backend system, or the like. In some embodiments, the input/output circuitry 306 may also include a keyboard, a mouse, a joystick, a touch screen, touch areas, soft keys, a microphone, a speaker, and/or other input/output mechanisms. The processor 302, and/or input/output circuitry 306 comprising the processor 302, may be configured to control one or more functions of one or more user interface elements through computer program instructions (e.g., software and/or firmware) stored on a memory accessible to the processor 302 (e.g., memory 304, and/or the like).

In some embodiments, the privacy-preserving user apparatus 300 includes communications circuitry 308. The communications circuitry 308 includes any means, such as a device or circuitry embodied in either hardware or a combination of hardware and software, that is configured to receive and/or transmit data from/to a network and/or any other device, circuitry, or module in communication with the privacy-preserving user apparatus 300. In this regard, the communications circuitry 308 may include, for example, a network interface for enabling communications with a wired or wireless communications network. For example, the communications circuitry 308 may include one or more network interface card(s), antenna(s), bus(es), switch(es), router(s), modem(s), and supporting hardware and/or software, or any other device suitable for enabling communications via one or more communications network(s). Additionally or alternatively, the communications circuitry 308 may include circuitry for interacting with the antenna(s) and/or other hardware or software to cause transmission of signals via the antenna(s) or to handle receipt of signals received via the antenna(s).

The privacy-preserving user apparatus 300 includes privacy-preserving modeling circuitry 310. The privacy-preserving modeling circuitry includes hardware, software, firmware, and/or a combination thereof, configured to support functionality associated with configuring a privacy-preserving personalized search model, and/or sub-models associated therewith. For example, in some embodiments, the privacy-preserving modeling circuitry 310 includes hardware, software, firmware, and/or a combination thereof, that trains the privacy-preserving personalized search model and/or one or more sub-models associated therewith in a privacy-preserving manner via communication with a privacy-preserving federated learning system. Additionally or alternatively, in some embodiments, the privacy-preserving modeling circuitry 310 includes hardware, software, firmware, and/or a combination thereof, that maintains a set of context clusters associated with one or more electronic resources corresponding to and/or otherwise embodying search result(s). Additionally or alternatively, in some embodiments, the privacy-preserving modeling circuitry 310 includes hardware, software, firmware, and/or a combination thereof, that generates, updates, and/or otherwise maintains one or more center(s) of interest and/or one or more center(s) of disinterest associated with a particular user profile. It should be appreciated that, in some embodiments, the privacy-preserving modeling circuitry 310 includes a separate processor, specially configured field programmable gate array (FPGA), or a specially programmed application specific integrated circuit (ASIC).

The privacy-preserving user apparatus 300 includes privacy-preserving personalized search circuitry 312. The privacy-preserving personalized search circuitry 312 includes hardware, software, firmware, and/or a combination thereof, configured to support functionality associated with performing personalized search query execution in a privacy-preserving manner and/or otherwise privacy-preserving personalized search functionality. For example, in some embodiments, the privacy-preserving personalized search circuitry 312 includes hardware, software, firmware, and/or a combination thereof, that receives a search result set associated with a search query, and/or receives and transmits the search query for execution to receive the search result set. Additionally or alternatively, in some embodiments, the privacy-preserving personalized search circuitry 312 includes hardware, software, firmware, and/or a combination thereof, that generates a personalized search result set from the search result set by applying the search result set to a privacy-preserving personalized search model. Additionally or alternatively, in some embodiments, the privacy-preserving personalized search circuitry 312 includes hardware, software, firmware, and/or a combination thereof, that outputs the personalized search result set. In some embodiments, the privacy-preserving personalized search circuitry 312 includes hardware, software, firmware, and/or a combination thereof, that generates and/or otherwise causes rendering of user interfaces associated with such functionality, for example a user query interface for inputting a search query, a personalized results interface for displaying personalized search results for selection by a user, and/or one or more resource access interfaces including resource content for one or more electronic resource(s) accessed by a user. In some example contexts, the resource access interface is rendered via a web browser utilized to access a particular web resource via the Internet. It should be appreciated that, in some embodiments, the privacy-preserving personalized search circuitry 312 may include a separate processor, specially configured field programmable gate array (FPGA), or a specially programmed application specific integrated circuit (ASIC).

In some embodiments, the privacy-preserving user apparatus 300 optionally includes the user interest discovery circuitry 314. In some embodiments, the user interest discovery circuitry 314 is provided as a separate computing device, software application, and/or the like that communicates with the privacy-preserving user apparatus 300 for providing such functionality. The user interest discovery circuitry 314 includes hardware, software, firmware, and/or a combination thereof, configured to support functionality associated with collecting user-specific interest data and/or updating one or more model(s) based on such data. For example, in some embodiments, the user interest discovery circuitry 314 includes hardware, software, firmware, and/or a combination thereof, that generates personalized resource summary data for one or more personalized search result(s). Additionally or alternatively, in some embodiments, the user interest discovery circuitry 314 includes hardware, software, firmware, and/or a combination thereof, that causes rendering of user preference training interface(s) and/or particular interface elements associated with the personalized resource summary data, and/or causes updated rendering of the user preference training interface(s) upon user input. Additionally or alternatively, in some embodiments, the user interest discovery circuitry 314 includes hardware, software, firmware, and/or a combination thereof, that receiving user input data associated with particular personalized resource summary interface element(s) and/or processing such user input data. Additionally or alternatively, in some embodiments, the user interest discovery circuitry 314 includes hardware, software, firmware, and/or a combination thereof, that causes updating of a privacy-preserving personalized search model based on user input data associated with one or more personalized resource summary interface element(s). Additionally or alternatively, in some embodiments, the user interest discovery circuitry 314 includes hardware, software, firmware, and/or a combination thereof, that causes rendering of an interest investigation interface and/or disinterest investigation interface associated with an engaged personalized resource summary interface. It should be appreciated that, in some embodiments, the user interest discovery circuitry 314 may include a separate processor, specially configured field programmable gate array (FPGA), or a specially programmed application specific integrated circuit (ASIC).

It should be further appreciated that, in some embodiments, one or more of the sets of circuitry 302-314 are combinable. Alternatively or additionally, in some embodiments, one or more of the modules performs some or all of the functionality described associated with another component. For example, in some embodiments, the privacy-preserving modeling circuitry 310, privacy-preserving personalized search circuitry 312, and/or the user interest discovery circuitry 314 are combined into a single set of circuitry that performs the actions of both. Similarly, in some embodiments, one or more of the privacy-preserving modeling circuitry 310, privacy-preserving personalized search circuitry 312, and/or user interest discovery circuitry 314 is combined with or embodied by the processor 302, such that the processor 302 performs one or more of the operations described above with respect to each of the privacy-preserving modeling circuitry 310, privacy-preserving personalized search circuitry 312, and/or the user interest discovery circuitry 314.

### Example Data Objects and Data Interactions of the Disclosure

Having discussed example systems and apparatuses in accordance with the present disclosure, example data and interactions between such data will now be described. In some embodiments, the various data described may be embodied by and/or otherwise maintained in a computing environment embodied by one or more computing devices, such as the specially configured user device 102, search system 104, and/or privacy-preserving federated learning system 106, for performing the functionality described herein. In this regard, one or more software applications may maintain such data and/or perform the data interactions as described.

FIG. 4 illustrates a visualization of example privacy-preserving personalized search models 202A in accordance with at least some example embodiments of the present disclosure. Specifically, as illustrated, the privacy-preserving personalized search models 202A includes a dynamic contextual multi-armed bandit 402 configured to utilize a plurality of sub-models 404-412. The plurality of sub-models include a resource context model 404, a user resource interest model 406, a user domain preference model 408, a user content type preference model 410, and a learning to rank model 412. One or more of the sub-models 404-412 may be trained in a privacy-preserving manner via communication with a privacy-preserving federated learning system, and/or some or all of the sub-models 404-412 may be trained local to a particular user device (e.g., embodied by a specially configured user apparatus 300).

The dynamic contextual multi-armed bandit 402 is a specially configured algorithmic, statistical, and/or machine learning model that selects a search result for including as a personalized search result associated with a particular user query for a particular user profile, and/or otherwise generates a personalized search result set for the particular user query for a particular user profile. In this regard, the dynamic contextual multi-armed bandit 402 may optimize the likelihood that a search result selected as a personalized search result for a particular user profile will be accessed by a user associated with the user profile for a particular search query. In this regard, the dynamic contextual multi-armed bandit 402 may select such personalized search result(s) based on any of a myriad of user-specific interest data for a particular user profile. The user-specific interest data may represent interests and/or disinterests associated with the user profile based on interactions with the privacy-preserving personalized search functionality, for example embodying from or otherwise derived from user interactions with the privacy-preserving personalized search functionality as described herein. As depicted, the dynamic contextual multi-armed bandit 402 may utilize the plurality of sub-models 404-410 to generate such user-specific interest data for use.

The resource context model 404 embodies one or more statistical, algorithmic, and/or machine learning model(s) that generate context data for a particular electronic resource. In this regard, the context data for a particular electronic resource embodies a data value that represents the particular subject matter of the electronic resource. In an example context where the electronic resources represent website content and the search results represent links to such website content, the context data associated with a particular search result may represent the subject matter of the content data for the website. A sports blog article about football, for example, may be associated with context data representing the particular sport of football, and a cooking article about French cuisine may be associated with context data representing French cuisine. It should be appreciated that electronic content and/or corresponding search results may be associated with context data representing any level of granularity. For example, an electronic resource representing a sports blog article about a particular sports athlete may be associated with context data representing sports generally (e.g., “sports”), the particular sport (e.g., “football”), sports athletes for the particular sport (e.g., “football athletes”), the particular athlete (e.g., “Athlete A”), and/or the like.

The resource context model 404 may generate the context data based on particular portion(s) of an electronic resource and/or related metadata. For example, in some embodiments, resource context model 404 is trained to generate the context data based on title data for the electronic resource, and/or particular snippets and/or extracted portions of content data (e.g., an abstract, a first paragraph, extracted paragraphs and/or sentences, and/or another deterministic and/or algorithmically extracted portion of content data). Non-limiting examples of the resource context model 404 includes a specially configured implementation of the Bidirectional Encoder Representations and Transformers (“BERT”) models made available by Google, LLC of Mountain View, Calif. In some such embodiments, a mobile or otherwise limited implementation of BERT, such as one that utilizes a single language implementation and/or limited language set, is utilized to reduce the size of the implementation and/or enable use of the BERT implementation on computing devices with limited hardware capabilities (e.g., mobile devices where storage space, RAM capacity, and/or processing power is limited). In other embodiments, the resource context model 404 may be embodied by another model type, algorithm, and/or implementation. For example, in circumstances where the specially configured user device 300 is computing resource restricted (e.g., embodies a mobile device with limited processing power, memory resources, and/or the like), the resource context model 404 may be embodied by any of a myriad of algorithmic, statistical, and/or machine-learning models for determining and/or embedding the context of a particular electronic resource within a particular embedding space while also meeting operational requirements for use in such a resource-constrained environment.

In some embodiments, the resource context model 404 is utilized to generate context clusters associated with the various electronic resources and/or corresponding search results. In this regard, context data corresponding to particular electronic resources and/or search results may be mapped in a particular multivariate space representing such contexts. The resource context model 404 may cluster new context data for a particular electronic resource based on a context distance from a data value representing the center of a context cluster, for example based on the context data for each electronic resource in the cluster. The context distance to each center of the context cluster may be identified such that, if it is determined that the context distance exceeds a particular clustering context distance threshold, a new context cluster is formed. Otherwise, if the clustering context distance threshold is not satisfied, the context data for the electronic resource may be added to the existing context cluster. It should be appreciated that such clustering methodologies should be performed for any number of electronic resources.

The user resource interest model 406 embodies one or more statistical, algorithmic, and/or machine learning model(s) that generate center of interest data and/or center of disinterest data for a particular user profile. In this regard, each center of interest generated and/or otherwise determined by the user resource interest model 406 embodies context data representing or that otherwise maps to a context likely to be of interest to the particular user profile within the multivariate space representing the various contexts of the electronic resources. Similarly, contexts represented closer to the center of interest (e.g., with a lower context distance from the center of interest) are likely to similarly be of interest for the user profile than contexts represented by contextual data further from the center of interest. Each center of disinterest generated and/or otherwise determined by the user resource interest model 406 similarly embodies context data representing or that otherwise maps to a context within the multivariate space representing the various contexts of the electronic resources likely to be not of interest to the particular user profile. Similarly, contexts represented closer to the center of disinterest (e.g., with a lower context distance from the center of disinterest) are likely to similarly not be of interest for the user profile than contexts represented by contextual data further from the center of disinterest. Context data for search results may be determined and/or processed to determine, with respect to the centers of interest and/or disinterest for the user profile corresponding to the search query and/or the context data for other search results, which search result is best for providing as a personalized search result.

The user domain preference model 408 embodies one or more statistical, algorithmic, and/or machine learning model(s) that determine preferred domains associated with search result(s) for providing as personalized search result(s). In this regard, the user domain preference model 408 may determine, for example from user-specific interest data, the domains from which a user associated with the user profile is most likely to access electronic resources. Such information may be utilized to determine whether a user associated with the user profile is likely to access a particular search result having particular domain data, and/or similarly whether the search result should be selected as a personalized search result based at least in part on such domain preferences. In an example context, for example, each search result is associated with or includes domain data associated with the location where a corresponding electronic resource is stored (e.g., a particular hostname for an Internet system). In this regard, the domain data may represent an identifier for such system(s) (e.g., “CNN.com” or just “CNN” for electronic resources made available via an Internet-based system or website associated with Cable News Network media company as opposed to “BBC.com” or just “BBC” for electronic resources made available via an Internet-based system or website associated with the British Broadcasting Corporation). Based on such previously-engaged search results, for example, the user domain preference model 408 may determine that a particular user profile prefers CNN.com search results as opposed to BBC.com search results, and/or otherwise generate domain preference data representing a probability that a user associated with the user profile will access the particular search result based on the domain data associated therewith.

The user content type preference model 410 embodies one or more statistical, algorithmic, and/or machine learning model(s) that determine preferred content types associated with search result(s) for providing as personalized search result(s). In this regard, the user content type preference model may determine, for example from user-specific interest data, the content types associated with electronic resources a user associated with the user profile is most likely to access. Such information may be utilized to determine whether a user associated with the user profile is likely to access a particular search result having particular content type data, and/or similarly whether the search result should be selected as a personalized search result based at least in part on such content type preferences. In an example context, for example, each search result is associated with or includes content type data representing the content type for content data of the electronic resource. In this regard, the content type data may represent an identifier for such types of content (e.g., video content, text content, image content, and/or the like). Based on previously-engaged search results, for example, the user content type preference model 410 may determine that a particular user profile prefers electronic resources of a video content type as opposed to electronic resources of a text content type, and/or otherwise generates content type preference data representing a probability that a user associated with the user profile will access the particular search result based on the content type data associated therewith.

It should be appreciated that, in other implementations, other sub-models associated with processing electronic resources may be generated and/or utilized. For example, in some embodiments, another trained sub-model is utilized that processes preferences for another aspect of the electronic data. It should further be appreciated that such sub-models may process aspects of electronic content at any desired level of granularity. In one or more embodiments, for example, a sub-model may generate preference data for a user profile associated with the preference of a user profile for electronic resources based on length (e.g., time length for video content or audio content, and/or number or words for text content). Any determinable user preference may be associated with a particular sub-model that produces data usable by the dynamic contextual multi-armed bandit 402.

In some embodiments, the learning to rank model 412 embodies one or more machine learning, algorithmic, and/or statistical model(s) that ranks search results of a search result set. The learning to rank model 412 may rank such search results based on any number of a myriad of factors, such as interests and/or disinterests associated with a particular user (e.g., corresponding to a particular user account). In this regard, in some embodiments, the dynamic contextual multi-armed bandit 402 is configured to utilize the trained learning to rank model 412 for ranking such search results based on context data associated with each search result. In some embodiments, the learning to rank model 412 generates ranking for search results based on factors associated with one or more other sub-model(s) (e.g., domain preferences, content type preferences, and/or the like).

The learning to rank model 412 may be embodied in any of a myriad of ways. Additionally or alternatively, the learning to rank model 412 may utilize any of a number of evaluation metrics and utilize any of a myriad of processing approach(es). For example, in some embodiments, the learning to rank model 412 may be embodied by any of a number of model types configured to utilize particular evaluation metrics and/or approaches. Non-limiting examples of the learning to rank model 412 include ListRank or associated ListNet implementations, and/or LambdaRank and related Lambda-implementations.

The learning to rank model 412 may be configured to rank search results based on a particular set of factors (e.g., model features) and corresponding trained set of weights for said factors. In some such embodiments, the learning to rank model is trained in a privacy-preserving manner, such that a specially configured version of the model maintained on the user device (e.g., embodied by the specially configured user apparatus 300) may be utilized for personalization on said user device, and additionally used for training of the model on multiple user devices without exposing an individual user's data to third-party entities and/or systems. Such training in a privacy-preserving manner may enable the generation of model weights for the learning to rank model 412 based on learned trends and/or data relationships from one or more users without exposing the individual data of each user.

As described, one or more of the sub-models may be trained in a privacy-preserving manner via communication with a privacy-preserving federated learning system. For example, each of the sub-models may be trained as a client model, and subsequently masked for updating in combination with one or more other client models. The masked client models may be updated into a masked updated global model by the privacy-preserving federated learning system. The masked updated global model may represent an updated version of the model without having exposed the data utilized to train any of the individual client models. Masking information utilized to mask each client model may be combined into a secure unmasking data object usable to unmask the masked updated global model. In this regard, the masked updated global model and secure unmasking data object may be distributed to various client devices to enable each client device to utilize, and/or continue to locally update through subsequent training, the updated global model upon unmasking. Such training may occur for any number of models and may occur any number of times (e.g., at various intervals, upon user request, and/or the like). For example, each sub-model may be trained in a similar privacy-preserving manner on a monthly basis to ensure that the client models remain reasonably up-to-date to maintain the accuracy of such models for use over time.

The dynamic contextual multi-armed bandit may utilize the data generated and/or otherwise determined by the one or more sub-models. For example, the content type preference data, the domain preference data, the centers of interest and/or disinterest, and/or the like, may be processed to select a search result for providing as a next personalized search result in a list of personalized search results. For example, such generated and/or otherwise determined data may be utilized in one or more algorithms embodied by or utilized by the dynamic contextual multi-armed bandit.

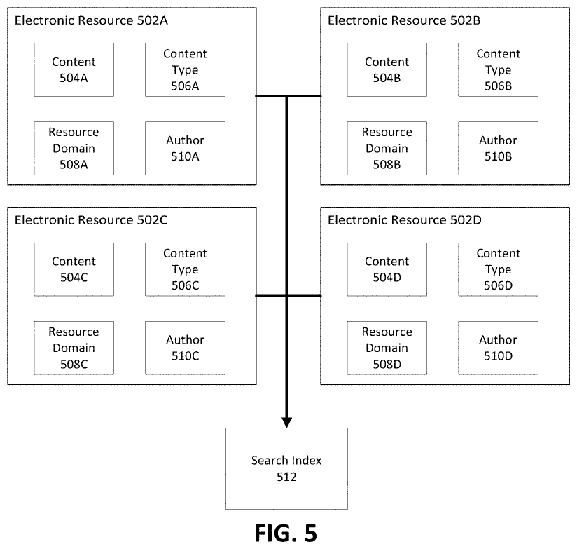

FIG. 5 illustrates a visualization of search index generation in accordance with at least some embodiments of the present disclosure. Specifically, the search index 504 is generated from a plurality of electronic resources, such as the electronic resources 502A-502D (collectively “electronic resources 502”). In some embodiments, the search index 504 may be generated, maintained, updated, and/or otherwise stored by a search system.

The search index 504 may be generated from any number of electronic resources, each of which may be associated with various data values, sub-objects, metadata, and/or the like. It should be appreciated that each electronic resource may be retrieved by any of a number of disparate systems accessible to the search system generating the search index. For example, the search system may crawl any number of external systems to index electronic resources accessible by such external systems in any of a myriad of manners, and/or otherwise identify and/or extract information associated with each electronic resource from various external systems in any of a myriad of manners known in the art. For example, the search system may crawl and index electronic resources made on external systems of a particular network (e.g., systems on the Internet, systems of a particular private network, and/or the like) to create the search index 504 based on electronic resources stored by such systems.

As illustrated, for example, each of the electronic resources 502 is associated with a plurality of data. Each electronic resource may be associated with content data 504A-504D. The content data may represent text data in one or more portions (a title, a content body, a blog post, and/or the like), image data, video data, and/or other data alone or in combination that embodies the content of the particular electronic resource. Such data may be indicated as content utilizing one or more data tags, and/or any other methodologies known in the art for enabling content to be identified, parsed, and/or extracted.

The electronic resources 502 each are associated with or include various non-content metadata. As illustrated, for example, the electronic resources 502 each are associated with a content type 506A-506D, a resource domain 508A-508D, and an author 510A-510D. Metadata embodying the values for each of these data properties may be included in and/or otherwise derived from the corresponding electronic resource. For example, the content type 506A may embody data indicating the format of the content data 504A (e.g., whether the content includes video content, image content, text content, and/or a combination thereof). The resource domain 508A may embody data indicating a hostname, IP address, and/or other resource locator that may be accessed to retrieve the corresponding electronic resource 502A. The author 510A may embody data representing the name of the creator or owner of the content data 504A of the electronic resource 502A. The resource domain 508A-508D may embody data representing an identifier for where the corresponding electronic resource can be located (e.g., on a particular network, such as a website address or portion thereof). In this regard, the electronic resource 502B, the electronic resource 502C, and the electronic resource 502E may each include values for such data vales representing such properties. Alternatively or additionally, the resource domain 508A-508D may embody data representing a web domain associated with the corresponding electronic resource. It should be appreciated that, in other embodiments, any number of additional and/or alternative data properties may be represented by data of an electronic resource and/or derived from data of an electronic resource.

The search index 504 may be generated from any or all of the data associated with each of the electronic resources 502. For example, in some embodiments, the search index 504 is generated based on the words and/or other data embodying the content of each of the electronic resources 502. In one such example context, the search index 512 generated based on the content data 504A-504D may be used to keyword match terms associated with a search query to the content portion of each electronic resource. In other embodiments, the search index 512 is generated based on the content, and various metadata included in and/or otherwise associated with each of the electronic resources 502. For example, the search index 512 may be generated to account for data associated with the content data 504A-504D, content type 506A-506D, resource domain 508A-508D, and author 510A-510D. In one such example context, the search index 512 generated based on the content, metadata portions, and/or other data associated with each of the electronic resources 502 may be used to keyword match terms associated with a search query to any one or more data portions of an electronic resource.

The search system may store the search index 512 for use in executing search queries and identifying a corresponding search result set for each received search query. In this regard, the search system may receive a search query from a user device, for example, and process the search query by matching search terms of the search query via the search index 514 to any number of electronic resources. The search system may return search results that represent portion of data associated with such electronic resources determined to satisfy the search query based on the term matching (or any other determination(s)), for example an extracted and/or generated summary of the content for the electronic resource, and/or pointers (e.g., IP addresses, URLs, URIs, and/or the like) that may be utilized to access such electronic resources determined to satisfy the search query. It should be appreciated that such pointer(s) and/or any other information that may be provided when an electronic resource is identified as a search result may be stored by the search system in and/or associated with the search index 512 to enable retrieval of such information in circumstances where the corresponding electronic resource is identified as a search result.

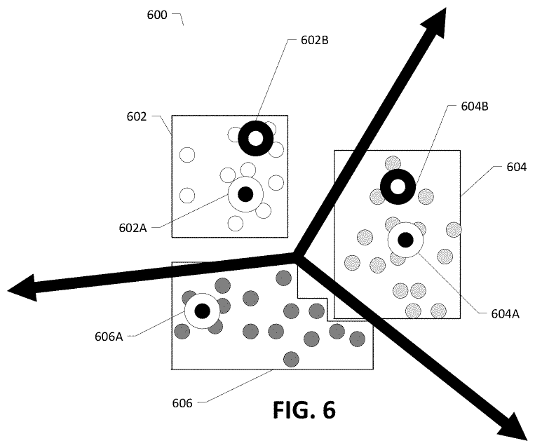

FIG. 6 illustrates an example context mapping space in accordance with at least some embodiments of the present disclosure. Specifically, FIG. 6 illustrates a three-dimensional visualization of a context mapping space 600. The context mapping space 600 includes a plurality of context data, each corresponding to a particular electronic resource of a plurality of electronic resources. For example, the plurality of context data may correspond to a plurality of previously-engaged personalized search results. In this regard, each context data in the context mapping space 600 may correspond to a particular previously-engaged search result with which a particular user accessed and/or otherwise engaged. Alternatively or additionally, in some embodiments, the context mapping space 600 includes a plurality of context data associated with any number of electronic resources and/or search results. In some such example embodiments, the context mapping space 600 includes context data for electronic resources corresponding to search results that may be selected as personalized search results for a particular user.

Each context data may represent a particular context associated with the data of the corresponding electronic resource (e.g., the content, a portion of the content, and/or metadata associated with the electronic resource). For example, the context data may be generated utilizing a specially trained model, such as a resource context model as described herein. In this regard, context data closer to one another may represent contexts (e.g., subject matter) more closely related than for context data further from one another. For example, a first context data proximate to a second context data may represent closely related contexts (e.g., two electronic resource about cooking different types of food), while a first context data distant from a second context data may represent unrelated contexts (e.g., a first electronic resource about cooking and a second electronic resource about water polo). It should be appreciated that the trained model that generates the context data for each electronic resource, for example the trained resource context model, may be specially configured to generate the context mapping space 600 and/or specific elements of the context mapping space 600, such as the dimensionality of the context mapping space 600, to enable effective mapping of the plurality of context data.

As illustrated, the context mapping space 600 includes multiple context clusters. Each context cluster represents a set of context data for electronic resources determined to be sufficiently related that such electronic resources may be grouped as associated with a shared context. For example, as illustrated, a first context cluster 602 includes a first plurality of context data associated with a first set of electronic resources (e.g., corresponding to a first set of search results and/or personalized search results), a second context cluster 604 includes a second plurality of context data associated with a second set of electronic resources (e.g., corresponding to a second set of search results and/or personalized search results), and a third context cluster 606 includes a third plurality of context data associated with a third set of electronic resources (e.g., corresponding to a third set of search results and/or personalized search results). In some embodiments, in generating the context clusters, new context data for a particular electronic resource may be generated and compared to a particular value to determine whether to add the new context data to an existing context cluster. For example, in some embodiments, the new context data is compared with context data representing a center of the context cluster (e.g., calculated and/or otherwise determined based on each context data already in the context cluster) to determine a context distance between the new context data and the center of the context cluster.

In circumstances where the context distance satisfies a clustering context distance threshold (e.g., is less than, or less than or equal to in some embodiments, the clustering context distance threshold) the new context data is added to the context cluster, representing the electronic resource is sufficiently related. In circumstances where the context distance does not satisfy a clustering context distance threshold (e.g., is greater than, or greater than or equal to in some embodiments, the clustering context distance threshold) the new context data is not added to the context cluster. The new context data may be tested for adding to one or more existing context clusters, and in circumstances where the new context data is not added to an existing context cluster, the new context data may begin a new context cluster. Additionally or alternatively, in some embodiments, the trained resource context model may generate such context clusters at one or more times, at predefined training time intervals, and/or the like. In some such embodiments, new context data may be assigned to context clusters in the manner described above between training sessions to account for context data for new selected personalized search results, for example, and/or other electronic resources to be considered in the context mapping space 600.

As illustrated, the context mapping space 600 includes multiple centers of interest and centers of disinterest. It should be appreciated that, in embodiments, any number of centers of interests may be determined and/or maintained—including zero or more centers of interest for a particular user profile. Similarly, any number of centers of disinterest may be determined and/or maintained—including zero or more centers of disinterest for a particular user profile.

A center of interest embodies context data representing a location in the context mapping space 600 that corresponds to a context a user profile is likely to be interested in. The center of disinterest may be determined based on user-specific interest data, including without limitation previously-selected search results, biographical information, previous search queries, and/or the like. In this regard, context data (e.g., for a first electronic resource) that is closer to a center of interest indicates a user profile is more likely to be interested in that context data as opposed to context data (e.g., for a second electronic resource) that is further from the center of interest. Thus, search results corresponding to context data that is closer to a center of interest may be determined to more likely be accessed by the user profile, which decreases as the context data is further from the center of interest. In this regard, each of the centers of interest 602A, 604A, and 606A may represent particular interests associated with a user profile based on various data associated with the user profile, for example generated by one or more trained user resource interest model(s) as described herein.

A center of interest similarly embodies context data representing a location in the context mapping space 600 that corresponds to a context a user profile is likely to not be interested in. The center of disinterest may be determined based on user-specific interest data, including without limitation previously-selected search results, biographical information, previous search queries, and/or the like. In this regard, context data (e.g., for a first electronic resource) that is closer to a center of disinterest indicates a user profile is less likely to be interested in that context data as opposed to context data (e.g., for a second electronic resource) that is further from the center of disinterest. Thus, search results corresponding to context data that is closer to a center of disinterest may be determined to be less likely to be accessed by the user profile, such that avoiding providing such search results as personalized search results is preferable because they are unlikely to be accessed. In this regard, each of the centers of disinterest 602B and 604B may represent particular contexts that a user profile is disinterested in based on various data associated with the user profile, for example as generated by one or more trained user resource interest model(s) as described herein. It should be appreciated that the center(s) of interest and/or center(s) of disinterest may be generated as described herein via interaction with various search result(s) and/or corresponding electronic resources via a preference training interface, as described herein.

In some embodiments, a center of interest and/or center of disinterest is associated with a centroid age that represents a temporal indication of how long the center of interest or center of disinterest has been in existence since creation and/or updating, and/or how many queries have been performed since creation and/or updating of the respective center of interest or disinterest. For example, in some embodiments, a centroid age associated with a center of interest and/or center of disinterest is generated a particular value upon creation of the center of interest or center of disinterest (e.g., the value zero or a maximum value). Subsequently, the centroid age may be updated upon each search query executed by the user or upon another action such as upon each interaction with a particular search result. For example, the centroid age may be incremented (or in other embodiments, decremented) for each search query executed by the user. In some such embodiments, the centroid age may be utilized to adjust a weight by which the center of interest or center of disinterest affects rankings of search results.

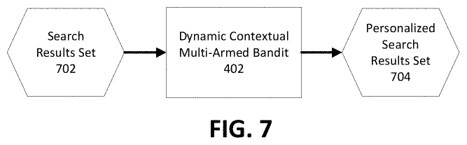

FIG. 7 illustrates an example search results personalization process in accordance with at least some example embodiments of the present disclosure. Specifically, FIG. 7 illustrates generation of a personalized search results set 704 from a search results set 702 utilizing a dynamic contextual multi-armed bandit 402. The search results set 702 may be generated or otherwise determined via a search system from a search query inputted by a user associated with a particular user profile and/or user device. As described herein, the search results set 702 may be received and processed on a user device specially configured to utilize the dynamic contextual multi-armed bandit 402.

The search results set 702 is generated without exposing the user-specific data to the search system. For example, a search query may be transmitted to the search system and processed utilizing a term matching or other non-personalized algorithm to identify the search results set 702 as satisfying the search query. In some other embodiments, the search system utilizes a reduced set of personalized data made available for processing (e.g., data that may be readily identifiable solely from the transmission of the search query from the user device, such as device IP address, location, search terms, and/or the like). Subsequently, the search system may transmit the search results set 702 back to the user device in response to the search query, such that the search results set 702 may be personalized. In this regard, it should be appreciated that the search results set 702 is generated while maintaining user privacy, but may not be the well-arranged for a particular user profile based on the interests of that user profile.

The search results set 702 is processed by the dynamic contextual multi-armed bandit 402 to generate the personalized search results set 704. In this regard, the dynamic contextual multi-armed bandit 402 may be trained based on user-specific interest data for a particular user profile, such that the personalized search results set 704 is arranged to first display search results likely to be accessed by the user. The personalized search results set 704 may be arranged such that the search results that are positioned first in the personalized search results set 704 match contexts that are likely to be of interest to the user profile based on the user-specific interest data associated with that profile. The dynamic contextual multi-armed bandit 402 and various sub-models associated therewith may be trained to determine such personalized search results from the search results set 702 iteratively to add the next best (e.g., most likely to be interesting) search result to the personalized search results set 704 for any number of search results, as described herein, or in other embodiments all at once to output the personalized search results set 704.

The dynamic contextual multi-armed bandit 402 may generate the personalized search results set 704 utilizing various sub-models. For example, the dynamic contextual multi-armed bandit 402 may receive the search results set 702 representing a non-personalized and/or unranked set of search results, and further receive and/or calculate computed context data associated with each search result and/or context distances to relevant center(s) of interest and/or center(s) of disinterest (e.g., utilizing a resource context model and/or user resource interest model) and ranking information from a learn to rank model (e.g., utilizing a user resource interest model and/or various other search models associated with various user preferences). The dynamic contextual multi-armed bandit 402 may generate weights for each of the relevant context distances and/or ranking information generated via the learn to rank model. Utilizing such weights, the dynamic contextual multi-armed bandit may generate the personalized search result set 704, for example by performing Thompson sampling or another preferred sampling mechanism.

### Example Processes for Privacy-Preserving Personalized Searching of the Disclosure

Having described example systems, apparatuses, and data interactions, example processes in accordance with the present disclosure will now be described. It should be appreciated that each of the processes may include one or more computing devices, such that each process serves as a data flow of a single computing device and/or between one or more interacting computing devices to facilitate the operations as depicted and described. Each of the processes depicts an example computer-implemented process that may be performed by one or more of the apparatuses, systems, and/or devices described herein, for example utilizing one or more of the circuitry components thereof. The operational blocks indicating operations of each process may be arranged in any of a number of ways, including but not limited to that as depicted and described herein. In some such embodiments, one or more operational blocks of any of the processes described herein occur in-between one or more operational blocks of another process, before one or more operational blocks of another process, and/or otherwise operates as a sub-process of a second process. Additionally or alternative, any of the processes may include some or all of the steps described and/or depicted, including one or more optional operational blocks in some embodiments. With regard to the flowcharts illustrated herein, one or more of the depicted operational blocks may be optional in some, or all, embodiments of the disclosure. Optional operational blocks are depicted with broken (or “dashed”) lines. Similarly, it should be appreciated that one or more of the operational blocks of each flowchart may be combinable, replaceable, and/or otherwise altered as described herein.

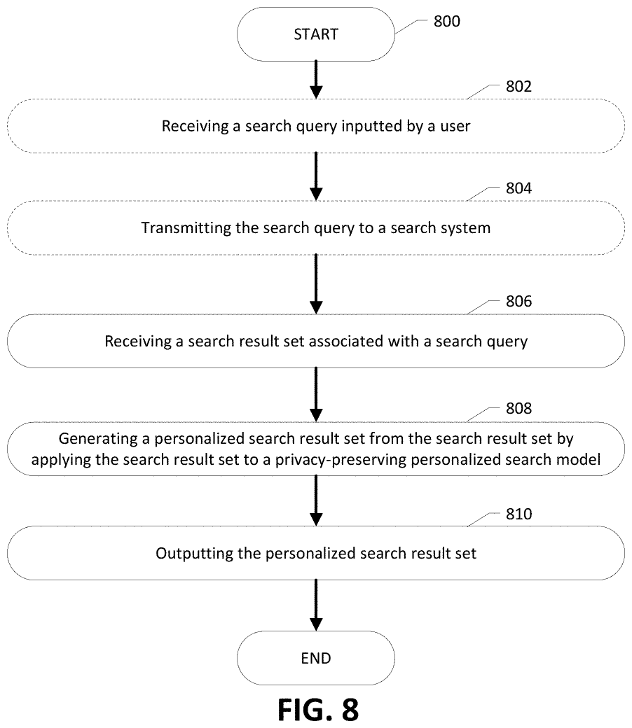

FIG. 8 illustrates a flowchart including example operations of an example process 800 for privacy-preserving personalized searching in accordance with at least some example embodiments of the present disclosure. The operations are depicted and described as performed by a privacy-preserving user apparatus 300, for example embodying the user device 102 specially configured to enable performance of privacy-preserving personalized searching. It should be appreciated that, for one or more of the described operations as depicted and described with respect to FIG. 8, the privacy-preserving user apparatus 300 may interact with one or more other computing devices, apparatuses, and/or the like, such as a search system and/or a privacy-preserving federated learning system.

The example process 800 may be embodied and/or implemented in any of a myriad of manners. For example, in some such embodiments, the process 800 embodies a computer-implemented method that may be executed by any of a myriad of computing devices, apparatuses, systems, and/or the like, as described herein. In some embodiments, the process 800 is embodied by computer program code stored on a non-transitory computer-readable medium of a computer program product configured for, upon execution, performing the computer-implemented process described. Alternatively or additionally, in some embodiments, the process 800 is performed by one or more specially configured computing devices, such as the privacy-preserving user apparatus 300 alone and/or in communication with one or more external computing devices and/or components. In this regard, in some such embodiments, the privacy-preserving user apparatus 300 is specially configured by computer program instructions stored thereon, for example in the memory 304 and/or another set of circuitry depicted and/or described herein, and/or otherwise accessible to the privacy-preserving user apparatus 300, for performing the operations as depicted and described.

The process 800 begins at optional operation 802. At optional operation 802, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to receive a search query inputted by a user. For example, in some embodiments, the privacy-preserving user apparatus 300 outputs and/or otherwise causes rendering of one or more search query interface that enables a user to input data embodying the search query, and/or submit the search query for processing, via user input data. The search query may include any of a myriad of data types. For example, in some embodiments, the search query comprise text data. In some embodiments, additionally or alternatively, the search query comprises image data.

At optional operation 804, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to transmit the search query to a search system. The search query may be transmitted to the search system to cause the search system to process the search query and provide a search results set including search result(s) that satisfy the search query. In some embodiments, the search query is transmitted as part of one or more requests specially configured to embody a request to process the search query. It should be appreciated that, to improve maintain privacy associated with processing the search query, minimal user-specific data (or in some embodiments, no user-specific data) is transmitted to the search system together with the search query, and/or the search system may not store any information associated with the search query and/or device transmitting the search query.

At operation 806, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to receive a search result set associated with a search query. The search result set may be received from the search system in response to transmission and/or other submission of the search query to the search system for processing. The search result set is received not personalized, or not significantly personalized, such that the order of the search results in the search result set is not sufficiently ordered based on likely user interest of the corresponding search result. In this regard, the search result set may be identified by the search system based on a non-personalized search algorithm, for example by matching search terms to a search index maintained by the search system. The search result set received from the search system for a particular search query may be further processed to generate a personalized search result set representing the search result set personalized into an arrangement in a manner such that search results likely to be of interest (e.g., likely to be accessed by the user profile based on the search request) are ordered first in the arrangement. In some embodiments, for example, the search result set is received from the search system in response to the search query inputted by the user at operation 802 and transmitted at operation 804.

At operation 808, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to generate a personalized search result set from the search result set. The personalized search result set is generated by applying the search result set to a privacy-preserving personalized search model. The privacy-preserving personalized search model may be trained in a privacy-preserving manner, and/or may include or otherwise utilize one or more sub-models trained in a privacy-preserving manner. For example, in some embodiments, the privacy-preserving personalized search model and/or the sub-models associated therewith is/are trained and updated locally via the privacy-preserving user apparatus 300. In some embodiments, the privacy-preserving personalized search model and/or one or more of the sub-models associated therewith is/are trained and/or updated via communication with a privacy-preserving federated learning system. In this regard, the privacy-preserving personalized search model may be configured, based on the various trained sub-models, to generate the personalized search result set based on the particular user's interests, for example embodied by various user-specific interest data collected and/or otherwise available for a particular user profile. For example, by training the privacy-preserving personalized search model and/or one or more of such sub-models of the privacy-preserving personalized search model in a privacy-preserving manner via communication with a privacy-preserving federated learning system, the trained models may be trained to sufficiently personalize search results for a particular user profile without exposing the training data (e.g., user-specific interest data) to third-party entities and/or systems in an interpretable format. The resulting personalized search result set is generated such that the search results most likely to be accessed by a user (e.g., the search results most likely to be of interest to a particular user profile) are arranged first in the personalized search result set. The resulting personalized search result set may embody an ordered arrangement of one or more of the search results from the search result set specific to a particular user profile.

In some embodiments, the personalized search result set is generated in an iterative manner. For example, the privacy-preserving user apparatus 300 may be configured to utilize the privacy preserving search model to identify a highest ranked search result from the search result set, where the highest ranked search result represents a search result most likely to be accessed from the search result set or a particular subset of the search result set (e.g., from a particular context cluster embodying a subset of the search result set). The highest ranked search result may be added to the personalized search result set in the first available position (e.g., starting with the first available position in a list of personalized search results), and removed from the search results set. Subsequently, the next highest ranked search result set from the search result set with the remaining search results may be identified, and added to the personalized search result set. This sub-process may be repeated until the personalized search result set includes a desired number of search results.

At operation 810, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to output the personalized search result set. In some embodiments, the personalized search result set is output for rendering to a personalized search result interface. The personalized search result interface may include user interface elements associated with accessing each of the personalized search results in the personalized search result set. In this regard, the personalized search result interface may arrange such interface elements in the same order represented by the personalized search result set, such that the user is first presented with the first personalized search result from the personalized search result set, then the second personalized search result, and so on. Alternatively or additionally, in some embodiments, the personalized search result set is output for further processing and/or manipulation by the privacy-preserving user apparatus 300 or an associated computing device (e.g., for storage and/or analysis).

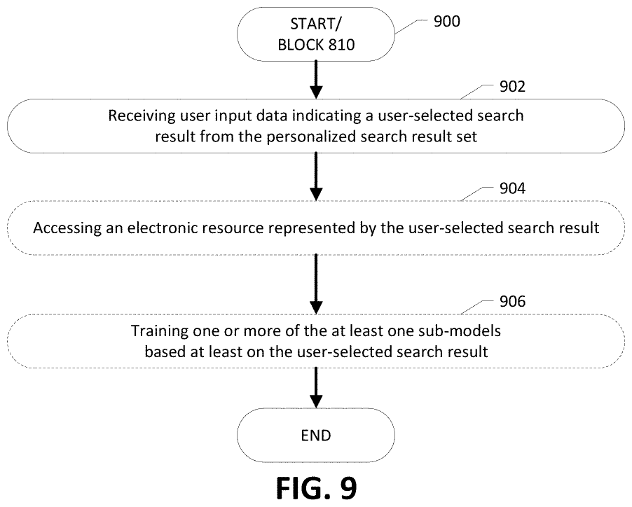

FIG. 9 illustrates a flowchart depicting example additional operations of an example process for utilizing a user-selected search result, for example as part of a process for privacy-preserving personalized searching, in accordance with at least some example embodiments of the present disclosure. The operations are depicted and described as performed by a privacy-preserving user apparatus 300, for example embodying the user device 102 specially configured to enable performance of privacy-preserving personalized searching. It should be appreciated that, for one or more of the described operations as depicted and described with respect to FIG. 9, the privacy-preserving user apparatus 300 may interact with one or more other computing devices, apparatuses, and/or the like, such as a search system and/or a privacy-preserving federated learning system.

The example process 900 may be embodied and/or implemented in any of a myriad of manners. For example, in some such embodiments, the process 900 embodies a computer-implemented method that may be executed by any of a myriad of computing devices, apparatuses, systems, and/or the like, as described herein. In some embodiments, the process 900 is embodied by computer program code stored on a non-transitory computer-readable medium of a computer program product configured for, upon execution, performing the computer-implemented process described. Alternatively or additionally, in some embodiments, the process 900 is performed by one or more specially configured computing devices, such as the privacy-preserving user apparatus 300 alone and/or in communication with one or more external devices. In this regard, in some such embodiments, the privacy-preserving user apparatus 300 is specially configured by computer program instructions stored thereon, for example in the memory 304 and/or another set of circuitry depicted and/or described herein, and/or otherwise accessible to the privacy-preserving user apparatus 300, for performing the operations depicted and described.

The process 900 begins at operation 902. In some embodiments, the process 900 begins after one or more operational blocks of another process, for example after operation 810 as depicted and described with respect to the process 800. Additionally or alternatively, in some embodiments, flow continues to an operation of another process upon completion of the process 900. Alternatively or additionally still, in some other embodiments, the flow ends upon completion of the process 900.

At operation 902, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to receive user input data indicating a user-selected search result from the personalized search result set. In some embodiments, the user interacts with a personalized search result interface to select a particular personalized search result from the personalized search result set for accessing by interacting with a user interface element corresponding to the personalized search result. For example, the user may tap, click on, or otherwise engage the user interface element corresponding to the personalized search result most of interest to the user for the particular search query submitted by the user. It should be appreciated that the user may select any personalized search result from the personalized search results set, and the user-selected search result need not necessarily be the first personalized search result in the set.

At optional operation 904, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to access an electronic resource associated with the user-selected search result. For example, in some embodiments, each search result corresponds to a particular pointer to an electronic resource associated with the search result. The pointer may embody a URL, URI, IP address, or other data that enables location and/or retrieval of the electronic resource associated with the user-selected search result from one or more computing device(s) of a network accessible to the privacy-preserving user apparatus 300. In this regard, the accessed electronic resource is downloaded to and/or rendered via the privacy-preserving user apparatus 300 for processing and/or viewing by the user.

At optional operation 906, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to train the privacy-preserving search model and/or one or more of the at least one sub-model based at least on the user-selected search result. In some embodiments, for example, the privacy-preserving search model and/or one or more of the sub-model(s) is trained locally to the privacy-preserving user apparatus 300. Additionally or alternatively, in some embodiments, the privacy-preserving search model and/or one or more of the sub-model(s) is/are trained via communication with a privacy-preserving federated learning system, for example to update the model(s) based on trends and/or data relationships learned by multiple implementations of such model(s). maintained by separate user devices.

In some embodiments, the privacy-preserving user apparatus 200 stores the user-selected search result as a previously-selected search result. Subsequent training of the privacy-preserving personalized search model, and/or one or more sub-models of the privacy-preserving personalized search model, may utilize the previously-selected search results as training data. In this regard, as the user selects search results from the personalized search results set, such search results are utilized to improve the accuracy of the privacy-preserving personalized search model in determining how likely a search result is to be accessed associated with a particular user profile. Alternatively or additionally, the user-selected search result may be utilized to recalculate and/or otherwise update one or more centers of interest and/or disinterest to account for the user-selected search result. Such updated training of the sub-models and/or centers of interest and/or disinterest enable the privacy-preserving personalized search model to improve in accuracy of predicting which search results are likely to be accessed associated with a particular user profile. It should be appreciated that such updated training may occur at predetermined time intervals, upon user engagement of a predetermined number of search results, and/or upon each user engagement of a search result.

It should be appreciated that, in some circumstances, the privacy-preserving search model further is updated from the user-selected search result. In this regard, the privacy-preserving search model may learn to improve its accuracy with respect to predicting whether a particular search result will be interacted with by a particular user. For example, in some embodiments where the privacy-preserving search model comprises a particular dynamic contextual multi-armed bandit, the dynamic contextual multi-armed bandit may be updated based on a selection to improve the likelihood of selecting similar search results for presenting to the user.

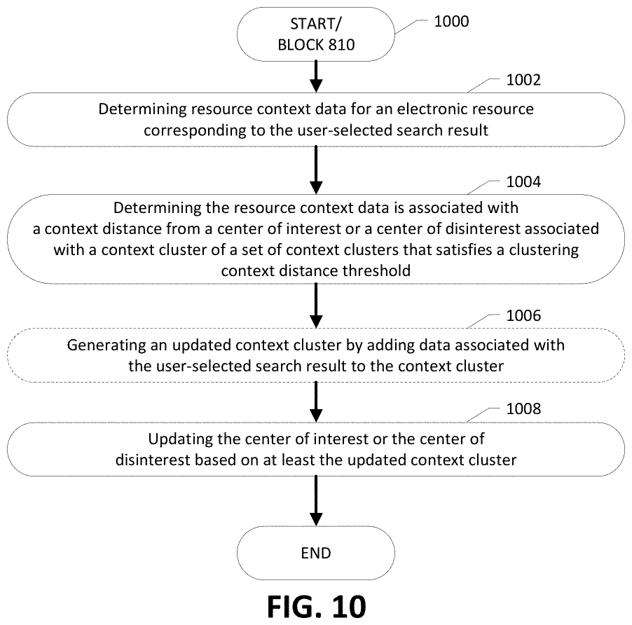

FIG. 10 illustrates a flowchart depicting example additional operations of an example process for utilizing updated context clusters, for example as part of a process for privacy-preserving personalized searching, in accordance with at least some example embodiments of the present disclosure. The operations are depicted and described as performed by a privacy-preserving user apparatus 300, for example embodying the user device 102 specially configured to enable performance of privacy-preserving personalized searching. It should be appreciated that, for one or more of the described operations as depicted and described with respect to FIG. 10, the privacy-preserving user apparatus 300 may interact with one or more other computing devices, apparatuses, and/or the like, such as a search system and/or a privacy-preserving federated learning system.

The example process 1000 may be embodied and/or implemented in any of a myriad of manners. For example, in some such embodiments, the process 1000 embodies a computer-implemented method that may be executed by any of a myriad of computing devices, apparatuses, systems, and/or the like, as described herein. In some embodiments, the process 1000 is embodied by computer program code stored on a non-transitory computer-readable medium of a computer program product configured for, upon execution, performing the computer-implemented process described. Alternatively or additionally, in some embodiments, the process 1000 is performed by one or more specially configured computing devices, such as the privacy-preserving user apparatus 300 alone and/or in communication with one or more external devices. In this regard, in some such embodiments, the privacy-preserving user apparatus 300 is specially configured by computer program instructions stored thereon, for example in the memory 304 and/or another set of circuitry depicted and/or described herein, and/or otherwise accessible to the privacy-preserving user apparatus 300, for performing the operations depicted and described.

The process 1000 begins at operation 1002. In some embodiments, the process 1000 begins after one or more operational blocks of another process, for example after operation 810 as depicted and described with respect to the process 800. Additionally or alternatively, in some embodiments, flow continues to an operation of another process upon completion of the process 1000. Alternatively or additionally still, in some other embodiments, the flow ends upon completion of the process 1000.

At operation 1002, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to determine resource context data for an electronic resource corresponding to the user-selected search result. The resource context data represents the context of the electronic resource with respect to a particular context mapping space that defines various contexts. For example, the resource context data may represent the subject matter of the electronic resource, as determined from one or more portions of the electronic resource (e.g., the content, specific portions of the content, the title, the abstract, and/or the like). In some embodiments, the resource context data is determined utilizing a trained resource context model. The trained resource context model may process the electronic resource to determine the context of the electronic resource, for example utilizing natural language processing to extract and process the text data embodying the electronic resource. A non-limiting example of a trained resource context model is a BERT implementation of a limited size capable of running on a mobile device, for example using a limited language set with English (or another particular language) only.

At operation 1004, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to determine the resource context data is associated with a context distance from a center of interest or a center of disinterest associated with a context cluster of a set of context clusters, where the context distance satisfies a clustering context distance threshold. In some embodiments, the privacy-preserving user apparatus 300 identifies the center of interest or center of disinterest near the resource context data using any of a myriad of pre-processing algorithms. For the identified center of interest or center of disinterest, the context distance is determined utilizing a distance algorithm between (1) the resource context data and (2) the center of interest or center of disinterest. The privacy-preserving user apparatus 300 may compare the resource context data with the clustering context distance threshold. The clustering context distance threshold is satisfied in a circumstance where the determined context distance is less than, or in other implementations less than or equal to, clustering context distance threshold. In some such embodiments, in a circumstance where a clustering context distance threshold is not met with respect to a particular context cluster, the privacy-preserving user apparatus 300 continues to compare the context distance with respect to each context cluster of a particular set of context clusters.

At optional operation 1006, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to generate an updated context cluster by adding data associated with the user-selected search result to the context cluster. In this regard, the updated context cluster associated with the center of interest or center of disinterest may be updated to include the resource context data for the new user-selected search result. In some embodiments, context data associated with the user-selected search result is added to the context cluster. In this regard, one or more context clusters may be generated and/or updated to reflect each user-selected search result as a previously-selected search result. In this regard, the updated context cluster may represent the interests of the user profile local to the user device.

At operation 1008, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to update the center of interest or the center of disinterest based on at least the updated context cluster. In this regard, the center of interest or center of disinterest to which the updated context cluster is associated may be updated based on a centroid update model, algorithm, and/or the like. For example, in some embodiments, an updated value for the center of interest associated with the updated context cluster is generated based on each search result corresponding to context data represented in the updated context cluster. Additionally or alternatively, in some embodiments an updated value for the center of disinterest associated with the updated context cluster is generated based on each search result corresponding to context data represented in the updated context cluster. In some embodiments, a differential value is calculated based on the context data for the user-selected search result, which is utilized to offset a current center of interest or a current center of disinterest, thus updating the center of interest or center of disinterest to account for the user-selected search result newly added to the context cluster. A non-limiting example of a centroid update algorithm is represented by the equation:

x=(1−t)x+t*p EQUATION 1:

In this equation, x denotes a value of a center of interest or a center of disinterest in a particular embedding space. Additionally, p represents the value of the contextual data for the new user-selected search result. Additionally, t represents a determinable weighting factor that affects the value of the shift towards the new user-selected search result. In this regard, t may be set to a particular data value such that older user-selected search results are “forgotten about” over time as new user-selected search results are received. For example, in some embodiments, t may be set to 0.1 to shift the center of interest or center of disinterest 0.1 towards the user-selected search result.

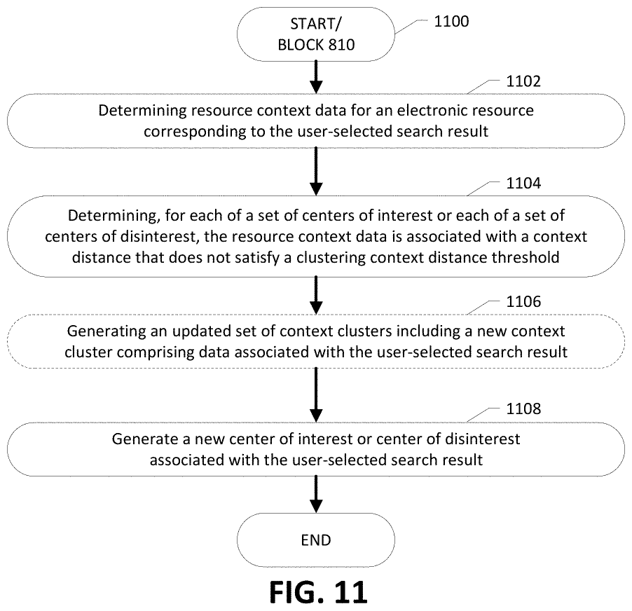

FIG. 11 illustrates a flowchart depicting example additional operations of an example process for utilizing updated context clusters, for example as part of a process for privacy-preserving personalized searching, in accordance with at least some example embodiments of the present disclosure. The operations are depicted and described as performed by a privacy-preserving user apparatus 300, for example embodying the user device 102 specially configured to enable performance of privacy-preserving personalized searching. It should be appreciated that, for one or more of the described operations as depicted and described with respect to FIG. 11, the privacy-preserving user apparatus 300 may interact with one or more other computing devices, apparatuses, and/or the like, such as a search system and/or a privacy-preserving federated learning system.

The example process 1100 may be embodied and/or implemented in any of a myriad of manners. For example, in some such embodiments, the process 1100 embodies a computer-implemented method that may be executed by any of a myriad of computing devices, apparatuses, systems, and/or the like, as described herein. In some embodiments, the process 1100 is embodied by computer program code stored on a non-transitory computer-readable medium of a computer program product configured for, upon execution, performing the computer-implemented process described. Alternatively or additionally, in some embodiments, the process 1100 is performed by one or more specially configured computing devices, such as the privacy-preserving user apparatus 300 alone and/or in communication with one or more external devices. In this regard, in some such embodiments, the privacy-preserving user apparatus 300 is specially configured by computer program instructions stored thereon, for example in the memory 304 and/or another set of circuitry depicted and/or described herein, and/or otherwise accessible to the privacy-preserving user apparatus 300, for performing the operations depicted and described.

The process 1100 begins at operation 1102. In some embodiments, the process 1100 begins after one or more operational blocks of another process, for example after operation 810 as depicted and described with respect to the process 800. Additionally or alternatively, in some embodiments, flow continues to an operation of another process upon completion of the process 1100. Alternatively or additionally still, in some other embodiments, the flow ends upon completion of the process 1100.

At operation 1102, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to determine resource context data for an electronic resource corresponding to the user-selected search result. In some embodiments, the resource context data is determined utilizing a trained resource context model as described herein. In this regard, for example, the privacy-preserving user apparatus 300 may determine the resource context data in the manner described herein with respect to operation 1102.

At operation 1104, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to determine, for each of a set of centers of interest or a set of centers of disinterest, the resource context data is associated with a context distance that does not satisfy a clustering context distance threshold. For example, in some embodiments, the privacy-preserving user apparatus 300 utilizes one or more distance algorithms to generate the context distance iteratively for each center of interest and/or center of disinterest. Upon generation of each context distance, the privacy-preserving user apparatus 300 compares the context distance with the clustering context distance threshold to determine the context distance does not satisfy the clustering context distance threshold. Upon determining the context distance does not satisfy the clustering context distance threshold, the privacy-preserving user apparatus 300 proceeds with processing the context distance with respect to the next center of interest or center of disinterest, until no unprocessed center of interest remains in the set (or until no unprocessed center of disinterest remains in the set).

At optional operation 1106, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to generate an updated set of context clusters including a new context cluster comprising data associated with the user-selected search result. For example, a new data object embodying the new context cluster may be generated by the privacy-preserving user apparatus 300, and subsequently included in the set of context clusters. In this regard, context data associated with another electronic resource, search result, user-selected search result, and/or the like, may be added to the new context cluster upon subsequent processing of electronic resources associated with similar context(s). In this regard, such context data may be processed, for example in a circumstance where the user selects a particular search result, and added to the new context cluster in a circumstance where the context distance associated with the new context cluster satisfies a clustering context distance threshold. The new context cluster may be associated with a newly generated center of interest or center of disinterest, for example based on the distance to an existing center of interest or center of disinterest.

At operation 1108, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to generate a new center of interest or a new center of disinterest associated with the user-selected search result. In this regard, the new center of interest or center of disinterest may be generated at a position within the context embedding space that corresponds to the resource context data for the user-selected search result. The new center of interest may be associated with a particular context cluster to which resource context data may be associated, for example for future user-selected search results. In this regard, in circumstances where resource context data associated with other user-selected search result(s) is/are received, it may be associated with said context cluster and utilized to update the corresponding center of interest and/or center of disinterest.

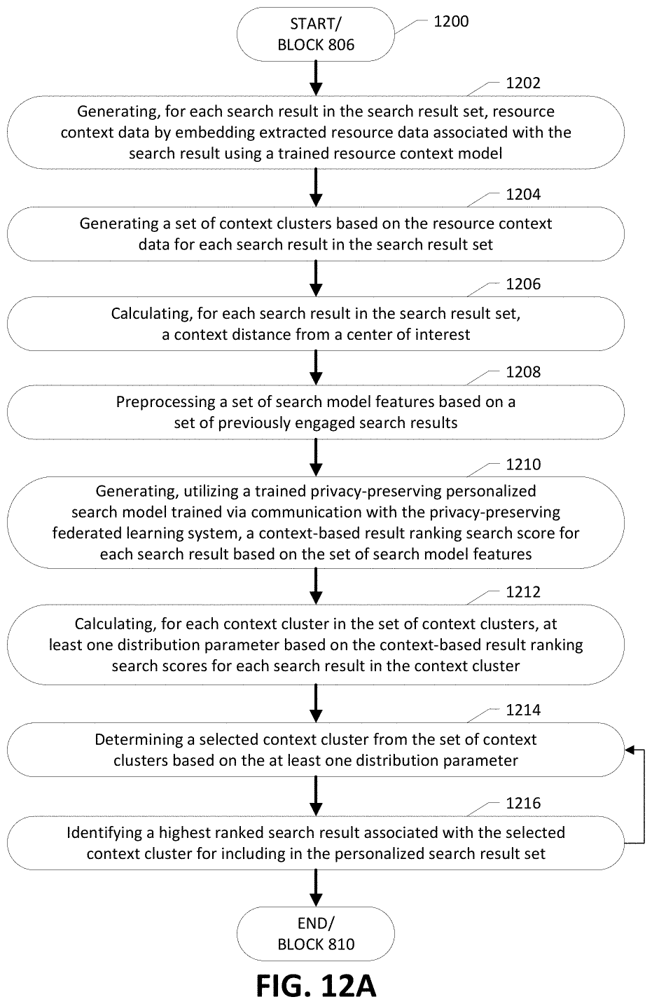

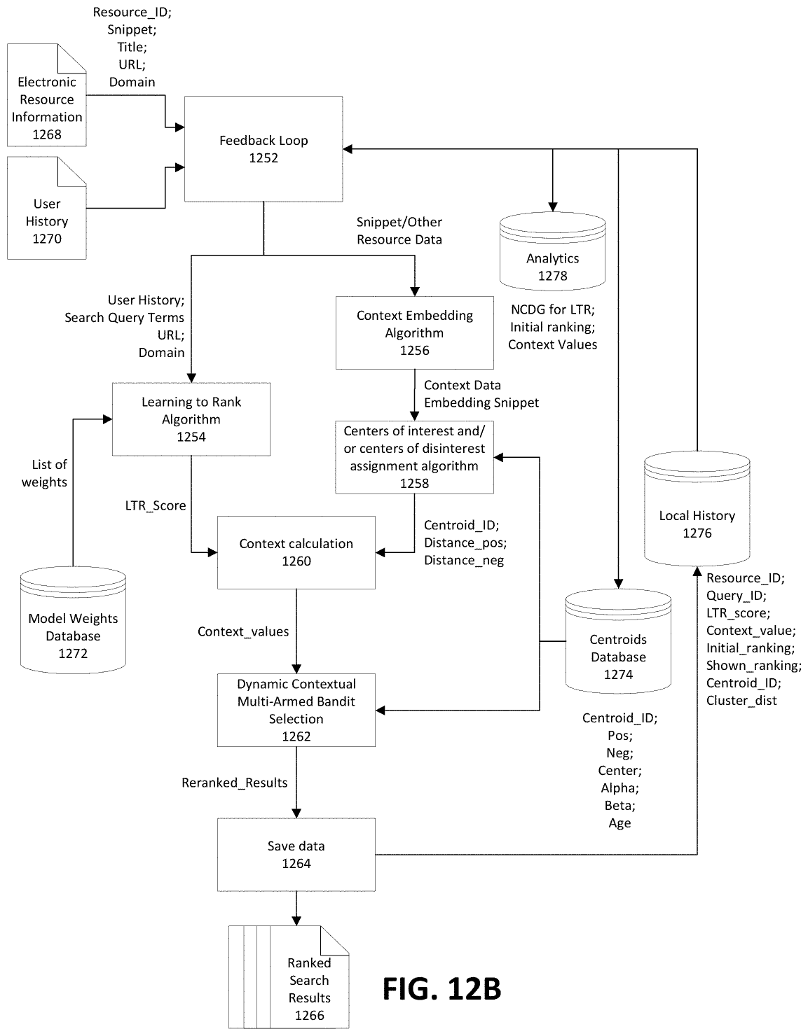

FIG. 12A illustrates a flowchart depicting example operations of an example process for generating a personalized search result set, in accordance with at least some example embodiments of the present disclosure. The operations are depicted and described as performed by a privacy-preserving user apparatus 300, for example embodying the user device 102 specially configured to enable performance of privacy-preserving personalized searching. It should be appreciated that, for one or more of the described operations as depicted and described with respect to FIG. 12A, the privacy-preserving user apparatus 300 may interact with one or more other computing devices, apparatuses, and/or the like, such as a search system and/or a privacy-preserving federated learning system.

The example process 1200 may be embodied and/or implemented in any of a myriad of manners. For example, in some such embodiments, the process 1200 embodies a computer-implemented method that may be executed by any of a myriad of computing devices, apparatuses, systems, and/or the like, as described herein. In some embodiments, the process 1200 is embodied by computer program code stored on a non-transitory computer-readable medium of a computer program product configured for, upon execution, performing the computer-implemented process described. Alternatively or additionally, in some embodiments, the process 1200 is performed by one or more specially configured computing devices, such as the privacy-preserving user apparatus 300 alone and/or in communication with one or more external devices. In this regard, in some such embodiments, the privacy-preserving user apparatus 300 is specially configured by computer program instructions stored thereon, for example in the memory 304 and/or another set of circuitry depicted and/or described herein, and/or otherwise accessible to the privacy-preserving user apparatus 300, for performing the operations depicted and described.

The process 1200 begins at operation 1202. In some embodiments, the process 1200 begins after one or more operational blocks of another process, for example after operation 806 as depicted and described with respect to the process 800. Additionally or alternatively, in some embodiments, flow continues to an operation of another process upon completion of the process 1200, for example operation 810 as depicted and described with respect to the process 800. Alternatively or additionally still, in some other embodiments, the flow ends upon completion of the process 1200.

At operation 1202, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to generate, for each search result in the search result set, resource context data by embedding extracted resource data associated with the search result. In some embodiments, the resource context data for each search result is generated utilizing a trained resource context data. For example, in some embodiments, the content of the electronic resource may be inputted to and processed by a modified mobile BERT implementation that embeds the data (e.g., text data of the content) as context data embodying the particular context of the electronic resource.

At operation 1204, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to generate a set of context clusters based on the resource context data for each search result in the search result set. For example, in some embodiments, the privacy-preserving user apparatus 300 performs a clustering algorithm that groups resource context data within a particular context distance from one another in a single context cluster. In some such embodiments, the privacy-preserving user apparatus 300 utilizes one or more trained clustering model(s) that are trained to cluster resource context data associated with each search result to generate the set of context clusters.

At operation 1206, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to calculate, for each search result in the search result set, a context distance from a center of interest. In some embodiments, for example, the context distance is determined utilizing one or more distance algorithms based on the center of interest and resource context data corresponding to the search result. In this regard, each search result may be associated with context distance that represents the distance of the context associated with the search result to the center of interest. Such context distances for each search result may represent how close a particular search result is to the determined interests for a particular user profile, and similarly how likely a user is to access the search result for a particular search query.

At operation 1208, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to preprocess a set of search model features based on a set of previously engaged search results. For example, in some embodiments, the privacy-preserving user apparatus 300 maintains the set of previously engaged search results representing each search result accessed by the user profile for previous search queries. The set of search model features represents features determined from the set of previously engaged search results as representative for determining whether a search result is likely to be selected by a particular user profile. For example, in some embodiments, the set of search model features are utilized by one or more models and/or algorithms, such as a privacy-preserving personalized search model, to generate an output score and/or output a selected search result for providing as a personalized search result as described herein.

The set of search model features may include any number of features associated with ranking and/or determining similarity of search results within a particular context. Non-limiting examples of such model features may be based on similarity between query term(s), a number of times a search query resulted in a search result corresponding to a particular electronic resource, a number of times a search result was shown, engaged, skipped and/or the like. It should be appreciated that the value for each search model feature may be determined utilizing a particular algorithm associated with the search model feature based on at least the previously engaged search results for a particular user account associated with the user.

At operation 1210, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to generate a context-based result ranking search score for each search result based on the set of search model features. In some embodiments, the context-based result ranking search score is generated utilizing a trained privacy-preserving personalized search model trained via communication with a privacy-preserving federated learning system. For example, in some embodiments, the trained privacy-preserving personalized search model embodies a learn to rank model trained based on the set of search model features via communication with a privacy-preserving federated learning system. In this regard, the trained privacy-preserving personalized search model may be trained to generate the context-based result ranking search score based on the user-specific data associated with each user profile and/or each user device without exposing such data in an interpretable format to any external or third-party systems and/or entities. Based on such training, the privacy-preserving personalized search model generates each context-based result ranking search score that represents the likelihood a search result from the search result set will be accessed associated with a particular user profile. In this regard, the privacy-preserving user apparatus 300 generates a set of context-based result ranking search scores that corresponds to search results in the set of search results. Additionally or alternatively, in some embodiments, the privacy-preserving user apparatus 300 normalizes each score generated by the trained privacy-preserving personalized search model to generate the set of context-based result ranking search scores as a set of normalized scores for further processing.

In this regard, the learning to rank algorithm(s) generate particular rankings for search results based on particular properties associated with the search results, such as based on domain preference of the particular user. The learning to rank algorithm(s) may be trained to generate such rankings based on various user-specific information, for example based on a set of historical search queries, and previously-selected search results associated with such search queries and/or indications of interest or disinterest in particular search results. The privacy-preserving personalized search model takes into account all such learning to rank data together with centers of interest and/or centers of disinterest to determine what to value in various contexts while further enabling exploration of interests within the embedding space. For example, in circumstances where the privacy-preserving personalized search model embodies a dynamic contextual multi-armed bandit, the dynamic contextual multi-armed bandit may learn whether the user is more likely to interact with search results ranked based on domain preference data or interest preference data, for example. Additionally or alternatively, the dynamic contextual multi-armed bandit may be configured to determine which context a particular user is most interested in, or which interest of a user's many interest the user likes the most. In some embodiments, the dynamic contextual multi-armed bandit is configured to identify which search results are likely to be preferred (and thus should be provided as personalized search results) based on particular datetime data, location data associated with the user device, and/or any other available data that may affect a user's preference for particular search results.

In some embodiments, one or more of such operations are performable, in whole or in part, in parallel. For example, in some embodiments, the operations 1202, 1204, and 1206 are performed in parallel with operations 1208 and 1210. It should be appreciated that, in other embodiments, the flow may proceed to operation 1212 upon completion of each of the sub-processes, whether performed in series or in parallel.

At operation 1212, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to calculate, for each context cluster in the set of context clusters, at least one distribution parameter based on the context-based result ranking search scores for each search result in the context cluster. In some embodiments, the at least one distribution parameters embodies a probabilistic distribution for selecting each context cluster from a distribution of the set of context clusters. In this regard, the distribution parameter(s) may define how likely a particular context cluster is to be selected from the set of context clusters.

In some embodiments, for example, at least one distribution parameter comprises at least a learning to rank factor, a positive context distance factor, and a negative context distance factor. The learning to rank factor may embody a value determined utilizing a first factor algorithm that applies a weight to a score generated by a learning to rank model. For example, in circumstances where three distribution parameters are generated, the learning to rank factor may be generated based on the equation:

LTR_Factor=(⅓)*score_from_LTR EQUATION 2:

In some embodiments, the positive context distance factor represents a factor that positively affects the ranking of the search result based on the context distance between the contextual data for the search result and the associated center of interest. In this regard, a second factor algorithm may be utilized to determine a value for the positive context distance factor that increases as the context data for the search result is closer to the center of interest. The value may similarly be weighted based on the factors of the distribution parameters. For example, the positive context distance factor may be generated based on the equation:

Positive_Distance_Factor=(⅓)*t_i*(1/(1+d_i/avg(d_j)) EQUATION 3:

In this equation, d_i represents the context distance from the center of interest to the context data associated with the search result. d_j represents the average context distance over all search results in a search result set associated with the search query. t_i represents the a centroid age factor associated with the center of interest, which may be determined from the centroid age based on the equation:

Age_Factor=exp(−(centroid age/decay factor)\hat{ }2) EQUATION 4:

In this regard, the centroid age is identifiable based on the datetime at which the center of interest was created and/or last updated. The decay factor represents a hyper-parameter that represents the speed at which the influence of the center of interest should decay. In this regard, based on equations 3 and 4, it should be appreciated that the value of the positive distance factor may equal ⅓ (or another weight based on the distribution parameters) in a circumstance where the context data for the search result is located exactly at the center of interest, equal ⅙ in a circumstance where the context data is the average context distance from the center of interest, and trends towards zero as the distance from the center of interest increases.

In some embodiments, the negative context distance factor represents a factor that negatively affects the ranking of the search result based on the context distance between the contextual data for the search result and the associated center of disinterest. In this regard, a third factor algorithm may be utilized to determine a value for the negative context distance factor that increases as the context data for the search result is further from the center of disinterest. The value may similarly be weighted based on the factors of the distribution parameters. For example, the negative context distance factor may be generated based on the equation:

Negative_Distance_Factor=(⅓)*t_i*1/(1+max(n j)−n_i) EQUATION 5:

In this equation, the similarly named sub-factors with respect to equation 3 represent the same values as described with respect to equation 3. n_i represents the context distance of the center of disinterest to the context data associated with the search result. max(d_j) represents the maximum context distance for all search results in the search result set associated with the search query. In this regard, based on equation 5, the value of the negative distance factor may be a maximum value (e.g., 3/1) in a circumstance where the context data is located at the maximum distance max(d_j) from the center of disinterest, and equal to 0 in a circumstance where the context data is located at the center of disinterest.

In this regard, it should be appreciated that the various values for the factors may be utilized to generate a final, normalized score for each search result. For example, the sum of the individual factors may provide an overall ranking score for the search result in a normalized range (e.g., 0 to 1 inclusive). Such ranking scores may subsequently be utilized to perform the ranking of the various search results, as described herein.

At operation 1214, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to determine a selected context cluster from the set of context clusters based on the at least one distribution parameter. In some embodiments, the at least one distribution parameters embodies a probabilistic distribution for selecting from the distribution of the set of context clusters. In some embodiments, the at least one distribution parameter defines a dynamic contextual multi-armed bandit that selects a context cluster from the set of context clusters for providing a search result as a personalized search result. In this regard, the selected context cluster may be determined based on the distribution defined by the at least one distribution parameter, for example the context cluster indicated by the at least one distribution parameter as most likely to include search results selected by the user profile, an exploration deviation, and/or another selection algorithm (e.g., to draw from the distribution defined by the at least one distribution parameter).

At operation 1216, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to identify a highest ranked search result associated with the selected context cluster for including in the personalized search result set. For example, in this regard, each context cluster may be associated with any number of search results, each associated with a context-based result ranking search score as described herein. The highest ranked search result for a particular context cluster may embody the search result associated with context data in the selected context cluster and corresponds to the highest context-based result ranking search score of each search result in the context cluster. In this regard, the highest-ranked search result corresponds to the search result in the context cluster that is most likely to be accessed and/or otherwise selected associated with a particular user profile (for example, selected by the user of the privacy-preserving user apparatus 300). In this regard, the personalized search result set may represent an ordered list of search results added for outputting associated with a particular search query. The highest ranked search result may subsequently be removed from the search result set to prevent including duplicates of the same search result. In this regard, the privacy-preserving search model (for example, embodied by a dynamic contextual multi-armed bandit) may pull from a cluster with a particular ranking and selects a highest-ranked search result. In some circumstances, the dynamic contextual multi-armed bandit is configured based on an exploration deviation, where the exploration deviation defines a percentage chance for an alternative context cluster (e.g., not the highest ranked cluster) to be selected from. Upon selection of the second highest ranked context cluster, the dynamic contextual multi-armed bandit may subsequently reselect from the highest ranked context cluster until the next determination to pull from an alternative context cluster.

The sub-process for selecting a search result for including in the personalized search result set, for example embodied by at least operations 1214 and 1216, may be repeated for any number of desired search results. For example, in some embodiments, the sub-process is repeated until the personalized search result set includes a desired determinable number of search results (e.g., 10 search results). Additionally or alternatively, in some embodiments, highest ranked search results are selected and included in the personalized search result set until another determination is satisfied (e.g., a most likely context cluster is empty, any context cluster is empty, and/or the like, a number of determined exploration selections have been made, and/or the like). In this regard, the personalized search result set may be generated to include any of a number of desired search results in an order such that the most likely search results are provided first in the personalized search result set (e.g., for displaying first to the user of the privacy-preserving user apparatus 300 for selection).

FIG. 12B illustrates a data flow between components for performing an example implementation of the process depicted with respect to FIG. 12A for generating a personalized search result set, in accordance with at least some example embodiments of the present disclosure. The personalized search result set is generated based on a search query, for example inputted by a user, and includes a feedback loop such that processing of subsequent search queries are informed based on information learned from the processing of prior search queries, as described herein. The operations are depicted and described as performed by a privacy-preserving user apparatus 300, for example embodying the user device 102 specially configured to enable performance of privacy-preserving personalized searching. It should be appreciated that, for one or more of the described operations as depicted and described with respect to FIG. 12B, the privacy-preserving user apparatus 300 may interact with one or more other computing devices, apparatuses, and/or the like, such as a search system and/or a privacy-preserving federated learning system.

The detailed process includes a feedback loop initiated at operation 1252. The feedback loop includes several sub-operations, for example each of the operation 1254-1264, that produces information that informs future iterations of search query processing. In this regard, in addition to generating a personalized search result set, the detailed process depicted and described with respect to FIG. 12B illustrates how the data produced by each operation improves the overall effectiveness of the process in accurately producing personalized search results.

The feedback loop utilizes electronic resource information 1268 and user history 1270, as well as local history information for the interactions and rankings previously associated with the user from previous queries. The electronic resource information 1268 embodies various data associated with an electronic resource corresponding to a search result in a search result set provided by a search system in response to the particular inputted search query. For example, the electronic resource information 1268 may include various data associated with each search result. Non-limiting examples of such information may include a resource identifier for the search query (resource ID), a snippet or other extracted data portion of the electronic resource (snippet), a title of the electronic resource (title), a URL indicating where the electronic resource corresponding to the search result is located (URL), and a domain associated with the electronic resource corresponding to the search result (domain). In some embodiments, all of the electronic resource information 1268 is provided by the search system in response to the particular search query.

The user history 1270 may include various data associated with previous interactions by a user account with search queries and corresponding personalized search results. Non-limiting examples of such information includes previously-selected search results, previous search queries, and/or the like. In some embodiments, the user history 1270 is stored by the specially configured user apparatus 300 in one or more repositories local to or otherwise accessible uniquely to the user of the specially configured user apparatus 300. For example, the specially configured user apparatus 300 may maintain a user-specific interest data repository that stores the user history 1270 for a single user, for example where a single user account is associated with the specially configured user apparatus 300, or particular user accounts, for example where a user may login to associate the specially configured user apparatus 300 with a specific user account corresponding to the user.

The feedback loop enables the results of personalization for previous search queries to adjust data values, weights, and other parameters that affect handling of the current and subsequent search queries. For example, previously-engaged search results (e.g., the personalized search results that were provided and engaged with by a user) may be used for calculation of the model weights utilized by the learning to rank algorithm. Additionally, the context data associated with the previously-engaged search results enables updating of one or more corresponding center(s) of interest and/or center(s) of disinterest, as described herein. Such updating may be performed in a manner such that the effects of older engaged search results may be weakened as new search queries are processed. Additionally or alternatively still, for example, the previously engaged search results may influence the probability distribution of a dynamic contextual multi-armed bandit for the context cluster of search results to which the search result belong. In this regard, for example, the probability distribution may be updated to increase the probability of selecting from the contexts with which the user has previously engaged.

Flow then proceeds into two branches, which may occur in parallel or in series. The first branch of operations includes operation 1254. The second branch of operations includes operations 1256 and 1258. It should be appreciated that, in some embodiments, parallel processing and/or other simultaneous processing methodologies may be leveraged to enable such operations to occur entirely or substantially at the same time.

At operation 1254 a learning to rank algorithm is executed to generate a learning to rank score (LTR_Score) for each of the search results in a particular search result list. For each search result, the learning to rank algorithm generates the corresponding learning to rank score based on the user history 1270, the search query terms, and one or more portions of the electronic resource information 1268 corresponding to the search result, such as the URL and/or domain for the search result. The learning to rank algorithm additionally is performed utilizing a list of model weights, for example retrieved or otherwise received from a model weights database 1272. The model weights used by the learning to rank algorithm may be updated based on a plurality of other models. In this regard, the learning to rank algorithm may be updated locally and/or in a privacy-preserving manner via communication with a privacy-preserving federated learning system based on data trends learned from those model(s) (e.g., whether search results ranked highly for the user of the local device have been interacted with, for example). In some embodiments, for example, the model weights for the learning to rank algorithm are updated based on local interactions by the user on the specially configured user apparatus 300, then updated in a privacy-preserving manner to account for trends and data relationships learned by other instances associated with other embodiments for different users such that the model weights database 1272 is updated with new weights based on these learned relationships. The model weights may then continue to be updated locally, and the cycle of privacy-preserving updating (e.g., via communication with a privacy-preserving federated learning system) repeated for any number of cycles at various time intervals. The resulting LTR_score may be utilized at operation 1260 for context calculation, as described herein.

At operation 1256, a context embedding algorithm is performed to generate context data representing an embedding of the electronic resource associated with each search result in a particular embedding space. For example, the context embedding algorithm may generate context data for the electronic resource based on particular data associated with the electronic resource, such as a snippet received from the search system or extracted by the specially configured user apparatus 300. The snippet, for example, may be an extracted portion of the electronic resource corresponding to the search result for display, as known in the art. In some embodiments, the context embedding algorithm is embodied by a specially configured BERT implementation. For example, the BERT implementation may be reduced to a limited language set and/or otherwise optimized to reduce the number of factors such that the computational resources required to execute the BERT implementation is reduced and enables mobile execution (e.g., on a smartphone or tablet device).

At operation 1258, the search results are assigned to relevant centers of interest and/or centers of disinterest. The search results may be assigned to the centers of interest and/or centers of disinterest utilizing the various algorithms described herein for assigning a search result to a center of interest and/or center of disinterest. For example, in some embodiments, a search result is assigned to one or more centers of interest and/or centers of disinterest based on the context distance between the context data for the electronic resource corresponding to the search result and context data represented by the center of interest or center of disinterest. The algorithms may output data associated with the assignment of a center of interest and/or center of disinterest for each centroid. For example, each search result may be associated with at least one centroid identifier that identifies the center of interest or center of disinterest (Centroid_ID) to which the search result was assigned (e.g., as part of a context cluster for that center of interest/disinterest), and/or a distance to the center of interest (Distance_pos) and/or distance to the center of disinterest (Distance_neg).

The centroids may be stored in a centroids database 1274. For example, the centroids database 1274 may be updated as a user interacts with personalized search results and/or provides indications of interest and/or disinterest as described herein. The centroids database 1274 may store various information for each centroid including, without limitation, a centroid identifier (centroid ID), a flag indicating center of interest (pos) or center of disinterest (neg), a context data value representing the position of the centroid (center), an age of the centroid (age), and beta and alpha values for the centroid position.

At operation 1260, a normalized context calculation is performed. The normalized context calculation generates a normalized context value, for example that falls between 0 and 1 inclusive. The normalized context value for each search result may be based on the learning to rank score for the search result, and the assigned center(s) of interest and/or center(s) of disinterest for the search result and context distances thereto. The normalized context value may be generated from multiple factors, for example as a sum of the factors described herein with respect to equations 2-5. In this regard, the resulting normalized context value for a particular electronic resource may represent how well the search result should rank within a particular context as compared to other electronic resources associated with the context on a normalized scale.

At operation 1262, a dynamic contextual multi-armed bandit is utilized to select personalized search results from the set of search results. For example, the dynamic contextual multi-armed bandit may make any number of selections based on the normalized context values for the various search results (Context values) the various centers of interest and/or disinterest from the centroids database 1274. In this regard, particular distribution parameters defining the dynamic contextual multi-armed bandit may be determined and utilized to select a particular context, and subsequently the highest-ranked document from that context. In this regard, the dynamic contextual multi-armed bandit may select from the highest ranked context while accounting for an exploration offset that enables the dynamic contextual multi-armed bandit to explore contexts otherwise not top ranked. In this regard, the dynamic contextual multi-armed bandit may provide highly-ranked results from highly-ranked contexts while similarly enabling exploration of results from other contexts.

The dynamic contextual multi-armed bandit may output a desired number of search results in a ranked order. For example, the dynamic contextual multi-armed bandit may select from the search result set to generate the ranked search results 1266. The ranked search results 1266 may embody the personalized search result set to be output in response to the particular search query inputted by the user. In this regard, the first search result in the ranked search results 1266 may embody a personalized search result determined to be most likely engaged by the user in response to the search query, the second search result in the ranked search results 1266 may embody a personalized search result determined to be second most likely to be engaged by the user in response to the search query, and so on. It should be appreciated that one or more of the search results in the ranked search results 1266 may be provided as a personalized search result based on an exploration deviation, such that the search result is provided as a method of exploring new contexts to determine the user's interests or disinterests in such context rather than because the search result was highest ranked of a particular selected context.

At operation 1264, data generated during the current iteration of generating the personalized search result set is saved. For example, for each personalized search result, particular data may be stored to the local history repository 1276. Such data may include the resource identifier for the search result, the query identifier, a learning to rank score, a normalized context value, an initial ranking, a shown ranking, a centroid identifier for the assigned center of interest and/or disinterest, and/or a distance from the centroid. It should be appreciated that, in this regard, the local history repository 1276 may include information associated with each personalized search result for use in determining whether such personalized search results were highly ranked, interacted with, and/or the like. Such information may inform subsequent rankings based on whether a highly ranked personalized search result was in fact interacted with by the user.

The information stored to the local history repository 1276 may subsequently be stored to and/or utilized to generate analytics 1278. For example, the analytics 1278 may include a determination as to the ranking quality of previously generated personalized search results, such as a normalized discounted cumulative gain (NDCG) value generated based on such rankings for personalized search results or particular rankings generated via the learning to rank algorithm. In some embodiments, for example, the NCDG for the learning to rank algorithm may be utilized to improve the accuracy of the learning to rank algorithm as personalized search results are provided and/or engaged with, such as by improving the accuracy of the rankings produced by the learning to rank algorithm based on the results engaged with by the user. Additionally or alternatively, the information stored to the local history repository 1276 may be utilized in subsequent iterations of the feedback loop 1252, as described herein.

### Example Data Interactions for Privacy-Preserving Personalized Search Training of the Disclosure

Data interactions between components embodied in hardware, software, firmware, and/or a combination thereof for privacy-preserving personalized search training in accordance with the present disclosure will now be described. In this regard, it should be appreciated that in some embodiments, a privacy-preserving user apparatus 300 is configured to both perform privacy-preserving personalized searching and privacy-preserving personalized search training. The privacy-preserving personalized search training may enable the privacy-preserving user apparatus 300 to select and/or otherwise output personalized search result(s) that are more likely to be accessed associated with a particular user profile based on interest(s) and/or disinterest(s). In this regard, such embodiments may both perform privacy-preserving personalized search while improving the accuracy of such processes via the privacy-preserving personalized search training processes described.

The privacy-preserving personalized search training processes described provide various technical advantages. For example, by training one or more models to improve the accuracy of selected search results, such embodiments waste less resources by outputting search results that are irrelevant to or otherwise unlikely to be accessed by a particular user profile associated with a particular search query. In this regard, computing resources are wasted by generating the search results and outputting them, for example via a rendered user interface on a user device. Additionally, such training improves the overall efficacy and efficiency by which a user may satisfy their search query. Additionally or alternatively, by performing such training in a privacy-preserving manner (e.g., locally or via communication with a privacy-preserving federated learning system), the accuracy improvements associated with consistent training and personalized data use are obtained without exposing a user's data to third-party entities and/or systems. As such, embodiments may learn (at one time, at multiple times, or continuously) about interests of a user profile to provide personalized search results that are likely to be accessed associated with that user profile without sacrificing full data privacy associated with such user-specific interest data utilized in training one or more models used in providing personalized search.

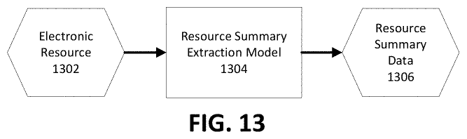

FIG. 13 illustrates an example resource summary generation process in accordance with at least some example embodiments of the present disclosure. Specifically, FIG. 13 illustrates generation of resource summary data 1306 associated with an electronic resource 1302 utilizing a resource summary extraction model 1304. The electronic resource 1302 may correspond to a particular search result for a search query inputted by a user associated with a particular user profile and/or user device. In some embodiments, for example, the electronic resource 1302 is identified and/or accessed via a search system to which the search query is transmitted and/or otherwise processed. As described herein, one or more electronic resources, such as the electronic resource 1302, may be received and processed on a user device specially configured to utilize the resource summary extraction model 1304, for example the privacy-preserving user apparatus 300 and/or a corresponding search system. In some embodiments, a search system extracts resource summary data associated with each electronic resource and stores the resource summary data 1306 included in and/or together with a search result in the search index.

The electronic resource 1302 may include or be associated with various data, such as content data, metadata, and/or the like. In some embodiments, the electronic resource 1302 is retrieved and/or otherwise accessed via a pointer maintained by and/or otherwise included in a search index maintained by a search system that identified and provided search results associated with a particular user query. For example, the electronic resource 1302 may embody the entirety of an electronic resource retrieved and/or otherwise accessed from a particular web-address, for example, or particular portion(s) thereof.

The resource summary extraction model 1304 may be a specially configured algorithmic, statistical, and/or machine learning model that extracts the resource summary data 1306 from the electronic resource 1302. For example, the resource summary extraction model 1304 may process particular portions of the electronic resource 1302 (e.g., a title, an abstract, other portion(s) of content data for the electronic resource 1302, and/or all of the content data for the electronic resource 1302) to provide a human-interpretable summary or other summary of the data in the electronic resource 1302. In some embodiments, a resource summary extraction model 1304 comprises one or more model(s) known in the art for generating a summary or preview of a search result for providing as a search result via a search engine.

The resource summary data 1306 may include any of a myriad of data determined as likely useful for displaying to a user for analyzing whether the search result associated with the electronic resource 1302 is of interest associated with a particular search query. In some embodiments, for example, the resource summary data 1306 includes a domain or other pointer associated with the electronic resource 1302 (e.g., a hostname, IP address, URL, URI, or other web-address for accessing the electronic resource 1302). Alternatively or additionally, in some embodiments, the resource summary data 1306 includes a data value representing when the electronic resource 1302 become available or was otherwise “posted” (e.g., a datetime value, or a timestamp interval from the time made available until the current timestamp), an author associated with the electronic resource 1302, a content type associated with the electronic resource 1302, and/or the like. In this regard, the resource summary data 1306 may be processed to generate and/or otherwise output a corresponding interface element associated with the search result.

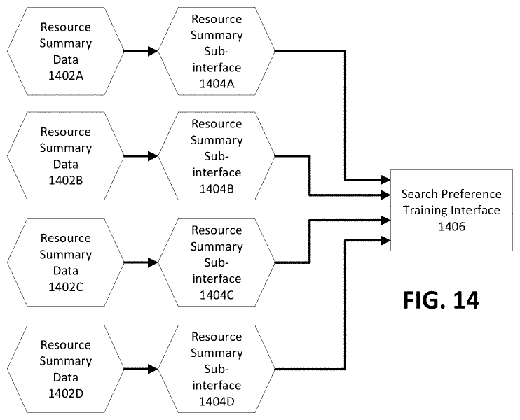

FIG. 14 illustrates an example search preference training interface and associated process in accordance with at least some example embodiments of the present disclosure. Specifically, FIG. 14 illustrates data interactions of a process for generating a search preference training interface 1406 in accordance with the present disclosure. The search preference training interface 1406 may be specially configured to enable a user to indicate interest or disinterest in a particular user query. In this regard, the search preference training interface 1406 may be configured to receive user input data associated with indicating such interest and/or disinterest in one or more search results. In some embodiments, the search preference training interface 1406 is generated and/or otherwise rendered via a user device, for example embodied by the privacy-preserving user apparatus 300.

As illustrated, for example, a plurality of resource summary data 1402A-1402D may be generated and/or otherwise received. Each resource summary data may correspond to a different search result associated with a particular inputted search query. For example, a user may input a search query via the privacy-preserving user apparatus 300, which is transmitted to a search system and processed to identify a search result set. Resource summary data may be identified and/or otherwise generated for each electronic resource associated with a search result of the search result set, for example by the search system or the privacy-preserving user apparatus 300, utilizing a resource summary extraction model as described with respect to FIG. 13. In this regard, for example, the resource summary data 1402A may correspond to a data summary of a first search result and associated first electronic resource, the resource summary data 1402B may correspond to a data summary for a second search result and associated second electronic resource, the resource summary data 1402C may correspond to a data summary of a third search result and associated third electronic resource, and the resource summary data 1402D may correspond to a data summary for a fourth search result and associated fourth electronic resource.

Privacy-preserving user apparatus 300 may generate the search preference training interface 1406 to include a resource summary sub-interface associated with each search result of the search result set. In this regard, the resource summary sub-interface for a particular search result may include a visual representation of the resource summary data corresponding to the search result and/or be configured to enable the user to indicate an interest and/or disinterest in the search result via user input. For example, as illustrated, the resource summary data 1402A may be utilized to generate and/or configure a resource summary sub-interface 1404A that corresponds to the first search result. Similarly, the resource summary data 1402B may be utilized to generate and/or configure a resource summary sub-interface 1404B that corresponds to the second search result, the resource summary data 1402C may be utilized to generate and/or configure a resource summary sub-interface 1404C that corresponds to the third search result, and/or the resource summary data 1402D may be utilized to generate and/or configure a resource summary sub-interface 1404D that corresponds to the fourth search result. Each of the resource summary sub-interfaces 1404A-1404D may include different data values based on the corresponding resource summary data for the search result, for example including a different title, a different content summary, a different domain, and/or the like.

Additionally or alternatively, in some embodiments, each resource summary sub-interface is configured to receive user input data indicating interest and/or disinterest in the corresponding search result. For example, in some embodiments, each resource summary sub-interface 1404A-1404D is configured to receive user input data of a first type (e.g., a left swipe) indicating disinterest in the corresponding search result, and user input data of a second type (e.g., a right swipe) indicating interest in the corresponding search result. In this regard, the user may interact with each resource summary sub-interface to indicate whether the user is interested or disinterested in the corresponding search result, and such indications may be processed to update data associated with the interests of a particular user and/or user profile. For example, in some embodiments, data representing indication(s) of interest and/or disinterest in particular search results may be utilized to update one or more centers of interest associated with the particular user profile representing the particular user. Additionally or alternatively, in some embodiments, once a user interacts with a resource summary sub-interface, one or more additional interface(s) are rendered associated with collecting additional data for use in determining why a user is interested or disinterested in a particular search result.

It should be appreciated that resource summary data may be generated for any number of search results in a search result set. Similarly, the search preference training interface 1406 may be configured to include any number of resource summary sub-interfaces. Additionally or alternatively, in some embodiments, once a user interacts with a resource summary sub-interface to indicate interest or disinterest in the corresponding search result for a particular search query, the resource summary sub-interface may be replaced and/or updated to be associated with a next search result to be rendered and include information associated with resource summary data for the next search result. In this regard, the user may continue to provide data representing an indication of interest and/or disinterest in any number of search results without navigating to separate interfaces for each search result.

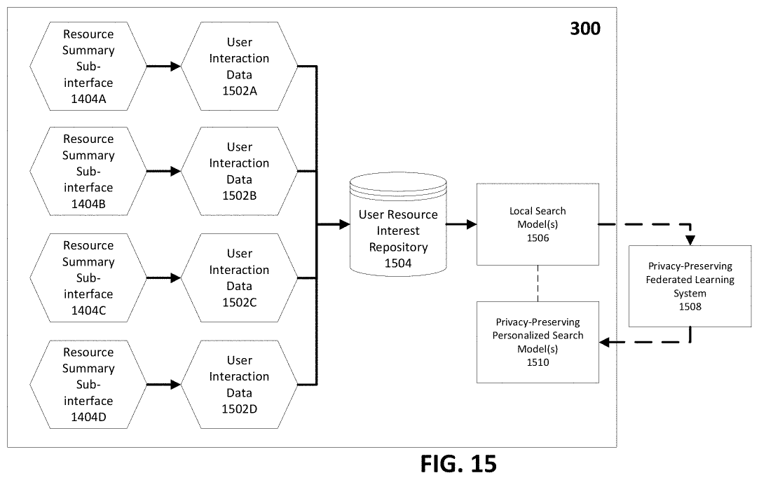

FIG. 15 illustrates a privacy-preserving personalized search model training process in accordance with at least some example embodiments of the present disclosure. Specifically, FIG. 15 illustrates data interactions for privacy-preserving personalized search training via user interaction with elements of a search preference training interface.

As illustrated and described, a plurality of resource summary interfaces 1404A-1402D, for example, may be rendered and/or otherwise provided via a privacy-preserving user apparatus 300 for viewing and/or interaction by a user of the privacy-preserving user apparatus 300. For example, the user may interact with each of the resource summary sub-interfaces 1404A resulting in user interaction data 1502A-1502D. Each of the user interaction data 1502A-1502D may represent a different user interaction with each of the resource summary sub-interfaces 1404A-1404D, where each user interaction represents interest or disinterest in the corresponding search result. For example, in some embodiments, the user performs a first user interaction associated with the resource summary sub-interface 1404A (e.g., a left swipe) resulting in user interaction data 1502A that represents disinterest in the first search result corresponding to the resource summary sub-interface 1404A. The user may subsequently perform a second user interaction associated with the resource summary sub-interface 1404B (e.g., a right swipe) resulting in user interaction data 1502B that represents interest in the second search result corresponding to the resource summary sub-interface 1404B. Such interaction may continue for any number of resource summary sub-interfaces and corresponding search results.

The user interaction data or corresponding data representing an indication of interest or disinterest in a particular search result may be stored alone or together with the search result, context data associated with the search result, and/or the like. Such data may be stored for processing via the privacy-preserving user apparatus 300. In this regard, data particular to the privacy-preserving user apparatus 300 and/or users of the privacy-preserving user apparatus 300 may be stored in a user resource interest repository 1504. The data stored to the user resource interest repository 1504 may embody user-specific interest data, which may be utilized to determine the interest(s) a user profile associated with the privacy-preserving user apparatus 300 and/or otherwise train one or more model(s) based on such data. For example, in some embodiments, the user-specific interest data may be utilized to generate one or more center(s) of interest and/or one or more center(s) of disinterest for a particular user profile.

As illustrated, for example, the user-specific interest data embodied in the user resource interest repository 1504 (e.g., data indicating interest and/or disinterest in particular search result(s) based on the user interaction data 1502A-1502D associated with the resource summary sub-interfaces 1404A-1404D) may be utilized to train one or more local search model(s) 1506 maintained by and/or otherwise utilized by the privacy-preserving user apparatus 300. In this regard, the local search model(s) 1506 may each embody privacy-preserving personalized search model(s) and/or sub-model(s) thereof utilized to select search result(s) for providing in a personalized search result for a particular search query. In this regard, the local search model(s) 1506 may be utilized to determine which search results are likely to be accessed by a particular user based on their indicated interests and/or disinterests, and/or determinations derived therefrom (e.g., the centers of interest and/or disinterest in a particular context mapping space).

In some embodiments, the local search model((s) 1506 are maintained entirely locally. Alternatively or additionally, in some embodiments, each of the local search model(s) m1506 may be updated in a privacy-preserving manner that enables the updated model to learn from trends and/or data relationships identified from a plurality of implementations of such a model associated with different devices and/or users. For example, the local search model(s) 1506 may be utilized to train one or more privacy-preserving personalized search model(s) 1510 in a privacy-preserving manner via communication with a privacy-preserving federated learning system 1508. In this regard, the privacy-preserving personalized search model(s) may represent updated, global versions of the model(s) trained based on the local search model(s) 1506 for various user(s) and/or user devices. Such training may be performed in a privacy-preserving manner by masking the local model for each device (e.g., multiple privacy-preserving user apparatuses 300), transmitting at least a portion of the masked local (or “client”) models to the privacy-preserving federated learning system 1508 for use in generating a masked updated global model that can only be unmasked by a secure unmasking data object generated based on the masks utilized to generate each masked client model utilized in generating the masked updated global model (and which may not be made available to the privacy-preserving federated learning system 1508), and receiving an updated masked global model from the privacy-preserving federated learning system 1508 for unmasking and use as one or the privacy-preserving personalized search model(s) 1510. In this regard, the secure unmasking data object may be received from a sub-system of the privacy-preserving federated learning system 1508, a second external system (e.g., a mask distributor), another specially configured user device, and/or may be generated by the privacy-preserving user apparatus 300 based on information received from various external devices (e.g., mask information from other specially configured user devices). In this regard, the privacy-preserving personalized search model(s) 1510 may be stored and/or utilized by the privacy-preserving user apparatus 300 once unmasked.

Additionally or alternatively, the privacy-preserving personalized search model(s) 1510 may be stored as the new local search model(s) 1506 for the privacy-preserving user apparatus 300, and/or locally updated as a user continues to interact with the privacy-preserving user apparatus 300 for performing privacy-preserving personalized search and/or corresponding training functionality. In this regard, it should be appreciated that such models may again be utilized in updated training in a privacy-preserving manner. For example, the privacy-preserving personalized search model(s) 1510 stored as the local search model(s) 1506 may subsequently be updated locally, and utilized in global training in a privacy-preserving manner via communication with the privacy-preserving federated learning system 1508 at predefined timestamp intervals (e.g., monthly), upon certain triggers (e.g., certain amount of search queries), and/or the like. The local updates to the local search model(s) 1506 on each specially configured user device, for example embodied by the privacy-preserving user apparatus 300, cause trends learned by each local model to reflected in the updated global model subsequently generated and distributed to various users upon initiation of the global training in the privacy-preserving manner via the privacy-preserving federated learning system 1508, as described.

### Example Interfaces of the Disclosure

Having described example systems, apparatuses, data interactions, and example processes for performing privacy-preserving personalized search training in accordance with the present disclosure, example interfaces associated with privacy-preserving personalized search training may now be described. In this regard, such interfaces may be engaged with by a user to perform functionality associated with privacy-preserving personalized search training. In some embodiments, a user-facing application is provided that enables rendering of such interfaces to a user device, for example embodied by a privacy-preserving user apparatus 300. For example, a user-facing web application and/or a native user-facing application may be provided that provides the privacy-preserving personalized search training functionality as described herein.

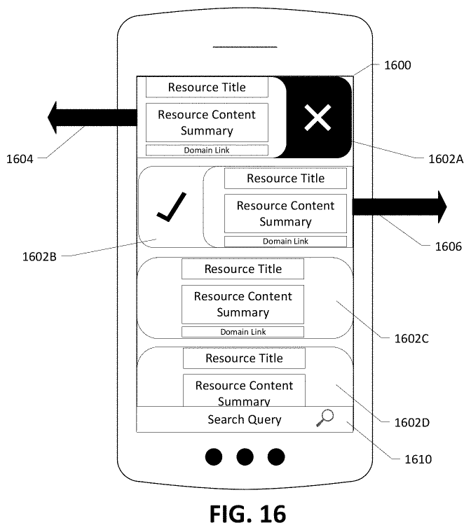

FIG. 16 illustrates an example search preference training interface in accordance with at least some example embodiments of the present disclosure. Specifically, FIG. 16 depicts an example search preference training interface 1600 including a plurality of sub-interfaces associated with providing indications of interest and/or disinterest in particular search results. In some embodiments, the privacy-preserving user apparatus 300 is configured to cause rendering of the search preference training interface 1600. For example, in some embodiments, the search preference training interface 1600 is rendered to a display of the privacy-preserving user apparatus 300. The search preference training interface 1600 may cause rendering of the search preference training interface 1600 to the display of the privacy-preserving user apparatus 300 via a specially configured user-facing application executed via the privacy-preserving user apparatus 300.

As illustrated, the search preference training interface 1600 optionally includes a search query input data field 1610. The search query input data field 1610 includes data embodying the search query inputted by the user. In some embodiments, for example, the search query input data field 1610 may be configured to receive data inputted by the user that is to be utilized for searching, such as inputted search terms, an inputted search string, inputted image data, and/or the like. The search query embodied by the search query input data field 1610 may be transmitted to a search system for processing, and a set of search results corresponding to the search query received in response from the search system. In some such embodiments, resource summary sub-interfaces may be generated and/or rendered for each search result in the set of search results. In other embodiments, the search result set is personalized utilizing the privacy-preserving personalized search functionality described herein, to generate a personalized search results set. The personalized search results set may subsequently be utilized to cause rendering of corresponding resource summary sub-interfaces.

The search preference training interface 1600 includes a plurality of resource summary sub-interfaces 1602A-1604D (collectively, “resource summary sub-interfaces 1602), For example, in some embodiments, example the resource summary sub-interface 1602A, the resource summary sub-interface 1602B, the resource summary sub-interface 1602C, the resource summary sub-interface 1602D. Each resource summary sub-interface may be associated with a particular search result and/or personalized search result corresponding to the search query inputted by the user. It should be appreciated that, in some embodiments, the search preference training interface 1600 is configured such that a limited number of resource summary sub-interfaces are rendered at one time (e.g., only a single resource summary sub-interface at a time, a predetermined number of resource summary sub-interfaces, as many resource summary sub-interfaces as can fit based on the dimensions of the display, and/or a navigable or otherwise “scrollable” interface that includes a resource summary sub-interface for each search result and/or personalized search result).

In this regard, each resource summary sub-interface includes various interface elements associated with resource summary data for the corresponding search result and/or personalized search result. For example, as illustrated, the resource summary data may include a resource title, a resource content summary, and a domain link associated with the corresponding search result and/or personalized search result. Each of these data values may be rendered via one or more interface elements of the corresponding resource summary sub-interface, such that the user may view such data values. It should be appreciated that one or more of the plurality of resource summary sub-interfaces 1602 may include one or more alternative data values, for example an author, a content type, a resource creation and/or posting timestamp, and/or the like.

The user may view the data of one of the plurality of resource summary sub-interfaces 1602 to consider whether the corresponding search result and/or personalized search result is of interest to the user, and may interact with the resource summary sub-interface to provide indication(s) of whether the search result and/or personalized search result is of interest to the user. For example, in some embodiments, each of the plurality of resource summary sub-interfaces 1602 is configured to receive user input data embodying a left swipe or a right swipe on the corresponding resource summary interface. In some such embodiments, for example, the user may left swipe on a resource summary sub-interface to indicate the user is not interested in the search result and/or personalized search result corresponding to the resource summary sub-interface. Alternatively or additionally, in some embodiments for example, the user may right swipe on a resource summary sub-interface to indicate the user is interested in the search result and/or personalized search result corresponding to the resource summary sub-interface.

As illustrated, for example, the user may provide user input data 1604 (e.g., a left swipe) to indicate the user is not interested in the search result or personalized search result corresponding to the resource summary sub-interface 1602A. Such user input data 1604 may be stored, and/or processed to be utilized in training one or more search model(s) and/or otherwise updating data representing interests and/or disinterests associated with the particular user (e.g., corresponding to a user profile embodying the user). For example, in some embodiments, the user input data 1604 is utilized to update one or more centers of interest and/or centers of disinterest associated with the user. In one or more embodiments, a user resource interest model is updated based on at least the indication of interest in the search result or personalized search result corresponding to the resource summary sub-interface 1602A.

Further as illustrated, for example, the user may provide user input data 1606 (e.g., a right swipe) to indicate the user is interested in the search result or personalized search result corresponding to the resource summary sub-interface 1602B. Such user input data 1606 may be stored, and/or processed to be utilized in training one or more search model(s) and/or otherwise updating data representing interests and/or disinterests associated with the particular user (e.g., corresponding to a user profile embodying the user). For example, in some embodiments, the user input data 1606 is utilized to update one or more centers of interest and/or centers of disinterest associated with the user. In one or more embodiments, a user resource interests model is updated based on at least the indication of disinterest in the search result or personalized search result corresponding to the resource summary sub-interface 1602B.

In some embodiments, as the user interacts with a resource summary sub-interface to provide an indication of interest or disinterest, the resource summary sub-interface is replaced with a resource summary sub-interface corresponding to a search result or personalized search result not yet processed from a search result set with respect to the inputted search query. In this regard, the user may continue to analyze and interact with such resource summary sub-interfaces. It should be appreciated that, in some embodiments, a predetermined number of resource summary sub-interfaces are provided for interaction by the user. In other embodiments, resource summary sub-interfaces may be provided until all search results and/or personalized search results corresponding to the inputted search query have been provided corresponding to a resource summary sub-interface for consideration and/or interaction by the user.

The user may continue to interact with each resource summary sub-interface in a similar manner. In this regard, for example, the user may interact with each of the resource summary sub-interface 1602C and resource summary sub-interface 1602D. Additionally or alternatively, the user may interact with each resource summary sub-interface that replaces resource summary sub-interfaces previously interacted with. Additionally or alternatively, the user may input a new search query to retrieve a new set of search results and/or personalized search results for rendering corresponding resource summary sub-interfaces. It should be appreciated that the search query may be updated at any time while viewing, analyzing, and/or interacting with the various resource summary sub-interfaces rendered to the search preference training interface.

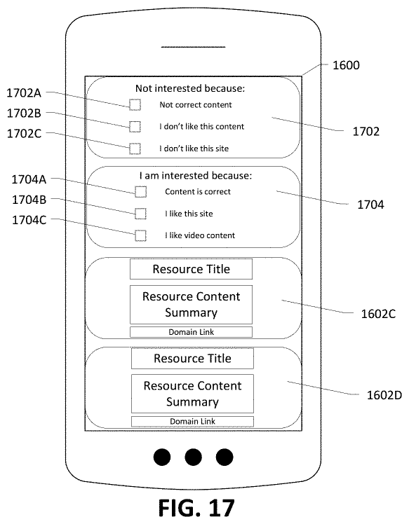

FIG. 17 illustrates an example search preference training interface including a disinterest investigation interface and an interest investigation interface in accordance with at least some example embodiments of the present disclosure. Specifically, FIG. 17 depicts an example search preference training interface 1600 updated to include a plurality of sub-interfaces associated with investigating user-specific interest data that corresponds to and/or represents reasons why the user is interested and/or disinterested in particular search results. In some embodiments, the privacy-preserving user apparatus 300 is configured to cause rendering of the search preference training interface 1600. The sub-interfaces may be updated, for example, in response to receiving user input data with a particular resource summary sub-interface that indicates an interest or disinterest in a particular search result and/or personalized search result.

In some embodiments, a disinterest investigation interface is rendered in a circumstance where the user provided user input data indicating disinterest in a search result or personalized search result. The disinterest investigation interface may be rendered to replace, rendered within, and/or otherwise rendered associated with the resource summary sub-interface corresponding to the search result or personalized search result. In this regard, the privacy-preserving user apparatus 300 may render the disinterest investigation interface in place of, or together with, a corresponding resource summary sub-interface after the user interacts with the resource summary sub-interface to provide an indication of interest or disinterest.

As illustrated, for example, the disinterest investigation interface 1702 is rendered associated with the resource summary sub-interface 1602A, for example upon receiving and/or processing the user input data 1604. The disinterest investigation interface 1702 is rendered at the same position as the corresponding resource summary sub-interface 1602A, for example wherein the disinterest investigation interface 1702 is generated at the same position, or where the interface elements of the disinterest investigation interface 1702 are rendered to replace those of the corresponding resource summary sub-interface 1602A.

The disinterest investigation interface 1702 includes a plurality of user insight interface elements, such as the plurality of user insight interface elements 1702A-1702C. For example, as illustrated, the disinterest investigation interface 1702 includes a user insight interface element 1702A associated with indicating whether the content of the search result or personalized search result is what the user is looking for with respect to the corresponding search query. The disinterest investigation interface 1702 further includes a user insight interface element 1702B associated with indicating whether the content corresponding to the search result or personalized search result is not preferred by the user. The disinterest investigation interface 1702 further includes a user insight interface element 1702C associated with indicating whether the domain associated with the search result or personalized search result is not preferred by the user. In this regard, each of the plurality of user insight interface elements 1702A-1702C are configured to receive user interaction that toggles selection of the corresponding user insight interface element. It should be appreciated that, in other embodiments, user insight interface element(s) may be provided corresponding to any number of desired user insights (e.g., corresponding to particular reasons why a user may indicate disinterest in a corresponding search result or personalized search result).

In some embodiments, the disinterest investigation interface 1702 is rendered via an animation upon interaction with the corresponding resource summary sub-interface. For example, in some embodiments, the various sub-interfaces of the disinterest investigation interface 1702 (e.g., interface elements 1702A-1702C) slide in or otherwise animate to be displayed upon completion of a left swipe or other user input on the corresponding resource summary sub-interface 1602. In other embodiments, the disinterest investigation interface 1702 is revealed upon interaction with the resource summary sub-interface 1602 (e.g., by swiping away the resource summary sub-interface 1602 to reveal the disinterest investigation interface 1702).

Each user insight interface element may be associated with receiving data representing a user's reasons for disinterest in a corresponding search result and/or personalized search result. In this regard, each user insight interface element 1702A-1702C may correspond to particular user-specific interest data and/or training particular search model(s). For example, user insight data corresponding to the selection of user insight interface element 1702A may be utilized in training a search system to identify particular search results, and/or a privacy-preserving personalized search model. Additionally or alternatively still, user insight data corresponding to the selection of user insight interface element 1702B may be utilized in updating training of a user resource interest model. Additionally or alternatively still, user insight data corresponding to the selection of user insight interface element 1702C may be utilized in updating training of a user domain preference model.

In some embodiments, each user insight interface element is utilized in training a different search model. In other embodiments, one or more user insight interface element(s) correspond to training the same search model, and/or a plurality of search model(s). For example, in this regard, the search model(s) may be updated to account for search results that should be avoided when providing personalized search results to the user.

In some embodiments, an interest investigation interface 1704 is rendered in a circumstance where the user provided user input data indicating interest in a search result or personalized search result. As illustrated, for example, the interest investigation interface 1704 is rendered associated with the resource summary sub-interface 1602B, for example upon receiving and/or processing the user input data 1606. The interest investigation interface 1704 is rendered at the same position as the corresponding resource summary sub-interface 1602B, for example wherein the interest investigation interface 1704 is generated at the same position, or where the interface elements of the interest investigation interface 1704 are rendered to replace those of the corresponding resource summary sub-interface 1602B.

In some embodiments, the interest investigation interface 1704 is rendered via an animation upon interaction with the corresponding resource summary sub-interface. For example, in some embodiments, the various sub-interfaces of the interest investigation interface 1704 (e.g., interface elements 1704A-1704C) slide in or otherwise animate to be displayed upon completion of a right swipe or other user input on the corresponding resource summary sub-interface 1604. In other embodiments, the interest investigation interface 1704 is revealed upon interaction with the resource summary sub-interface 1604 (e.g., by swiping away the resource summary sub-interface 1604 to reveal the interest investigation interface 1704).

The interest investigation interface 1704 includes a plurality of user insight interface elements, such as the plurality of user insight interface elements 1704A-1704C. For example, as illustrated, the interest investigation interface 1704 includes a user insight interface element 1704A associated with indicating whether the content of the search result or personalized search result is what the user is looking for with respect to the corresponding search query. The interest investigation interface 1704 further includes a user insight interface element 1704B associated with indicating whether the content corresponding to the search result or personalized search result is preferred by the user. The interest investigation interface 1704 further includes a user insight interface element 1704C associated with indicating whether the content type associated with the search result or personalized search result is preferred by the user. In this regard, each of the plurality of user insight interface elements 1704A-1704C are configured to receive user interaction that toggles selection of the corresponding user insight interface element. It should be appreciated that, in other embodiments, user insight interface element(s) may be provided corresponding to any number of desired user insights (e.g., corresponding to particular reasons why a user may indicate interest in a corresponding search result or personalized search result).

Each user insight interface element may be associated with receiving data representing a user's reasons for interest in a corresponding search result and/or personalized search result. In this regard, each user insight interface element 1704A-1704C may correspond to particular user-specific interest data and/or training particular search model(s). For example, user insight data corresponding to the selection of user insight interface element 1704A may be utilized in training a search system to identify particular search results, and/or a privacy-preserving personalized search model. Additionally or alternatively still, user insight data corresponding to the selection of user insight interface element 1704B may be utilized in updating training of a user resource interest model. Additionally or alternatively still, user insight data corresponding to the selection of user insight interface element 1704C may be utilized in updating training of a user content type preference model.

As described with respect to the disinterest investigation interface 1702, in some embodiments, each user insight interface element is utilized in training a different search model. In other embodiments, one or more user insight interface element(s) correspond to training the same search model, and/or a plurality of search model(s). For example, in this regard, the search model(s) may be updated to account for search results that should be prioritized when providing personalized search results to the user.

In this regard each user insight interface element may be associated with one or more particular model(s). For example, in a circumstance where the user interacts with an interest insight interface element that indicates the search result was merely not interesting to the user, a model that generates one or more center(s) of disinterest (and/or the actual center of disinterest\) is updated based on such data. Additionally or alternatively, in circumstances where the user interacts with an interest insight interface element that indicates the search result was not associated with an interesting domain, the learning to rank algorithm embodying the domain preference model may be updated. Alternatively or additionally, in some embodiments, interaction with a user insight interface element causes rendering of another associated user insight interface element, where the update is performed based on the user insight with this second user insight interface element. For example, in a circumstance where the user interacts with a user insight interface element to indicate a reason or context that is incorrect associated with the search result for the search query, which may be utilized to update a resource context model that generates the context data associated with particular search result(s).

In some embodiments, the user may provide particular user input to skip a resource summary sub-interface. In circumstances where a user skips a resource summary sub-interface, the resource summary sub-interface may be replaced with a resource summary sub-interface associated with a different search result or personalized search result without providing particular insight into whether the corresponding search result is interesting or disinteresting to the user. In some such embodiments, skipping a search result (or personalized search result) queues the search result to be presented again upon presentation of all other search results in the set.

### Example Processes for Privacy-Preserving Personalized Search Training of the Disclosure

Having described example systems, apparatuses, data interactions, interfaces, and example processes for privacy-preserving personalized search in accordance with the present disclosure, example processes for performing privacy-preserving personalized search training in accordance with the present disclosure will now be described. It should be appreciated that each of the processes may include one or more computing devices, such that each process serves as a data flow of a single computing device and/or between one or more interacting computing devices to facilitate the operations as depicted and described. Each of the processes depicts an example computer-implemented process that may be performed by one or more of the apparatuses, systems, and/or devices described herein, for example utilizing one or more of the circuitry components thereof. The operational blocks indicating operations of each process may be arranged in any of a number of ways, including but not limited to that as depicted and described herein. In some such embodiments, one or more operational blocks of any of the processes described herein occur in-between one or more operational blocks of another process, before one or more operational blocks of another process, and/or otherwise operates as a sub-process of a second process. Additionally or alternative, any of the processes may include some or all of the steps described and/or depicted, including one or more optional operational blocks in some embodiments. With regard to the flowcharts illustrated herein, one or more of the depicted operational blocks may be optional in some, or all, embodiments of the disclosure. Optional operational blocks are depicted with broken (or “dashed”) lines. Similarly, it should be appreciated that one or more of the operational blocks of each flowchart may be combinable, replaceable, and/or otherwise altered as described herein.

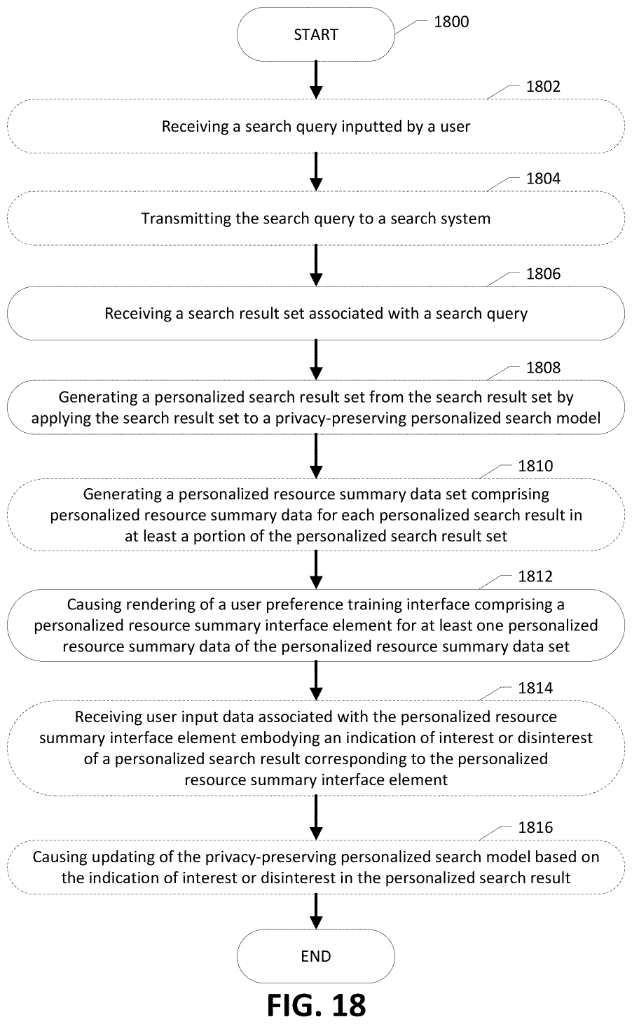

FIG. 18 illustrates a flowchart depicting example operations of rendering of a search personalization training interface for personalized privacy-preserving personalized search training in accordance with at least some example embodiments of the present disclosure. The operations are depicted and described as performed by a privacy-preserving user apparatus 300, for example embodying the user device 102 specially configured to enable performance of privacy-preserving personalized searching. It should be appreciated that, for one or more of the described operations as depicted and described with respect to FIG. 18, the privacy-preserving user apparatus 300 may interact with one or more other computing devices, apparatuses, and/or the like, such as a search system and/or a privacy-preserving federated learning system.

The example process 1800 may be embodied and/or implemented in any of a myriad of manners. For example, in some such embodiments, the process 1800 embodies a computer-implemented method that may be executed by any of a myriad of computing devices, apparatuses, systems, and/or the like, as described herein. In some embodiments, the process 1800 is embodied by computer program code stored on a non-transitory computer-readable medium of a computer program product configured for, upon execution, performing the computer-implemented process described. Alternatively or additionally, in some embodiments, the process 1800 is performed by one or more specially configured computing devices, such as the privacy-preserving user apparatus 300 alone and/or in communication with one or more external computing devices and/or components. In this regard, in some such embodiments, the privacy-preserving user apparatus 300 is specially configured by computer program instructions stored thereon, for example in the memory 304 and/or another set of circuitry depicted and/or described herein, and/or otherwise accessible to the privacy-preserving user apparatus 300, for performing the operations as depicted and described.

The process 1800 begins at optional operation 802. At optional operation 1802, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to receive a search query inputted by a user. For example, in some embodiments, the privacy-preserving user apparatus 300 outputs and/or otherwise causes rendering of a search personalization training interface or associated interface that includes one or more search query input data fields. The user may interact with the search query input data fields to input the search query, and/or submit the search query for processing. As described herein, it should be appreciated that the search query may include any of a myriad of data types, for example text data, image data, file data, and/or the like.

At optional operation 1804, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to transmit the search query to a search system. The search query may be transmitted to the search system to cause the search system to process the search query and provide a search results set including search result(s) that satisfy the search query. The search results set may be provided to the privacy-preserving user apparatus 300 as response data to the transmission including the search query. In some embodiments, the search query is transmitted as part of one or more requests specially configured to embody a request to process the search query. It should be appreciated that, to improve maintain privacy associated with processing the search query, minimal user-specific data (or in some embodiments, no user-specific data) is transmitted to the search system together with the search query, and/or the search system may not store any information associated with the search query and/or device transmitting the search query.

At operation 1806, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to receive a search result set associated with a search query. The search result set may be received from the search system in response to transmission and/or other submission of the search query to the search system for processing. In some embodiments, for example, the search result set is received from the search system in response to the search query inputted by the user at block 1802 and transmitted at block 1804.

The search result set is received not personalized, or not significantly personalized, such that the order of the search results in the search result set is not sufficiently ordered based on likely user interest of the corresponding search result. In this regard, the search result set may be identified by the search system based on a non-personalized search algorithm, for example by matching search terms to a search index maintained by the search system. The search result set received from the search system for a particular search query may be further processed to generate a personalized search result set representing the search result set personalized into an arrangement in a manner such that search results likely to be of interest (e.g., likely to be accessed by the user profile based on the search request) are ordered first in the arrangement.

At operation 1808, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to generate a personalized search result set from the search result set. The personalized search result set is generated by applying the search result set to a privacy-preserving personalized search model. The privacy-preserving personalized search model may include or otherwise utilize one or more sub-models trained in a privacy-preserving manner via communication with a privacy-preserving federated learning system. In this regard, the privacy-preserving personalized search model may be configured, based on the various trained sub-models, to generate the personalized search result set based on the various user-specific interest data collected and/or otherwise available for a particular user profile. For example, by training the privacy-preserving personalized search model and/or one or more of such sub-models of the privacy-preserving personalized search model in a privacy-preserving manner via communication with a privacy-preserving federated learning system, the trained models may be trained to sufficiently personalize search results for a particular user profile without exposing the training data (e.g., user-specific interest data) to third-party entities and/or systems in an interpretable format. The resulting personalized search result set is generated such that the search results most likely to be accessed by a user (e.g., the search results most likely to be of interest to a particular user profile) are arranged first in the personalized search result set. The resulting personalized search result set may embody an ordered arrangement of one or more of the search results from the search result set specific to a particular user profile.

In some embodiments, the personalized search result set is generated in an iterative manner. For example, the privacy-preserving user apparatus 300 may be configured to utilize the privacy preserving search model to identify a highest ranked search result from the search result set, where the highest ranked search result represents a search result most likely to be accessed from the search result set or a particular subset of the search result set (e.g., from a particular context cluster embodying a subset of the search result set). The highest ranked search result may be added to the personalized search result set in the first available position (e.g., starting with the first available position in a list of personalized search results), and removed from the search results set. Subsequently, the next highest ranked search result set from the search result set with the remaining search results may be identified, and added to the personalized search result set. This sub-process may be repeated until the personalized search result set includes a desired number of search results.

At optional operation 1810, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to generate a personalized resource summary data set. The personalized resource summary set comprises personalized resource summary data each personalized search result in at least a portion of the personalized search result set. For example, in some embodiments, personalized resource summary data is generated for a determined number of personalized search results in the personalized search result set, such as generating personalized resource summary data for each of the top ten personalized search results in the personalized search result set. In some embodiments, personalized resource summary data is generated for each personalized search result in the personalized search result set.

The personalized resource summary data for a particular personalized search result may represent various data values associated with the personalized search result and/or corresponding electronic resource. For example, in some embodiments, the personalized resource summary data comprises content summary data representing a summary of the content data for the electronic resource corresponding to the search result. Such personalized resource summary data may embody or include an extracted portion of the content data of the electronic resource, content summary data generated based on processing the entirety of the content data for the electronic resource, and/or generated based on any other of a myriad of processing methodologies for generating a summary of an electronic resource. Additionally or alternatively, the personalized resource summary data may include any of a myriad of data values associated with other data properties and/or aspects of the personalized search result. For example, the personalized resource summary data may include a domain data value associated with the domain corresponding to the personalized search result, an author data value associated with the author of the electronic resource corresponding to the personalized search result, a datetime value representing when the search result became available and/or the corresponding electronic resource was posted, and/or the like.

In this regard, it should be appreciated that the data included in personalized resource summary data may be altered by one or more entities. For example, in some embodiments, an entity controlling a search system and/or a user-facing application for privacy-preserving personalized searching may configure the personalized resource summary data to include any of a myriad of data values determined as likely to be useful for user analysis of a particular search result for interest. Alternatively or additionally, in some embodiments, the user of the privacy-preserving user apparatus 300 may configure the personalized resource summary data to include any of a myriad of desired data values they would prefer for analyzing a personalized search result. The configuration options available to the user may be limited to data properties that the search system and/or user-facing application is configured to extract associated with a personalized search result and/or corresponding electronic resource.

At operation 1812, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to cause rendering of a user preference training interface comprising a personalized resource summary interface element for at least one personalized resource summary data of the personalized resource summary data set. The user preference training interface may include any number of personalized resource summary interface elements, each corresponding to a personalized resource summary data of the personalized resource summary data set. In some embodiments, for example, the user preference training interface includes a determined number of personalized resource summary interface elements or less if there are insufficient results, for example a maximum of five personalized resource summary interface elements. In other embodiments, the user preference training interface includes a single personalized resource summary interface element, for example which may be updated and/or replaced upon user interaction with the personalized resource summary interface element, as described herein. In yet other embodiments, the user preference training interface includes a number of personalized resource summary interface elements that fit the display associated with the privacy-preserving user apparatus 300. In yet other embodiments still, the user preference training interface includes a personalized resource summary interface for each personalized resource summary data in the personalized resource summary data set.

Each personalized resource summary interface may correspond to particular personalized resource summary data of the personalized resource summary data set. Each personalized resource summary interface may include one or more interface elements that correspond to particular data values of the corresponding personalized resource summary data. For example, in some embodiments, a personalized resource summary interface includes an interface element corresponding to each data value of the personalized resource summary data, such as a title interface element, an author interface element, a content summary interface element, a date posted interface element, a domain interface element, and/or the like. In this regard, each interface element of the personalized resource summary interface may include a rendered representation of the corresponding data value for viewing and/or analysis by a user. In this regard, the user may view and/or analyze a personalized resource summary interface to determine whether the user is interested in the corresponding personalized search result or not interested in the corresponding personalized search result.

In some embodiments, the user preference training interface is configured to enable user interaction with each personalized resource summary interface element rendered therein. For example, in some embodiments, at optional operation 1814, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to receive user input data associated with the personalized resource summary interface element, the user interaction data embodying an indication of interest or disinterest of a personalized search result corresponding to the personalized resource summary interface element. In this regard, the indication may represent a likelihood that the user accesses the personalized search result. The user may continue to interact with the user preference training interface to provide such indications of interest and/or disinterest for any of a number of personalized search results associated with a personalized resource summary interface rendered via the user preference training interface. In some embodiments, for example, the user may provide user input data by interacting with the personalized resource summary interface, such as where the user input data embodying a swipe left to indicate disinterest in the personalized search result or a swipe right to indicate interest in the personalized search result. In other embodiments, the user provides alternative user input data associated with a particular personalized resource summary interface, for example a voice command, swipe up or swipe down, a tap, a pinch-in or pinch-out, and/or the like, indicating one of interest or disinterest in a particular personalized search result corresponding to a particular personalized resource summary interface.

In some embodiments, the user preference training interface is updated upon receiving the user input data associated with a particular personalized resource summary interface indicating interest or disinterest in the corresponding personalized search result. For example, in some embodiments, the personalized resource summary interface is replaced or otherwise updated upon receiving the user input data associated with the personalized resource summary interface. The personalized resource summary interface may be replaced with a personalized resource summary interface corresponding to personalized resource summary data in the personalized resource summary data set for a personalized search result that has not yet been associated with a rendered personalized resource summary interface and/or for which an indication of interest or disinterest has not yet been received. In this regard, the user preference training interface may be updated any number of times to enable the user to continue to provide indications of interest and/or disinterest for various personalized search results, which may be utilized to improve the accuracy of personalized search results provided associated with the user for subsequent search queries as described herein.

At optional operation 1816, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to cause updating of the privacy-preserving personalized search model based on the indication of interest or disinterest in the personalized search result. In some embodiments, the indication of interest or disinterest in the personalized search result may be utilized to update one or more center(s) of interest or center(s) of disinterest for the user profile. Additionally or alternatively, in some embodiments for example, the indication of interest or disinterest is stored as user-specific interest data associated with a user profile (e.g., representing the user or privacy-preserving user apparatus 300). The user-specific interest data may be utilized to update training of one or more sub-models of the privacy-preserving personalized search model and/or data associated therewith.

For example, the indication of interest or disinterest in the personalized search result may be utilized to update training of a user resource interest model, a user domain preference model, a user content type preference model, and/or the like. The updated training of such model(s) may be performed local to the privacy-preserving user apparatus 300, and/or subsequently may be performed globally in a privacy-preserving manner via communication with a privacy-preserving federated learning system. For example, in some embodiments the local model is updated locally, and subsequently utilized for updating globally in a privacy-preserving manner as described herein. In this regard, the model(s) accessible to the privacy-preserving user apparatus 300 may be updated such that the trends represented by the local training data may be learned by the model(s), and the updated models through global training represent such trends learned by the models of a plurality of specially configured user devices without exposing the data local to each specially configured user device.

In other embodiments, the process 1800 is performed with one or more modifications with respect to the particular data processed and/or displayed to the user. For example, in some embodiments, the search result set that is non-personalized is utilized to generate corresponding interfaces based on resource summary data associated with such non-personalized search results. In this regard, the user may indicate which of the non-personalized search results are interesting and/or disinteresting to the user. Additionally or alternatively, in some embodiments, the resource summary data associated with a particular search result (or personalized search result) is generated and/or otherwise maintained by the search system. In some such embodiments, the specially configured user apparatus 300 may receive the resource summary data from the search system (e.g., together or in conjunction with the search result set) and utilize such resource summary data without subsequent processing or customization. In this regard, the search personalization training interface may function to provide similar functionality with respect to non-personalized search results, and/or with respect to the particular resource summary data maintained by the search system (e.g., separate from the specially configured user apparatus 300).

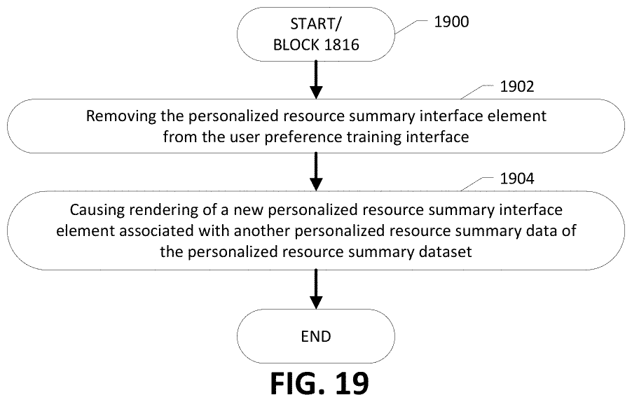

FIG. 19 illustrates a flowchart depicting example additional operations of an example process for updating a search personalization training interface, for example as part of a process for rendering and using a search personalization training interface, in accordance with at least some example embodiments of the present disclosure. The operations are depicted and described as performed by a privacy-preserving user apparatus 300, for example embodying the user device 102 specially configured to enable privacy-preserving personalized search training. It should be appreciated that, for one or more of the described operations as depicted and described with respect to FIG. 19, the privacy-preserving user apparatus 300 may interact with one or more other computing devices, apparatuses, and/or the like, such as a search system and/or a privacy-preserving federated learning system.

The example process 1900 may be embodied and/or implemented in any of a myriad of manners. For example, in some such embodiments, the process 1900 embodies a computer-implemented method that may be executed by any of a myriad of computing devices, apparatuses, systems, and/or the like, as described herein. In some embodiments, the process 1900 is embodied by computer program code stored on a non-transitory computer-readable medium of a computer program product configured for, upon execution, performing the computer-implemented process described. Alternatively or additionally, in some embodiments, the process 1900 is performed by one or more specially configured computing devices, such as the privacy-preserving user apparatus 300 alone and/or in communication with one or more external devices. In this regard, in some such embodiments, the privacy-preserving user apparatus 300 is specially configured by computer program instructions stored thereon, for example in the memory 304 and/or another set of circuitry depicted and/or described herein, and/or otherwise accessible to the privacy-preserving user apparatus 300, for performing the operations depicted and described.

The process 1900 begins at operation 1902. In some embodiments, the process 1900 begins after one or more operational blocks of another process, for example after operation 1816 as depicted and described with respect to the process 1800. Additionally or alternatively, in some embodiments, flow continues to an operation of another process upon completion of the process 900. Alternatively or additionally still, in some other embodiments, the flow ends upon completion of the process 1900.

At operation 1902, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to remove the personalized resource summary interface element from the user preference training interface. For example, the personalized resource summary interface element may be removed upon user interaction with the personalized resource summary interface element indicating interest or disinterest in the corresponding personalized search result. In some embodiments, the personalized resource summary interface element is removed by de-rendering it from the user preference training interface. In some embodiments, the personalized resource summary interface is removed by rendering an entirely new interface to the display.

At operation 1904, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to cause rendering of a new personalized resource summary interface element associated with another personalized resource summary data of the personalized resource summary data set. In some embodiments, the privacy-preserving user apparatus 300 causes rendering of a new personalized resource summary interface element associated with the next personalized resource summary data of the personalized resource summary data set. In some other embodiments, the privacy-preserving user apparatus 300 causes rendering of a new personalized resource summary interface element associated with a randomly selected personalized resource summary data from the personalized resource summary data set. In this regard, it should be appreciated that the new personalized resource summary interface element may enable the user to view and/or analyze the personalized resource summary data associated with a different personalized search result, and/or interact with the personalized resource summary interface element to indicate interest or disinterest in the corresponding personalized search result.

The new personalized resource summary interface may be rendered in any of a myriad of manners. In some embodiments, the new personalized resource summary interface is rendered at the same position as the personalized resource summary interface removed from the user preference training interface. For example, in some embodiments a single personalized resource summary interface is rendered at a time, such that the new personalized resource summary interface replaces the previous personalized resource summary interface with which the user already interacted. In other embodiments, the new personalized resource summary interface is rendered at a different position based on one or more previously-rendered personalized resource summary interfaces. For example, a list of personalized resource summary interfaces may be rendered linearly, such that when a user interacts with one of the personalized resource summary interfaces, the remaining personalized resource summary interfaces earlier or subsequent in the list update their positions and the new personalized resource summary interface is rendered at the end of the list.

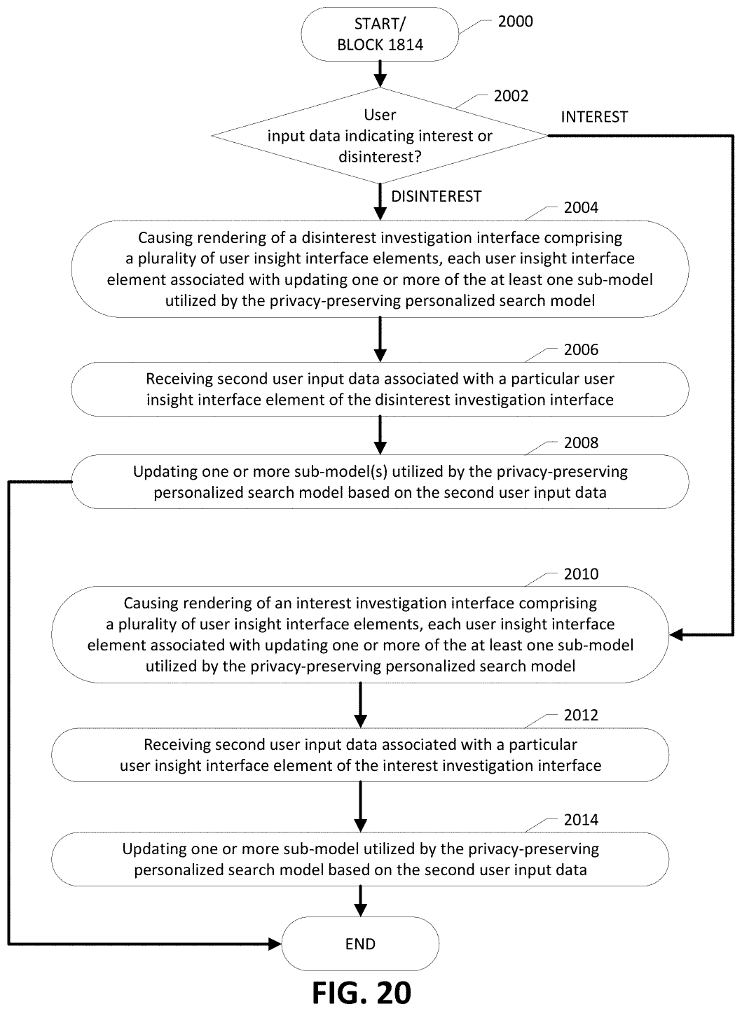

FIG. 20 illustrates a flowchart depicting example additional operations of an example process for updating one or more sub-models of a privacy-preserving personalized search model, for example as part of a process for rendering and using a search personalization training interface, in accordance with at least some example embodiments of the present disclosure. The operations are depicted and described as performed by a privacy-preserving user apparatus 300, for example embodying the user device 102 specially configured to enable privacy-preserving personalized search training. It should be appreciated that, for one or more of the described operations as depicted and described with respect to FIG. 20, the privacy-preserving user apparatus 300 may interact with one or more other computing devices, apparatuses, and/or the like, such as a search system and/or a privacy-preserving federated learning system.

The example process 2000 may be embodied and/or implemented in any of a myriad of manners. For example, in some such embodiments, the process 2000 embodies a computer-implemented method that may be executed by any of a myriad of computing devices, apparatuses, systems, and/or the like, as described herein. In some embodiments, the process 2000 is embodied by computer program code stored on a non-transitory computer-readable medium of a computer program product configured for, upon execution, performing the computer-implemented process described. Alternatively or additionally, in some embodiments, the process 2000 is performed by one or more specially configured computing devices, such as the privacy-preserving user apparatus 300 alone and/or in communication with one or more external devices. In this regard, in some such embodiments, the privacy-preserving user apparatus 300 is specially configured by computer program instructions stored thereon, for example in the memory 304 and/or another set of circuitry depicted and/or described herein, and/or otherwise accessible to the privacy-preserving user apparatus 300, for performing the operations depicted and described.

The process 2000 begins at operation 2002. In some embodiments, the process 2000 begins after one or more operational blocks of another process, for example after operation 1814 as depicted and described with respect to the process 1800. Additionally or alternatively, in some embodiments, flow continues to an operation of another process upon completion of the process 2000. Alternatively or additionally still, in some other embodiments, the flow ends upon completion of the process 2000.

At operation 2002, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to receive user input data indicating interest or disinterest associated with a particular personalized search result. In some embodiments, the user input data is received in response to user interaction with a personalized resource summary interface corresponding to the personalized search result. For example, in some embodiments, the user performs a first user input for a personalized resource summary interface to indicate disinterest in the corresponding personalized search result (e.g., a left swipe), or a second user input for the personalized resource summary interface to indicate interest in the corresponding personalized search result (e.g., a right swipe).

The privacy-preserving user apparatus 300 may receive different user input data based on the performed user input and may determine which user input was performed from the user input data. In this regard, the privacy-preserving user apparatus 300 may process received user input data to determine whether the received user input data represents interest or disinterest. In circumstances where user input data is received that indicates a user interest in the corresponding personalized search result, flow proceeds to operation 2010. In circumstances where user input data is received that indicates a user disinterest in the corresponding personalized search result, flow proceeds to operation 2004.

At operation 2004, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to cause rendering of a disinterest investigation interface comprising a plurality of user insight interface elements. Each user insight interface element may be associated with updating one or more sub-models utilized by the privacy-preserving personalized search model. The disinterest investigation interface element may be associated with a particular personalized search result, for example based on the personalized resource summary interface with which the user interacted. In this regard, for example, each user insight interface element may enable a user to input particular user-specific insight data that provides reasons, insight, and/or other context as to why a user is interested or disinterested in a personalized search result. In this regard, the user may interact with each user insight interface element to provide particular user-specific insight data associated with interest or disinterest a personalized search result corresponding to the user insight interface element.

Each portion of user specific insight data may be associated utilized by a different sub-model, for example as training data for the sub-model. For example, in some embodiments, a first user insight interface element is rendered associated with determining whether the user did not prefer the content type associated with the personalized search result, such data embodying a first portion of user-specific insight data. Additionally or alternatively, a second user insight interface element is rendered associated with determining whether the user did not prefer the domain (e.g., a website) associated with the personalized search result, such data embodying a second portion of user-specific insight data. Additionally or alternatively still, a third user insight interface element is rendered associated with determining whether the user does not prefer the length of the content associated with the personalized search result, such data embodying a third portion of user-specific insight data. Each of these portions of insight data may be utilized to update training of a different sub-model, for example a content type preference model, a user domain preference model, and a user content length preference model respectively.

At operation 2006, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to receive second user input data associated with a particular user insight interface element of the disinterest investigation interface. The second user input data may indicate selection of the user insight investigation interface element. For example, in some embodiments, the user insight interface element comprises a checkbox that is selectable and/or de-selectable by the user, where selection of the user insight interface element indicates a particular reason for disinterest in a corresponding personalized search result. It should be appreciated that the user may interact with any number of user insight interface elements of the disinterest investigation interface.

At operation 2008, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to update one or more sub-models utilized by the privacy-preserving federated search model based on the second user input data. In this regard, the one or more sub-models associated with the user insight interface element may be updated based on the user input data. For example the second user input data selecting a user insight interface element indicating a user does not prefer a particular content type associated with a personalized search result may be utilized to update an associated content type preference model. Each of the model(s) may be updated to represent trends in the disinterest of particular personalized search result(s).

It should be appreciated, as described herein, that in some embodiments one or more of the model(s) are updated on the privacy-preserving user apparatus 300. In this regard, the user-specific interest data corresponding to the second user input data model(s) may be stored and/or maintained on the privacy-preserving user apparatus 300 in a manner such that the information is inaccessible to external systems and/or third-party entities. The updated model may be maintained and/or utilized locally via the privacy-preserving user apparatus 300. Additionally or alternatively, the updated local model may be utilized to further generate an updated global model (e.g., reflecting trends learned by the updated local model and/or other updated local models for other users and/or devices) in a privacy-preserving manner via communication with a privacy-preserving federated learning system. In this regard, the updated global model may be generated in a manner that does not expose the user-specific data to such third-party entities while still enabling such updated training, and the updated global model may replace the local model once generated and received. It should further be appreciated that the process for generating the updated global model may be initiated at any of a myriad of intervals, for example immediately upon receiving the second user input data, at a predetermined time interval, and/or the like.

At operation 2010, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to cause rendering of an interest investigation interface comprising a plurality of user insight interface elements. Each user insight interface element may be associated with updating one or more sub-models utilized by the privacy-preserving personalized search model. The interest investigation interface may be associated with a particular personalized search result, for example based on the personalized resource summary interface with which the user interacted. In this regard, for example, each user insight interface element may enable a user to input particular user-specific insight data that provides reasons, insight, and/or other context as to why a user is interested in the corresponding personalized search result. In this regard, the user may interact with each user insight interface element to provide particular user-specific insight data associated with interest in the personalized search result corresponding to the user interest investigation interface.

Each portion of user-specific insight data may be associated with and/or utilized by a different sub-model, for example as training data for the sub-model. For example, in some embodiments, a first user insight interface element is rendered associated with determining whether the user prefers the content type associated with the personalized search result, such data embodying a first portion of user-specific insight data. Additionally or alternatively, a second user insight interface element is rendered associated with determining whether the user prefers the domain (e.g., a website) associated with the personalized search result, such data embodying a second portion of user-specific insight data. Additionally or alternatively still, a third user insight interface element is rendered associated with determining whether the user prefers the length of the content associated with the personalized search result, such data embodying a third portion of user-specific insight data. Each of these portions of insight data may be utilized to update training of a different sub-model, for example a content type preference model, a user domain preference model, and a user content length preference model respectively.

At operation 2012, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to receive second user input data associated with a particular user insight interface element of the interest investigation interface. The second user input data may indicate selection of the user insight investigation interface element. For example, in some embodiments, the user insight interface element comprises a checkbox that is selectable and/or de-selectable by the user, where selection of the user insight interface element indicates a particular reason for disinterest in a corresponding personalized search result. It should be appreciated that the user may interact with any number of user insight interface elements of the interest investigation interface.

At operation 2014, the privacy-preserving user apparatus 300 includes means, such as the privacy-preserving modeling circuitry 310, privacy-preserving personalized search circuitry 312, communications circuitry 308, input/output circuitry 306, processor 302, and/or the like, or a combination thereof, to update one or more sub-models utilized by the privacy-preserving personalized search model based on the second user input data. In this regard, the one or more sub-models associated with the user insight interface element may be updated based on the user input data. For example the second user input data selecting a user insight interface element indicating a user prefers a particular content type associated with a personalized search result may be utilized to update an associated content type preference model. Each of the model(s) may be updated to represent trends in the user's interest of particular personalized search result(s).

It should be appreciated, as described herein, that in some embodiments one or more of the model(s) are updated on the privacy-preserving user apparatus 300. In this regard, the user-specific interest data corresponding to the second user input data model(s) may be stored and/or maintained on the privacy-preserving user apparatus 300 in a manner such that the information is inaccessible to external systems and/or third-party entities. The updated model may be maintained and/or utilized locally via the privacy-preserving user apparatus 300. Additionally or alternatively, the updated local model may be utilized to further generate an updated global model (e.g., reflecting trends learned by the updated local model and/or other updated local models for other users and/or devices) in a privacy-preserving manner via communication with a privacy-preserving federated learning system. In this regard, the updated global model may be generated in a manner that does not expose the user-specific data to such third-party entities while still enabling such updated training, and the updated global model may replace the local model once generated and received. It should further be appreciated that the process for generating the updated global model may be initiated at any of a myriad of intervals, for example immediately upon receiving the second user input data, at a predetermined time interval, and/or the like.

It should be appreciated that, in some embodiments, a plurality of user input data associated with user insight interface elements and/or different interest investigation interfaces and/or disinterest investigation interfaces are received. For example, the user may interact to provide user input data associated with indicating interest and/or disinterest various different personalized search results, and for each provide second user input data associated with user insight interfaces of corresponding interest investigation interface(s) and/or disinterest investigation interface(s). In this regard, the privacy-preserving user apparatus 300 may receive data associated with various personalized search results, and/or receive data associated with various user-specific insight data for such personalized search results, and update training of one or more model(s) at a single time once a plurality of data has been received and/or otherwise identified. In this regard, computing resources may be saved by minimizing updated training operations (e.g., instead of updating training for each and every interaction by the user), as model updating and/or training often utilizes significant computing resources to perform each time.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communications network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communications network. Examples of communications networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communications network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. An apparatus for privacy-preserving data search training comprising at least one processor and at least one memory, the at least one memory comprising computer-coded instructions that, upon execution via the at least one processor, configured the apparatus to:
receive a search result set associated with a search query;
generate a personalized search result set from the search result set by:
apply the search result set to a privacy-preserving personalized search model;
generate a personalized resource summary data set comprising personalized resource summary data for each personalized search result in at least a portion of the personalized search result set;
cause rendering of a search preference training interface, the search preference training interface comprising a personalized resource summary interface element for at least one personalized resource summary data of the personalized resource summary data set;
receive user input data associated with the personalized resource summary interface element embodying an indication of interest or disinterest of a personalized search result corresponding to the personalized resource summary interface element; and
cause updating of the privacy-preserving personalized search model based on the indication of interest or disinterest in the personalized search result.

2. The apparatus according to claim 1, further configured to:
remove the personalized resource summary interface element from the search preference training interface; and
cause rendering of a new personalized resource summary interface element associated with another personalized resource summary data of the personalized resource summary data set.

3. The apparatus according to claim 1, wherein the user input data embodies a left swipe indicating disinterest in the personalized search result, or the user input data embodies a right swipe indicating interest in the personalized search result.

4. The apparatus according to claim 1, wherein each personalized resource summary data of the personalized resource summary data set comprises extracted content summary data generated associated with an electronic resource corresponding to a personalized search result of the personalized search result set.

5. The apparatus according to claim 1, wherein the user input data embodies an indication of disinterest of the personalized search result corresponding to the personalized resource summary interface element, the apparatus further configured to:
cause rendering of a disinterest investigation interface associated with the personalized search result corresponding to the personalized resource summary interface element, wherein the disinterest investigation interface comprises a plurality of user insight interface elements, each user insight interface element associated with updating one or more sub-model utilized by the privacy-preserving personalized search model, wherein second user input data associated with a particular user insight interface element of the plurality of user insight interface elements is utilized to further train one or more of the at least one sub-model based on the second user input data.

6. The apparatus according to claim 1, wherein the user input data embodies an indication of interest of the personalized search result corresponding to the personalized resource summary interface element, the apparatus further configured to:
cause rendering of an interest investigation interface associated with the personalized search result corresponding to the personalized resource summary interface element, wherein the interest investigation interface comprises a plurality of user insight interface elements, each user insight interface element associated with updating one or more sub-model utilized by the privacy-preserving personalized search model, wherein second user input data associated with a particular user insight interface element of the plurality of user insight interface elements is utilized to further train the one or more of the at least one sub-model based on the second user input data.

7. The apparatus according to claim 1, further configured to:
receive the search query inputted by a user; and
transmit the search query to a search system, wherein the search result set is received in response to transmitting the search query based at least on the search query.

8. The apparatus according to claim 1, wherein the privacy-preserving personalized search model is configured to generate the personalized search result set based at least on (1) at least one center of interest associated with a user profile and (2) at least one center of disinterest associated with the user profile.

9. The apparatus according to claim 1, wherein the privacy-preserving personalized search model is configured to generate the personalized search result set based at least on (1) an exploration deviation from at least one center of interest associated with a user profile or (2) the exploration deviation from at least one center of disinterest associated with the user profile.

10. The apparatus according to claim 1, wherein to cause updated training of the privacy-preserving personalized search model based on the indication of interest or disinterest of the personalized search result comprises:
train an updated search model based on the indication of interest or disinterest of the personalized search result;
mask, based on a local decryption key, the updated search model to produce a local masked updated search model;
transmit the local masked updated search model to the privacy-preserving federated learning system;
generate a secured unmasking data object based on at least the local decryption key and a plurality of external local decryption keys;
receive a masked updated global model from the privacy-preserving federated learning system; and
generate an unmasked updated global model by unmasking the masked updated global model utilizing the secured unmasking data object, the unmasked updated global model embodying the updated privacy-preserving personalized search model.

11. A computer-implemented method for privacy-preserving data search training comprising:
receiving a search result set associated with a search query;
generating a personalized search result set from the search result set by:
applying the search result set to a privacy-preserving personalized search model;
generating a personalized resource summary data set comprising personalized resource summary data for each personalized search result in at least a portion of the personalized search result set;
causing rendering of a search preference training interface, the search preference training interface comprising a personalized resource summary interface element for at least one personalized resource summary data of the personalized resource summary data set;
receiving user input data associated with the personalized resource summary interface element embodying an indication of interest or disinterest of a personalized search result corresponding to the personalized resource summary interface element; and
causing updating of the privacy-preserving personalized search model based on the indication of interest or disinterest in the personalized search result.

12. The computer-implemented method according to claim 11, further comprising:
removing the personalized resource summary interface element from the search preference training interface; and
causing rendering of a new personalized resource summary interface element associated with another personalized resource summary data of the personalized resource summary data set.

13. The computer-implemented method according to claim 11, wherein the user input data embodies a left swipe indicating disinterest in the personalized search result, or the user input data embodies a right swipe indicating interest in the personalized search result.

14. The computer-implemented method according to claim 11, wherein each personalized resource summary data of the personalized resource summary data set comprises extracted content summary data generated associated with an electronic resource corresponding to a personalized search result of the personalized search result set.

15. The computer-implemented method according to claim 11, wherein the user input data embodies an indication of disinterest of the personalized search result corresponding to the personalized resource summary interface element, the computer-implemented method further comprising:
causing rendering of a disinterest investigation interface associated with the personalized search result corresponding to the personalized resource summary interface element, wherein the disinterest investigation interface comprises a plurality of user insight interface elements, each user insight interface element associated with updating one or more sub-model utilized by the privacy-preserving personalized search model, wherein second user input data associated with a particular user insight interface element of the plurality of user insight interface elements is utilized to further train one or more of the at least one sub-model based on the second user input data.

16. The computer-implemented method according to claim 11, wherein the user input data embodies an indication of interest of the personalized search result corresponding to the personalized resource summary interface element, the computer-implemented method further comprising:
causing rendering of an interest investigation interface associated with the personalized search result corresponding to the personalized resource summary interface element, wherein the interest investigation interface comprises a plurality of user insight interface elements, each user insight interface element associated with updating one or more sub-model utilized by the privacy-preserving personalized search model, wherein second user input data associated with a particular user insight interface element of the plurality of user insight interface elements is utilized to further train the one or more of the at least one sub-model based on the second user input data.

17. The computer-implemented method according to claim 11, wherein the privacy-preserving personalized search model is configured to generate the personalized search result set based at least on (1) at least one center of interest associated with a user profile and (2) at least one center of disinterest associated with the user profile.

18. The computer-implemented method according to claim 11, wherein causing updated training of the privacy-preserving personalized search model based on the indication of interest or disinterest of the personalized search result comprises:
training an updated search model based on the indication of interest or disinterest of the personalized search result;
masking, based on a local decryption key, the updated search model to produce a local masked updated search model;
transmitting the local masked updated search model to the privacy-preserving federated learning system;
generating a secured unmasking data object based on at least the local decryption key and a plurality of external local decryption keys;
receiving a masked updated global model from the privacy-preserving federated learning system; and
generating an unmasked updated global model by unmasking the masked updated global model utilizing the secured unmasking data object, the unmasked updated global model embodying the updated privacy-preserving personalized search model.

19. A computer program product for privacy-preserving data search training comprising at least one non-transitory computer-readable storage medium having computer program code thereon that, in execution with at least one processor, is configured for:
receiving a search result set associated with a search query;
generating a personalized search result set from the search result set by:
applying the search result set to a privacy-preserving personalized search model;
generating a personalized resource summary data set comprising personalized resource summary data for each personalized search result in at least a portion of the personalized search result set;
causing rendering of a search preference training interface, the search preference training interface comprising a personalized resource summary interface element for at least one personalized resource summary data of the personalized resource summary data set;
receiving user input data associated with the personalized resource summary interface element embodying an indication of interest or disinterest of a personalized search result corresponding to the personalized resource summary interface element; and
causing updating of the privacy-preserving personalized search model based on the indication of interest or disinterest in the personalized search result.

20. The computer program product according to claim 19, wherein causing updated training of the privacy-preserving personalized search model based on the indication of interest or disinterest of the personalized search result comprises:
training an updated search model based on the indication of interest or disinterest of the personalized search result;
masking, based on a local decryption key, the updated search model to produce a local masked updated search model;
transmitting the local masked updated search model to the privacy-preserving federated learning system;
generating a secured unmasking data object based on at least the local decryption key and a plurality of external local decryption keys;
receiving a masked updated global model from the privacy-preserving federated learning system; and
generating an unmasked updated global model by unmasking the masked updated global model utilizing the secured unmasking data object, the unmasked updated global model embodying the updated privacy-preserving personalized search model.
